(19) United States
(12) Patent Application Publication
(10) Pub. No.: US 2003/0055732 A1
(43) Pub. Date: Mar. 20, 2003

(54) Service management method, service management apparatus, service management network system, service management program, and computer program product storing the service management program

(76) Inventor: Masaya Nagata, Nara-shi (JP)

Correspondence Address: BIRCH STEWART KOLASCH & BIRCH, PO BOX 747, FALLS CHURCH, VA, 22040-0747, US

(21) Appl. No.: 10/083,409

(22) Filed: Feb. 27, 2002

(30) Foreign Application Priority Data
Mar. 23, 2001 (JP) 2001-86201
Mar. 23, 2001 (JP) 2001-86256

(51) Int. Cl. G06G 1/14; G06F 17/60

(52) U.S. Cl. 705/22

(57) ABSTRACT

In the service management method for providing a product-in-circulation to a service receiver, a terminal managed by a service provider includes: a memory section for registering data of a product-in-circulation delivered to a contract signer and an expiring date of the product-in-circulation; an input section for inputting the status on use of the product-in-circulation, or a communications section for detecting the status on use of the product-in-circulation; and an arithmetic processing section for calculating an account of a product-in-circulation whose status on use has been input, of all products-in-circulation delivered to the service receiver, in accordance with expiring date data of the product-in-circulation. According to the arrangement, it is possible to provide a rational service management system whereby the service receiver does not have to purchase extra products-in-circulation in advance, and a product-in-circulation can be charged according to the expiring date.

### FIELD OF THE INVENTION

The present invention is directed to service management methods for degradables and consumables and service management network systems related with the method and preferably directed to management, delivery, charging, and other related methods for the degradables and consumables, including those used in copying machines, printers, and other image forming apparatuses, which the service receiver can keep a stock of and be charged on the quantities of the products used.

### BACKGROUND OF THE INVENTION

Copying machines, printers, and other image forming apparatuses need a refill after continuous use over an extended period of time, and degradables and consumables, such as toner cartridges and photosensitive body cartridges, must be replaced.

Throughout this document, we use degradables in reference to those photosensitive body cartridges and other photosensitive parts that wear out by use and consumables in reference to toner and ink cartridges and other similar parts that hold toner, ink, etc. that are consumed by use. However, degradables are also consumable in the sense that they have to be replaced with new ones after an extended period of use, and some toner cartridges include a built-in photosensitive body cartridge. In light of these facts, when degradables and consumables are not necessarily differentiated from each other, consumables collectively refers to both kinds of products.

The user of a machine that requires replacement of consumables typically buys new ones before he/she uses up old ones. By so doing, he/she can keep a stock of them and avoid situations where the machine becomes inoperative because he/she has run out of the consumables.

In the current payment system, the user can legitimately own consumable products only after buying them. Put differently, without paying, he/she cannot own them, much less to keep a stock of them. Thus, in order to keep a stock of them, they have to be purchased.

Meanwhile, when a generous budget is a thing that is hard to come, the user needs to curb expenses on consumable products. Maybe he/she could do this by keeping a smaller stock of spare consumable products, but the stock would have to be refilled more often. He/she would fairly frequently have to bother to check the stock to find out how many of them are left unused and also the consumable products currently in use to know how longer they could be used. The user or manager of the machine would be typically responsible for doing this job, but could not dedicate his/her whole time to it. Under these circumstances, he/she probably could not, or would not, manage the consumables.

A likely result is that more than a currently necessary number of consumable products are bought and stocked.

There exists a technique to exploit use-by date data of general articles (daily and medical goods, preserved foods, etc.) including the foregoing consumable products in sales activities of the articles.

For example, Japanese Published Patent Application 9-30055/1997 (Tokukaihei 9-30055) discloses a technique whereby using a label printer which is equipped with article data memory means for recording data on each article to print labels carrying sales data of the articles according to the article data retrieved from the article data memory means, an optimum method to display a date-of-manufacture cell title type, such as dates of fabrication, manufacture, and display; an expiry date cell title type, such as an expiry date, use-by date, quality guarantee period, and valid period; and a data type given corresponding to the date of manufacture cell title type and the expiry date cell title type (method to display by way of date or time as the expiry and method to display by way of days or hours as a period) is selected for each article according to the nature of the article.

The date of fabrication or expiry date is time-related data to ensure the quality of the article. The date of fabrication may be, for example, the date of manufacture, display, etc. The expiry date may be, for example, a use-by date, quality guarantee period, and valid period.

Specifically, there is provided a print selection table file in which print selection tables are specified to determine a date of fabrication cell title type to specify an item of the date of fabrication, a date of fabrication cell data type to specify a date and time of fabrication, an expiry date cell title type to specify an item of the expiry date, and an expiry date cell data type to specify an expiry date and time, as well as a switching days area to store switching days data to select a print selection table, a print selection table is selected and read based on a comparison between the switching days data and valid period data in the article data read out from a PLU (price look up) file, and the date-of-fabrication cell and expiry-date cell are created based on the readout print selection table.

In this manner, no data is specified to create date-of-fabrication and expiry-date cells for each article; therefore, the title and data types for the date-of-fabrication and expiry-date cells can be automatically specified without a need for large volume memory. Consequently, an operator only needs to select a print selection table file and switching days file appropriately in advance, which helps to improve operability.

Meanwhile, in a case where a mistake occurs in making contract between a seller of an article and a purchaser of the article, return of the supplied article is permitted otherwise only the purchaser makes a mistake. Further, it is typical in a mail order that return of a received article is permitted otherwise the article is opened. There exists such business model.

There are situations where the spare consumables kept by the user are totally wasted: for example, the user has been renting an image forming apparatus from a leasing company, but returns it as the contract expires; or the user simply discards an old image forming apparatus that has been used up to its expected life.

Even when the user renews the contract, unless he/she rents a compatible model with the consumable products he/she has kept a stock of for the old model, they are totally wasted.

This is especially true in offices where vast amounts of pages are printed. Many consumable products therefore must be bought and kept in stock to satisfy the needs in exchange for a large amount of advance payment. If the foregoing situations occur, loss is very large accordingly.

The problem is partly solved by predicting how longer the photosensitive body and toner are usable. The prediction can be made by an IC chip provided in the consumable product to record data on operation conditions, such as the date and time the consumable product was last replaced, the total time of use of the consumable product since its installation, and the number of pages printed.

Using an image forming apparatus with the function to predict the remaining product life by electronic means may be somewhat helpful to establish a fairly reliable, automatic day-to-day control system that even works with a stock of a least number of spare consumable products possible.

Nevertheless, however precisely the prediction is made, the user still needs to pay to keep some spare consumable products at hand. Anyway, the precision of the prediction varies greatly depending on the performance of the algorithm involved, and the prediction is in no case 100% reliable.

To sum up the description so far, the user needs to keep spare consumable products at hand to avoid situations where the machine becomes inoperative because he/she has run out of consumable products. To this end, the user has to buy the consumable products in the current accounting system. In addition, the user may not actually use those spare consumable products he/she has paid for and let them waste.

Tokukaihei 9-30055 relates to a method to determine a date-of-fabrication cell title type, a date-of-fabrication cell data type corresponding to the date-of-fabrication cell title type, an expiry date cell title type, and an expiry date cell data type corresponding to the expiry date cell title type in accordance with the nature of the article by comparing the valid period data of the article and the predetermined switching data. Although article information is recorded, together with valid period information, as an electronic file (PLU file), the disclosure totally differs from the configuration in which the expiry date data of the article is used to handle accounting.

While, in a case where an article received by a purchaser is returned, the article is stocked. Particularly in a case where an article customized for a purchaser is returned, it is sometimes impossible to sell the customized article at a regular price due to its uniqueness. Thus, it is necessary for a seller to contrive to dispose of the returned article, but the way the article is disposed of varies depending on its uniqueness or the seller's way of thinking. Thus, in some cases, the article is disposed of as a discounted article, or in other cases, the article is disposed at a net auction in a home page. There is also a case where the article is sold so that the article is not found to be an article which has been returned.

It is efficient to sell a returned article to another purchaser in the light of utilization. However, even though there is no difference between an entirely new product and the returned article as unused articles, the purchaser does not desire to be charged for the returned article at the same price as a new one. Further, in a case where the purchaser is not be informed that the article is a recycled article, the seller may be blamed that the attitude is not be permitted.

Further, it is impossible to avoid such disadvantage that an appearance of the article is damaged while the article is returned and supplied again. If the damage can be recognized visually and the extent of the damage can be classified in accordance with a value, it is possible to reflect the extent of the damage on charge, but much time is required in making such valuation table, and this is so difficult.

### SUMMARY OF THE INVENTION

The object of the present invention is to provide a method and a system etc. whereby it is possible to curb unnecessary expenses, without resorting to forecast or other unreliable methods, by charging only the degradables and the consumables he/she actually used, out of those delivered to the service receiver, so as to avoid situations where the machine becomes inoperative because he/she has run out of the consumables.

Another object of the present invention is to provide a rational accounting system whereby an account varies in accordance with use-by date data.

Further, a system in which also a collected article is dealt provides a rational accounting system in which accounting calculation is based on the number of times the article has been collected, data which can be expressed as a value, so as to clarify the accounting calculation system from the beginning, so that the transparency of a corporation can be declared, and an account varies in accordance with the number of times collected.

Note that, examples of products-in-circulation covered by the service include not only products-in-circulation used in machines that require use of products-in-circulation, but also recording paper and other office supplies, soap and other everyday commodities used at home, parts used in manufacture of products at factories, etc. The present invention is applicable to any such product that the service receiver would find it more convenient and would not have to waste purchased goods if the service receiver has the product delivered in advance and is later charged only for the amount actually used.

In order to achieve the foregoing object, a service management method of the present invention makes a computer execute the steps of: (a) registering (by input means provided in a terminal which functions as the computer) unique data to specify each product-in-circulation delivered to a service receiver and expiry date data of the product-in-circulation (as a product-in-circulation data table in a memory section); (b) detecting (by communication means provided in the terminal) use of the product-in-circulation used by the service receiver, via a network; (c) recognizing (by arithmetic processing means provided in the terminal) the use of the product-in-circulation as a purchase action; and (d) calculating (by arithmetic processing means provided in the terminal) an account of a product-in-circulation recognized as the purchase action, of all products-in-circulation delivered to the service receiver, in accordance with the expiry date data.

According to the arrangement, if there is a use regarded as a purchase action (for example, use detected for the first time via a network), of all uses (commencement of use, in use, end of use etc.) detected via the network, a product-in-circulation concerning the use is charged. Thus, it is possible to provide such system that an unused product-in-circulation delivered to a service receiver in advance is not charged, and only the product-in-circulation that has been actually used is charged.

Note that, the present invention is applicable not only to existing products-in-circulation such as daily necessities, office supplies, and industrial parts, but also to any material products-in-circulation other than products-in-circulation whose period-before-expiring is extremely short, for example, within a week.

Thus, it is not necessary for a service receiver to manage the stock, and unnecessary advance expense can be curbed. Further, the service provider can certainly secure customers, so that it is possible to sell products-in-circulation steadily.

Further, the most characteristic point of the present invention is as follows. Even when products-in-circulation of the same kind are dealt, an account is calculated in accordance with expiring date data (for example, period-before-expiring, quality guarantee period) of a product-in-circulation, so that it is possible to lower a price of the product-in-circulation whose period-before-expiring is short in a case where the products-in-circulation of the same kind are different from each other in the period-before-expiring due to difference of the manufacturing date. Thus, it is possible to provide an account system which can solve such problem that a product-in-circulation whose period-before-expiring is short is hard to be purchased.

Further, in a case where performance of a product-in-circulation degrades or deteriorates with passage of time compared with initial performance at a time when the product-in-circulation was manufactured, an account can be varied by considering degrading or deterioration of the performance, so that it is possible to provide a rational accounting system whereby an account can be calculated according to current performance at a time when the product-in-circulation is used.

Further, even when the obvious degrading or deterioration is not found in a product-in-circulation, there is a case where expiring date data is written and displayed. Conventionally, this often influenced determination on whether to purchase the product-in-circulation or not. For example, in a case where products-in-circulation of the same or similar kind which are different only in the expiring date exist in a shop at the same time, there is a possibility that a product-in-circulation whose period-before-expiring is longer is selected and a product-in-circulation whose period-before-expiring is shorter remains unsold. However, according to the present invention, it is possible to exclude such anxiety of consumers, and it is possible to obtain such effect that sales can be promoted.

Further, since expiring date data is registered in the terminal, it is not required to form the data in a product-in-circulation in a case where there is no obligation to write the data on the product-in-circulation itself. Thus, it is not required to obtain expiring date data from the product-in-circulation, and it is possible to obtain the expiring date data easily by a computer operation performed by a service provider.

Note that, the present invention is particularly applicable in the following case. If period-before-expiring is several years and a product-in-circulation which was delivered in advance is not used, it is possible that the product-in-circulation is collected and is used for another service receiver, or it is possible to provide the product-in-circulation at a price lowered in accordance with the period-before-expiring when the product-in-circulation is sold to another service receiver. By so doing, it is possible to promote the sales. Thus, the present invention is particularly effective in a service method in which collection of products-in-circulation is permitted.

Further, in order to achieve the foregoing object, the service management method of the present invention makes a computer execute the steps of: accessing management data which records, as required, (a) unique data to specify each product-in-circulation delivered to a service receiver, (b) expiring date data of the product-in-circulation, and (c) status on use of the product-in-circulation used by the service receiver, so as to specify a product-in-circulation recognized to be purchased by the service receiver, and so as to read out the expiring date data of the product-in-circulation that has been specified; calculating a period-before-expiring of the product-in-circulation that has been specified, in accordance with the expiring date data that has been read out; and calculating an account of the specified product-in-circulation, and the account is varied according to the calculated period-before-expiring.

According to the arrangement, the management data records, as required, the unique data to specify each product-in-circulation delivered to the service receiver and the expiring date data of the product-in-circulation and the status on use (unused, in use, used etc.) of the product-in-circulation used by the service receiver. As to obtaining the status on use of the product-in-circulation, a computer may receive the status on use of the product-in-circulation via a network from a communication apparatus on the side of the service receiver as described above, or a service person dispatched by the service provider may grab the status on use of the product-in-circulation used by the service receiver so as to transmit the status on use from a communication terminal of the service person to the computer, or the service person may take it back to the service station so as to enter the status on use into the computer manually. The foregoing and similar manners can be employed.

Further, as long as the management data can be accessed by a computer, it does not matter whether memory means of the management data is provided in or outside a computer, or it does not matter whether the memory means is detachable with respect to the computer or not. Further, the memory means may be managed by another computer connected by a network.

In accordance with such status on use and unique data recorded in the management data, a computer can specify a product-in-circulation recognized to be purchased by a service receiver. Further, expiring date data of the specified product-in-circulation is read out from the management data so as to calculate a period-before-expiring in which the product-in-circulation can be used effectively, so that an account which varies according to the period-before-expiring is calculated.

Thus, as described above, it is possible to provide an extremely rational accounting system whereby an account, which varies depending on performance of a product-in-circulation and according to a period-before-expiring, is charged to a service receiver after the product-in-circulation has been actually used.

Further, in order to achieve the foregoing object, the service management method of the present invention, in which a computer causes a product-in-circulation for use in operating a machine to be provided, makes a computer execute the steps of: causing (arithmetic processing means of) a terminal managed by a service provider to register unique data of a product-in-circulation delivered to a service receiver and expiring date data of the product-in-circulation in (memory means of) the terminal; causing (read-out means of) a machine provided on a side of the service receiver to read out the unique data of the product-in-circulation installed in the machine; transmitting data which contains at least the unique data that has been read out (by transmission/reception means in accordance with control of a controller section) to the service provider; causing (communications means of) the terminal managed by the service provider to detect the data via a network; recognizing installation of the product-in-circulation in the machine as a purchase action in accordance with the unique data that has been detected (by the arithmetic processing means of the terminal); and calculating (by the arithmetic processing means of the terminal) an account of the product-in-circulation that has been regarded as the purchased, of all products-in-circulation delivered to the service receiver, in accordance with the expiring date data of the product-in-circulation.

According to the arrangement, by a simple step on the side of the service receiver in which unique data of a product-in-circulation installed in a machine is read out, the terminal managed by the service receiver detects use of the product-in-circulation and determines whether the use should be recognized as purchase or not in accordance with the unique data (for example, in accordance with judgement that the unique data is received for the first time), so that it is possible to obtain a basic effect that it is possible to know precisely how many products-in-circulation are actually used.

Further, the most characteristic point of the present invention is as follows. Also as described above, it is possible to provide an extremely rational accounting system whereby an account, which varies depending on performance of a product-in-circulation and according to a period-before-expiring, is charged to a service receiver after the product-in-circulation has been actually used.

Note that, if a machine provided on the side of the service receiver executes automatically the steps of reading out unique data of a product-in circulation and transmitting data which contains at least the unique data that has been read out to the service provider, it is possible to execute the foregoing steps without fail so that the service receiver does not have to pay attention to the execution and avoids trouble in the execution. Further, since the foregoing steps are executed via a network, it is possible to perform a real time process.

Further, by the step of reading out unique data of a product-in-circulation installed in a machine provided on the side of a service receiver, it is possible to execute the step of obtaining status on use of the product-in-circulation used by the service receiver and the step of recognizing use of the product-in-circulation as a purchase action in a case where the status on use of the product-in-circulation is judged to be the use of the product-in-circulation. Both the steps can be executed at the same time. Thus, it is possible to make the process simpler.

Further, data formed in a product-in-circulation is data to specify each product-in-circulation. If products-in-circulation having the same unique data have already been registered by a service provider, a checking operation is performed for a reason that two or more products-in-circulation having the same unique data exist. Typically, a product-in-circulation detected later is likely to be a pirated version (having unique data which is a duplicate of a regular product's unique data), and the service provider can take a measure for excluding the pirated version.

Further, in order to achieve the foregoing object, the service management apparatus of the present invention includes: a product-in-circulation data memory section for registering data to specify a product-in-circulation delivered to a service receiver and expiring date data of the product-in-circulation in pairs; an input section for inputting status on use of the product-in-circulation; and an arithmetic processing section for calculating an account of a product-in-circulation that has been actually used, of all products-in-circulation delivered to the service receiver, in accordance with the expiring date data of the product-in-circulation.

According to the arrangement, the arithmetic processing section detects that a product-in-circulation is used and specifies the used product-in-circulation in accordance with data to specify a product-in-circulation that has been registered in the product-in-circulation data memory section and data of the status on use that has been entered via the input section, and reads out expiring date data concerning the specified product-in-circulation from the product-in-circulation data memory section, so that it is possible to calculate an account of the product-in-circulation.

Thus, in the service management apparatus of the present invention, it is possible to collectively manage a basic service whereby an unused product-in-circulation that has been delivered in advance is not charged, and only the product-in-circulation that has been actually used is charged.

Further, as an effect particular to the present invention, it is possible to obtain the following advantage. Even when products-in-circulation of the same kind are dealt, an account of each used product-in-circulation is calculated in accordance with expiring date data of the product-in-circulation. Thus, for example, it is possible to promote the sales of products-in-circulation by setting an account of a product-in-circulation whose use-by date nearly expires to be less than a basic account. As a result, it is possible to clear away stocks kept by a service provider.

Note that, as long as data to specify the product-in-circulation (for example, model name, model number etc.) and service receiver data are recorded in pairs upon registering, it is possible to specify a service receiver who have used the product-in-circulation in the terminal, even in a case where the service receiver transmits only the product-in-circulation data to the terminal while using the product-in-circulation. Thus, compared with a case where unique data of a product-in-circulation and service receiver data are received in pairs upon using the product-in-circulation, it is possible to reduce the amount of data which should be received. Thus, it is possible to reduce input load and arithmetic processing load.

Further, an input section for inputting status on use of a product-in-circulation may be input means whereby an operator of the service management apparatus inputs data manually, or may be input means having an interface into which data is input via physical lines or radio transmission such as infrared line communication form, for example, a portable data processing apparatus into which data of status on use is input by a service person etc.

Further, the arithmetic processing section may calculate an account by performing a program process in which calculation based on an arithmetic expression is performed, or may calculate by performing a process in which a look-up table is used. The look-up table outputs an account by adjusting an account calculated in advance, corresponding to a period-before-expiring that has been calculated from expiring date data.

Further, in order to achieve the foregoing object, the service management apparatus of the present invention includes: a product-in-circulation data memory section for registering unique data to specify each product-in-circulation delivered to a service receiver and expiring date data in pairs; a communications section for detecting use of the product-in-circulation via a network; and an arithmetic processing section for calculating an account of a product-in-circulation that has been detected being used, of all products-in-circulation delivered to the service receiver, in accordance with the expiring date data of the product-in-circulation.

According to the arrangement, in addition to the foregoing effects, the communications section detects use of a product-in-circulation via a network, so that the service provider can obtain the purchase status on the side of the service receiver remote from the service provider without fail and in a substantially real time process.

Further, since unique data is allocated to each product-in-circulation provided to a service receiver and is registered in the memory section, it becomes easier to perform electrical management. Further, for example, in a case of an image forming apparatus, according to whether or not unique data of a product-in-circulation received from the product-in-circulation installed in an image forming apparatus is identical to data which has been registered, the arithmetic processing section can judge electrically whether it is a case where the same product-in-circulation is detached and attached in removing jammed papers etc. or a case where the product-in-circulation is replaced with a new product-in-circulation. Thus, in a case where data of an installed product-in-circulation is new, notice of the foregoing case can be recognized as a purchase action for the product-in-circulation.

Note that, as long as unique data of the product-in-circulation and service receiver data are stored in pairs upon registering, it is possible to specify a service receiver in accordance with the unique data of the product-in-circulation even though plural service receivers exist. That is, it is possible to manage not only a product-in-circulation but also a service receiver by using unique data of the product-in-circulation as basic management data.

Further, compared with a case where unique data of a product-in-circulation and contract signer data are received in pairs upon using the product-in-circulation, it is possible to reduce the amount of data which should be received. Thus, it is possible to reduce input load and arithmetic processing load.

Further, in order to achieve the foregoing object, the service management network system of the present invention includes: a first group and a second group, wherein the first group is a machine in which a product-in-circulation, having unique data, which is consumed or degraded, is installed so as to be detachable, and the machine has: (a) a read-out section for detecting unique data of the product-in-circulation from the product-in-circulation; (b) a transmitter section for externally transmitting the unique data that has been read out via a network; and (c) a controller section for controlling the read-out section and the transmitter section, and the second group is a service management apparatus having: (a) a communications section for performing communications with the first group; (b) a product-in-circulation data memory section for registering the unique data of the product-in-circulation and expiring date data of the product-in-circulation generated in the first group; and (c) an arithmetic processing section for confirming status on use of the product-in-circulation so as to calculate an account of a used product-in-circulation, of all products-in-circulation delivered to a service receiver, in accordance with the expiring date data of the product-in-circulation.

According to the arrangement, it is possible to realize the service management method that has already been described, by using a network system and an IT technique such as an IC chip.

If the network system is characterized in that the machine is an image forming apparatus, it is possible to collectively manage, via a network, product-in-circulation data of a delivered toner cartridge etc. with respect to the image forming apparatus connected to the network.

Further, in order to achieve the foregoing object, the service management network system of the present invention includes: a first group and a second group, wherein the first group is a machine having: (a) a read-out section for detecting unique data of a product-in-circulation from the product-in-circulation having the unique data; (b) a transmitter/receiver section for externally transmitting the unique data that has been read out via a network; and (c) a controller section for controlling the read-out section and the transmitter/receiver section, and the second group is a service management apparatus having: (a) a communications section for performing communications with the first group; (b) a product-in-circulation data memory section for registering the unique data of the product-in-circulation and expiring date data of the product-in-circulation generated in the first group; and (c) an arithmetic processing section for confirming status on use of the product-in-circulation so as to calculate an account of a used product-in-circulation, of all products-in-circulation delivered to a service receiver, in accordance with the expiring date data of the product-in-circulation.

According to the arrangement, a serviced object is not restricted to a product-in-circulation required in operating the machine, and substantially all the general articles which are typically circulated can be delivered to a service receiver as stocks. Thus, it is possible to service all the articles that can be charged according to the status on use.

The causes of this are as follows. The read-out section of the machine can detect unique data of a product-in-circulation from the product-in-circulation having the unique data, so that it is not necessary that the product-in-circulation is installed in the machine. Further, as to substantially all the articles that are typically circulated, unique data for specifying each article can be added to the article by means of various data recording forms such as IC chips and bar codes.

Note that, an input section for entering the status on use of a product-in-circulation may be provided on the service management apparatus additionally, and the status on use of the product-in-circulation may be updated by entering data via the input section as required.

Further, in order to achieve the foregoing object, the service management method of the present invention makes a computer program executes the steps of: registering (by input means provided in a terminal used as a computer) unique data of a product-in-circulation delivered to a service receiver and number of times collected data of the product-in-circulation (as a product-in-circulation table) in a memory section that is capable of being accessed by a computer; detecting (by communications means provided in the terminal) use of the product-in-circulation used by the service receiver via a network; recognizing (by arithmetic processing means provided in the terminal) the use that has been detected as a purchase action; and calculating an account of a product-in-circulation recognized as the purchase action by considering the number of times collected data of the product-in-circulation, of all products-in-circulation.

According to the arrangement, an unused product-in-circulation that has been merely delivered to the service receiver is not charged, and an account calculated with respect to a product-in-circulation that is recognized to be purchased by the service receiver is charged to the service receiver. As a result, it is possible to provide such rational service that the service receiver is not charged for an unnecessary product, and the load of the service receiver required in stock management is reduced and the service receiver can curtail unnecessary advance expenses. Further, the service provider can certainly secure customers by providing the foregoing service, so that it is possible to sell products-in-circulation steadily.

Further, an account is calculated based on the number of times collected data of a product-in-circulation which can be managed with a numerical value, so that it is possible to exclude vagueness which tends to occur in calculating an account. Further, even in a case where the same product-in-circulation is dealt, an account can be varied according to how many times the product-in-circulation has been collected. Thus, for example, a product-in-circulation which has been collected frequently is charged less, so that it is possible to promote the sales of the product-in-circulation which has been collected frequently.

The number of times collected data is registered in and is managed by a memory section, so that it is not required to generate the data with respect to the product-in-circulation basically. Thus, it is not required to obtain the number of times collected data from the product-in-circulation, and it is possible to obtain the data easily by a computer operation performed by the service provider and it is possible to update the data easily by processing the data electrically.

Note that, a basic account may be varied by reflecting a price reduction effect which is brought about by a mass production, or price lowering which is performed to promote the sales of a product which is hard to sell because long time has passed since the product became on sale, and by further reflecting rise of a price which occurs on the basis of unbalance between the demand and the supply.

Note that, the number of times collected data may include not only the number of times collected but also additional information such as “SCRATCH ON THE SURFACE” or “NO WRAPPING”.

Further, in order to achieve the foregoing object, the service management method of the present invention, in which a computer cuases a product-in-circulation for use in operating a machine to be provided, makes the computer execute the steps of: causing a terminal managed by a service provider to register unique date of the product-in-circulation delivered to a service receiver and number of times collected data of the product-in-circulation in memory means which that is capable of being accessed by the computer; causing a machine provided on a side of the service receiver to read out unique data of a product-in-circulation installed in the machine; transmitting data, that includes the unique data of the product-in-circulation, to a terminal managed by the service provider; causing the terminal managed by the service provider to detect the data via a network; recognizing installation of the product-in-circulation in the machine as a purchase action in accordance with the unique data of the product-in-circulation; and calculating an account of a product-in-circulation recognized to be the purchase action in accordance with the number of times collected data of the product-in-circulation.

According to the arrangement, use of the product-in-circulation is detected by a simple step in which the unique data of the product-in-circulation installed in the machine is read out on the side of the service receiver, and whether the use of the product-in-circulation is equivalent to purchase or not is determined on the side of the service provider, so that it is possible to know how many products-in-circulation has been consumed, with a numeric value precisely.

Further, the terminal managed by the service provider calculates an account in accordance with the number of times collected data of a product-in-circulation which can be managed with a numerical value. Thus, even in a case where the same product-in-circulation is dealt, the account can be varied depending on how many times the product-in-circulation has been collected. Thus, for example, a product-in-circulation which has been collected frequently is charged less, so that it is possible to promote the sales of the product-in-circulation which has been collected frequently.

Note that, when the step of reading out unique data of a product-in-circulation and the step of transmitting data which contains at least the read out data to the service provider are executed automatically by the machine provided on the side of the service receiver, it is possible to execute the steps without fail while the service receiver does not pay attention to the execution and does not feel any trouble. Further, since the process is performed via a network, a real time process can be realized.

Further, in accordance with the step of reading out unique data of a product-in-circulation installed in a machine provided on the side of the service receiver, not only the step of obtaining the status on use of a product-in-circulation used by the service receiver, but also the step of recognizing the use of the product-in-circulation as a purchase action in the case where the status on use is judged to be the use of the product-in-circulation, are executed at the same time. Thus, it is possible to simplify the process.

In order to achieve the foregoing object, the service management method of the present invention includes: a product-in-circulation data recording section for registering unique data of a product-in-circulation delivered to a service receiver and number of times collected data in pairs; an input section for inputting status on use of the product-in-circulation; and an arithmetic processing section for calculating an account of the product-in-circulation by considering the number of times collected data of the product-in-circulation.

According to the arrangement, the arithmetic processing section takes in the number of delivered products-in-circulation from data of the products-in-circulation registered in the product-in-circulation data recording section, and subtracts the number of used products-in-circulation from the number of the delivered products-in-circulation, so that it is possible to know how many products-in-circulation are actually used. Thus, it is possible to collectively manage such service that unused products-in-circulation that has been delivered in advance are not charged and only products-in-circulation that has been actually used are charged.

Since the service management apparatus calculates an account in accordance with the number of times collected data of a product-in-circulation which can be managed with a numerical value, even in a case where the same product-in-circulation is dealt, an account can be varied depending on how many times the product-in-circulation has been collected. Thus, for example, a product-in-circulation which has been collected frequently is charged less, so that it is possible to promote the sales of the product-in-circulation which has been collected frequently. As a result, it is possible to clear away stocks kept by a service provider.

As long as unique data of a product-in-circulation or data for specifying the product-in-circulation (for example, model name, model number etc.) and service receiver data are recorded in pairs upon registering, it is possible to specify a service receiver who used the product-in-circulation in the service management apparatus, even in a case where the service receiver transmits only the data of the product-in-circulation to the service management apparatus while using the product-in-circulation. Thus, compared with a case where unique data of a product-in-circulation and service receiver data are received in pairs upon using the product-in-circulation, it is possible to reduce the amount of data which should be received. Thus, it is possible to reduce input load and arithmetic processing load.

Further, in order to achieve the foregoing object, the service management apparatus of the present invention includes: a product-in-circulation data recording section for registering unique data of a product-in-circulation delivered to a service receiver and number of times collected data of the product-in-circulation in pairs; a communications section for detecting use of the product-in-circulation via a network; and an arithmetic processing section for calculating an account of a product-in-circulation detected being used by means of the communications section, of all products-in-circulation delivered to the service receiver, in accordance with the number of times collected data of the product-in-circulation.

According to the arrangement, since the communications section can detect use of a product-in-circulation by receiving data from a network, it is not required to confirm the use of the product-in-circulation additionally. Thus, it is possible to save trouble that the service receiver and the service provider would have.

Since unique data is allocated to each product-in-circulation provided to a service receiver and is registered in the memory section, it becomes easier to perform electrical management. Further, for example, according to whether or not unique data of a product-in-circulation received from the product-in-circulation installed in an image forming apparatus is identical to data which has been registered, the arithmetic processing section electrically determines whether it is a case where the same product-in-circulation is detached and attached or a case where the product-in-circulation is replaced with a new product-in-circulation. Thus, in a case where the data of an installed product-in-circulation is new, notice of the foregoing case can be recognized as a purchase action for the product-in-circulation.

Since the communications section detects use of a product-in-circulation via a network, a service provider can obtain status on purchase on the side of the service receiver remote from the service provider in a substantially real time process.

As long as unique data of a product-in-circulation and service receiver data are stored in pairs upon registering, it is possible to specify a service receiver in accordance with the unique data of the product-in-circulation even though plural service receivers exist. That is, it is possible to manage not only a product-in-circulation but also a service receiver by using unique data of a product-in-circulation as basic management data. Further, in a using process of a product-in-circulation, even in a case where a service receiver transmits only the unique data of a product-in-circulation to the service management apparatus, the service management apparatus can specify the service receiver who used the product-in-circulation. Thus, compared with a case where unique data of a product-in-circulation and service receiver data are received in pairs upon using the product-in-circulation, it is possible to reduce the amount of data which should be received. Thus, it is possible to reduce input load and arithmetic processing load.

Further, in order to achieve the foregoing object, the service management network system of the present invention includes: a first group and a second group, wherein the first group is a machine in which a product-in-circulation, having unique data, which is consumed or degraded, is installed so as to be detachable, and the machine has: (a) a read-out section for detecting unique data of the product-in-circulation from the product-in-circulation; (b) a transmitter section for externally transmitting data which contains the unique data via a network; and (c) a controller section for controlling the read-out section and the transmitter section, and the second group is a service management apparatus having: (a) a product-in-circulation data recording section for registering the unique data of the product-in-circulation and number of times collected data of the product-in-circulation; (b) a communications section for performing communications with the first group so as to obtain the data which contains the unique data; and (c) an arithmetic processing section for calculating an account of a product-in-circulation detected being used in accordance with the data, of all products-in-circulation delivered to the first group, by considering the number of times collected data of the product-in-circulation.

According to the arrangement, it is possible to realize the service management method described above by using a network system and electric management of the number of times collected, and an IT technique such as an IC chip.

Note that, in a case of a system in which an image forming apparatus is used as the machine, it is possible to collectively manage, via a network, product-in-circulation data of a toner cartridge etc. in the image forming apparatus connected to the network.

Further, in order to achieve the foregoing object, the service management network system of the present invention includes: a first group and a second group, wherein the first group is a machine having: (a) a read-out section for detecting unique data of a product-in-circulation from the product-in-circulation having the unique data; (b) a transmitter section for externally transmitting data which contains the unique data via a network; and (c) a controller section for controlling the read-out section and the transmitter section, and the second group is a service management apparatus having: (a) a product-in-circulation data recording section for registering the unique data of the product-in-circulation and number of times collected data of the product-in-circulation; (b) a communications section for performing communications with the first group so as to obtain the data which contains the unique data; and (c) an arithmetic processing section for calculating an account of a product-in-circulation detected being used in accordance with the data, of all products-in-circulation delivered to the first group, by considering the number of times collected data of the product-in-circulation.

According to the arrangement, a serviced object is not restricted to a product-in-circulation for use in operating a machine, and it is possible to service substantially all the general articles that are typically circulated, that is, all the articles that can be delivered to the service receiver as stocks and can be charged according to the number of articles used actually.

The causes of this are as follows. A read-out section of a machine can detect unique data of a product-in-circulation from the product-in-circulation having the unique data, so that it is not necessary that the product-in-circulation is installed in the machine. Further, as to substantially all the articles that are typically circulated, unique data for specifying each article can be added to the article by means of various data recording forms such as IC chips and bar codes.

Note that, an input section for entering the status on use of a product-in-circulation may be provided in the service management apparatus, and the status on use of the product-in-circulation may be updated by manually entering data by means of the input section as required.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a schematic view showing a service management network system of the present invention.

FIG. 2 is a schematic perspective view showing a form of a product-in-circulation of the present invention.

FIG. 3 is an explanatory drawing showing connection of a service management network system of the present invention.

FIG. 4 is a drawing to describe how a product-in-circulation of the present invention is packed.

FIG. 5(a) to FIG. 5(c) are drawings to describe a circulation form of a product-in-circulation of the present invention.

FIG. 6(a) to FIG. 6(c) are drawings which show an example of a product-in-circulation data table in which product-in-circulation data and the number of times collected are registered in pairs.

FIG. 7 and FIG. 7(b) are drawings which show an example of a contract signer table displayed on a data manager window.

FIG. 8(a) and FIG. 8(b) are drawings which show an example of a management table (by default) displayed on the data manager window.

FIG. 9(a) and FIG. 9(b) are drawings which show an example of the management table (upon advance registration) displayed on the data manager window.

FIG. 10(a) and FIG. 10(b) are drawings which show an example of the management table (during use of a product-in-circulation) displayed on the data manager window.

FIG. 11(a) and FIG. 11(b) are drawings which show an example of the management table (upon replacement of a product-in-circulation) displayed on the data manager window.

FIG. 12(a) and FIG. 12(b) are drawings which show an example of the management table (upon collection of a product-in-circulation) displayed on the data manager window.

FIG. 13 is a drawing to describe an accounting method.

FIG. 14 is a drawing which shows an example of a processing flow of an account processing method of the present invention.

FIG. 15 is a drawing which shows an example of an account factor table used in an account process of the present invention.

FIG. 16(a) and FIG. 16(b) are drawings which show an example of a basic account table used in the account process of the present invention.

FIG. 17(a) and FIG. 17(b) are drawings which show an example of unique data/contract signer ID table of the present invention.

FIG. 18 is a drawing which shows an example of a processing flow of a process in which the number of times collected is updated.

FIG. 19 is a drawing which shows an example of a processing flow of a process in which the unique data/contract signer ID table shown in FIG. 17 is updated.

FIG. 20 is a schematic view showing another service management network system of the present invention.

FIG. 21(a) and FIG. 21(b) show another example of a machine used in the service management network system shown in FIG. 20.

FIG. 22(a) to FIG. 22(c) are drawings which show an example where a typical article is integrated with its unique data.

FIG. 23(a) to FIG. 23(c) are drawings which show another example where a typical article is integrated with its unique data.

FIG. 24(a) to FIG. 24(c) are drawings which show still another example where a typical article is integrated with its unique data.

FIG. 25(a) to FIG. 25(c) show still another example of a machine used in the service management network system shown in FIG. 20.

FIG. 26 is a drawing which shows how a terminal management table is connected to a customer table by using a contract signer ID as a key in the service management network system shown in FIG. 20.

FIG. 27 is a drawing which shows an example of a management table (by default) displayed on a data manager window in the service management network system shown in FIG. 20.

FIG. 28 is a drawing which shows an example of the management table (upon advance registration) displayed on the data manager window in the service management network system shown in FIG. 20.

FIG. 29 is a drawing which shows an example of the management table (during use of a product-in-circulation) displayed on the data manager window in the service management network system shown in FIG. 20.

FIG. 30 is a drawing which shows an example of the management table (upon collection of a product-in-circulation) displayed on the data manager window in the service management network system shown in FIG. 20.

FIG. 31 is a drawing which shows an example of the management table (upon collection of a product-in-circulation) in a case where display concerning a product-in-circulation to be collected is deleted in the management table shown in FIG. 30.

FIG. 32 is a drawing to describe a charging process in the service management network system shown in FIG. 20.

FIG. 33 is a drawing which shows an example of a processing flow in which an initial registration of a service management table is performed.

FIG. 34 is a drawing which shows an example of a processing flow in which a first update of the service management table is performed.

FIG. 35 is a drawing which shows an example of a processing flow which includes second and subsequent updates of the service management table.

FIG. 36 is a drawing which shows an example of a processing flow which includes an update of the service management table performed upon collection of a product-in-circulation.

FIG. 37 is a schematic view showing still another service management network system of the present invention.

FIG. 38(a) and FIG. 38(f) are drawings which show a timing chart to describe an operation of a machine.

FIG. 39 is a flow chart showing a flow of a control operation of an arithmetic processing section with respect to an automatic update process of a spare cartridge table.

FIG. 40 is a schematic view showing another service management network system of the present invention.

FIG. 41(a) to FIG. 41(e) are drawings to describe an advance request method with respect to a product-in-circulation.

FIG. 42(a) to FIG. 42(c) are schematic perspective view showing an example of a second terminal used in the service management network system shown in FIG. 20.

FIG. 43(a) to FIG. 43(c) show still another example of a machine used in the service management network system shown in FIG. 20.

FIG. 44 shows still another example of a machine used in the service management network system shown in FIG. 20.

FIG. 45(a) and FIG. 45(b) show still another example of a machine used in the service management network system shown in FIG. 20.

FIG. 46(a) and FIG. 46(b) are drawings which show an example of a product-in-circulation data table in which product-in-circulation data and expiring data are registered in pairs.

FIG. 47(a) and FIG. 47(b) are drawings which show an example of the management table (by default) displayed on the data manager window.

FIG. 48(a) and FIG. 48(b) are drawings which show an example of the management table (upon advance registration) displayed on the data manager window.

FIG. 49(a) and FIG. 49(b) are drawings which show an example of a management table (during use of a product-in-circulation) displayed on the data manager window.

FIG. 50(a) and FIG. 50(b) are drawings which show an example of the management table (upon replacement of a product-in-circulation) displayed on the data manager window.

FIG. 51(a) and FIG. 51(b) are drawings which show an example of the management table (upon collection of a product-in-circulation) displayed on the data manager window.

FIG. 52 is a drawing which shows an example of a processing flow of an accounting process of the present invention.

FIG. 53 is a drawing which shows an example of an account factor table used in the accounting process of the present invention.

FIG. 54 is a drawing which shows an example of a processing flow of a process for calculating a period-before-expiring.

FIG. 55 is a drawing which shows an example of the management table (by default) displayed on the data manager window in the service management network system shown in FIG. 20.

FIG. 56 is a drawing which shows an example of the management table (upon advance registration) displayed on the data manager window in the service management network system shown in FIG. 20.

FIG. 57 is a drawing which shows an example of the management table (during use of a product-in-circulation) displayed on the data manager window in the service management network system shown in FIG. 20.

FIG. 58 is a drawing which shows an example of the management table (upon collection of a product-in-circulation) displayed on the data manager window in the service management network system shown in FIG. 20.

### DESCRIPTION OF THE EMBODIMENT

[Embodiment 1]

(Product-in-Circulation)

In the present embodiment, a product-in-circulation means a part of an apparatus in terms of a function, and replacement of the product-in-circulation enables the apparatus to restore and keep its function. For example, in a case where the apparatus is an image forming apparatus, a toner cartridge or a developing cartridge, a photosensitive body cartridge, a cartridge in which a developing member and a photosensitive body are formed integrally, an ink cartridge, and a cartridge in which an ink tank and a printing head are formed integrally, are regarded as the product-in-circulation. In this industry, these products are called supply products.

General products-in-circulation which do not necessarily constitute part of an apparatus will be described in later embodiments.

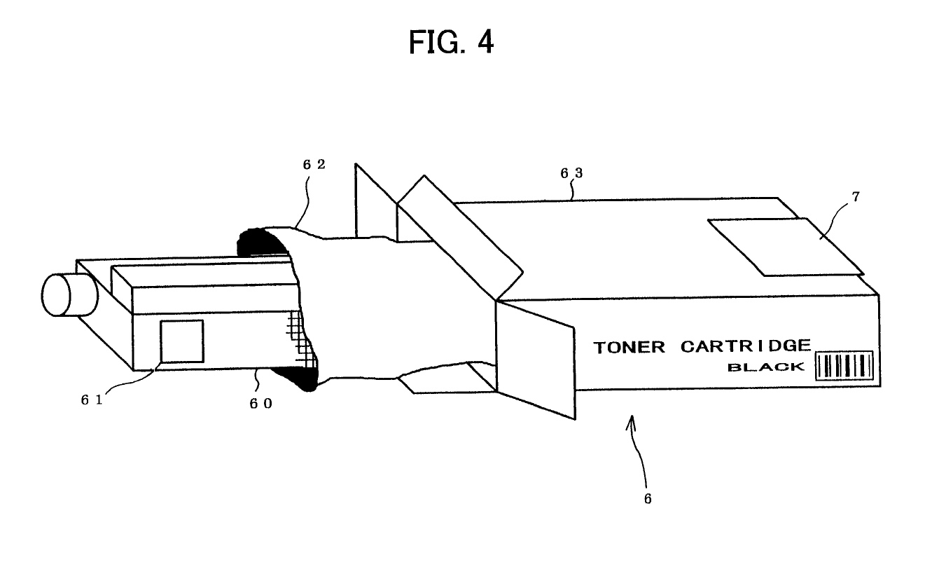

FIG. 4 shows a general example of a case where a product-in-circulation 6 is a toner cartridge. A toner cartridge 60 in a circulating state is wrapped or packed with a wrapping material 62 or a packing material 63. The wrapping material 62 or the packing material 63 is used to keep the quality of the product or to protect the product, and, for example, an aluminum pack is used as the wrapping material 62, and paper or corrugated paper is used as the packing material 63, and they are not required in actually using a toner cartridge. Thus, although the wrapping material 62 and the packing material 63 are included in the product-in-circulation 6 in a circulating state, the product-in-circulation 6 installed in a machine means the toner cartridge 60.

The present invention is characterized by an IC chip 61, which functions as an unique data generating section for generating unique data with respect to the toner cartridge 60, and the IC chip can specify (identify) each product-in-circulation.

An ink cartridge of an inkjet printer is arranged in the same manner.

(Arrangement of a Network and an Apparatus)

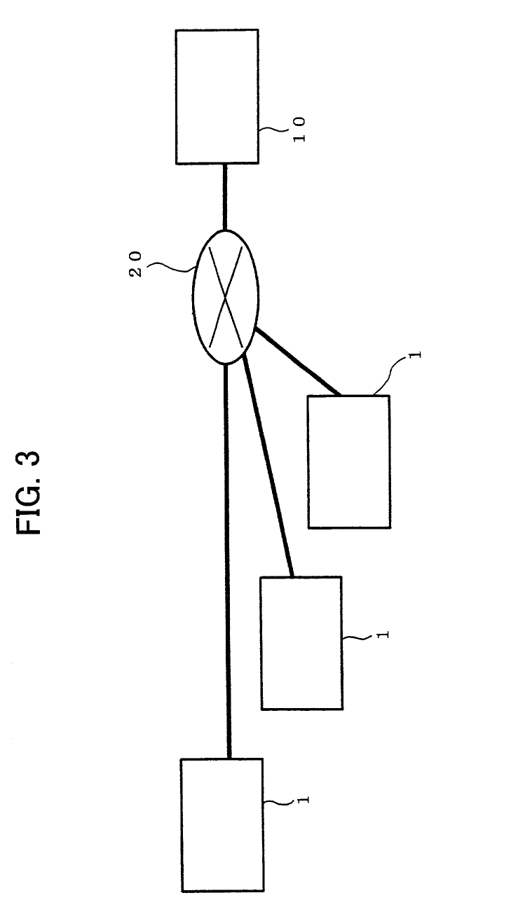

FIG. 3 shows a general arrangement of a service provider 10 and a contract signer 1 in a network.

The service provider 10 provides the contract signer 1 (service receiver) with service concerning the product-in-circulation 6 such as the toner cartridge 60 which will be concretely described later.

In a case where the service provider 10 is a leasing company etc., the service provider 10 may provide service to make a leasing contract with respect to a main body of an image forming apparatus.

The network 20 is, for example, a public network such as a telephone line. A relation between a specific contract signer 1 and the service provider 10 is described as follows.

First, the service provider 10 delivers an image forming apparatus 2 and the product-in-circulation 6 such as the toner cartridge 60 which is applicable to the image forming apparatus 2. Generally, when image forming apparatuses made by the same maker differ from each other in terms of types, it is often that products-in-circulation used in different apparatuses also differ from each other accordingly, so that a type number and a code number etc. of the product-in-circulation 6 are determined and confirmed in accordance with main body data of the image forming apparatus 2.

In this case, the number of the products-in-circulation 6, which are to be delivered, is not particularly determined, but one or more spares are enough except for a product which is immediately used in a main body of the apparatus.

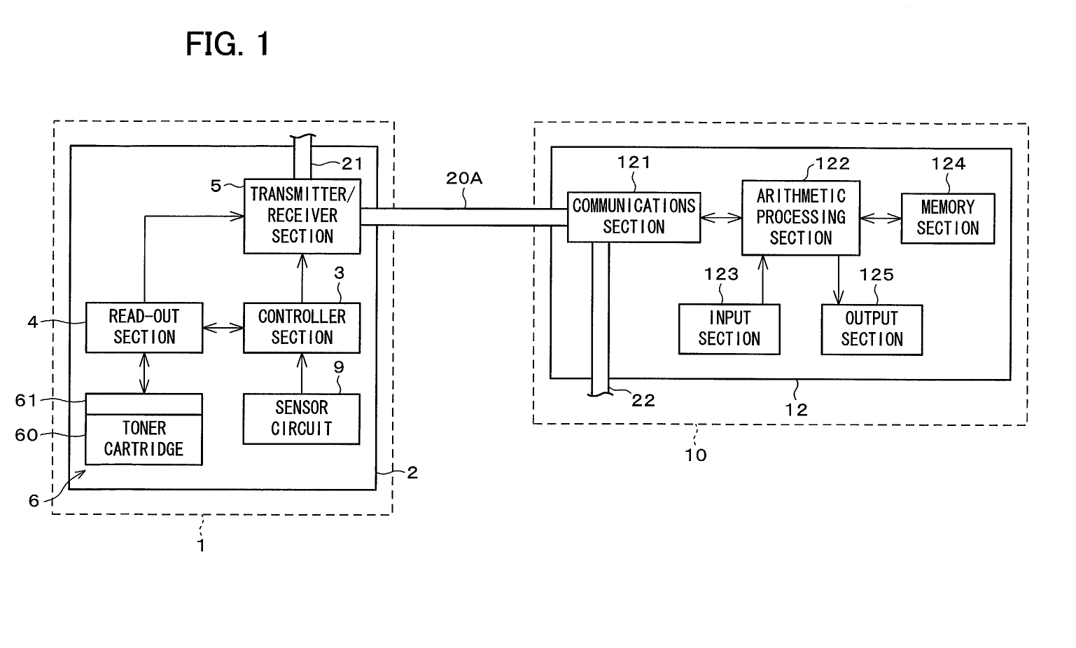

As shown in FIG. 1, the image forming apparatus 2 on the side of the contract signer 1 is connected to a terminal 12 on the side of the service provider 10 by a telephone line 20A etc. as a network 20.

An arrangement of the image forming apparatus 2 on the side of the contract signer 1 is described as follows. The image forming apparatus 2 (machine) includes: image forming means (not shown) for forming images on a recording material such as paper by toner, ink, and the like; a toner cartridge 60 used as a degradable; a read-out section 4 for reading out data (described later) formed in the toner cartridge 60; a transmitter/receiver section 5 for outputting the data that has been read out to outside; and a controller section 3 for controlling the read-out section 4 and the transmitter/receiver section 5. A sensor circuit 9 is made up of a sensor, which detects whether the toner cartridge 60 is installed in the image forming apparatus 2 or not, and peripheral circuits of the sensor, and it is often that the sensor circuit 9 is installed in a typical copying machine and a printer, so that the entire operations are based on the use of the sensor circuit 9. However, in a case where the sensor is not installed, it is possible to employ substitute means, so that the sensor is not necessarily required.

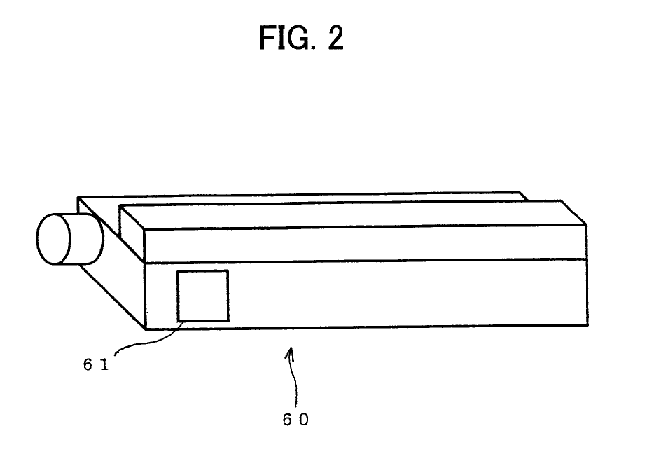

It is preferable that the toner cartridge 60 records its own unique data either on its surface or therein. For example, there is provided an IC chip (first data recording body) 61 as shown in FIG. 2 to store a product model number and an ID number in advance in internal EEPROM, ferroelectric memory, or other nonvolatile memory. Alternatively, the unique data may be recorded in the form of a bar code or other simple method, because in the present invention, the ID number recorded in the IC chip 61 is not secret and does not need special protection.

Note that, some products are conventionally marked using bar codes to distinguish between product-in-circulation for convenience in circulation and inventory management and other purposes. All the individual pieces of the same model share the same bar code to reduce labor and time in printing and management, etc. The bar code is therefore useless in distinguishing individual product-in-circulation 6 unless they are of different models or products.

This makes a sharp contrast with the present invention. According to the present invention, different bar codes are given to different pieces of product-in-circulation 6 to distinguish between individual pieces. The present invention differs from the prior art in that individual pieces of product-in-circulation 6 are distinguishable according to the present invention, but not by the use of conventional bar codes.

According to the present invention, the IC chip 61 basically records nothing but a product model number and an ID number for that particular product (in other words, ID numbers of the respective cartridges for specifying the products-in-circulation 6 individually), and does not have to be rewritten. The IC chip 61 therefore does not need to be large in memory capacity or versatile in function, permitting great simplification of both software and hardware, including memory controller.

A sensor may be provided, if necessary, to detect the quantity of remaining toner. By so doing, the quantity of the toner currently in use can be detected with improved precision.

The read-out section 4 varies depending on how data is recorded in the toner cartridge 60: if the data is recorded in the form of a bar code, the read-out section 4 is a bar code reader; if the data is recorded in an IC chip, the read-out section is electric or high frequency read-out means.

The transmitter/receiver section 5 is a modem, for example, and is connected via telephone lines or a similar network like CATV. Data may be exchanged between the image forming apparatus 2 and the terminal 12 only via physical lines or partly via radio transmission.

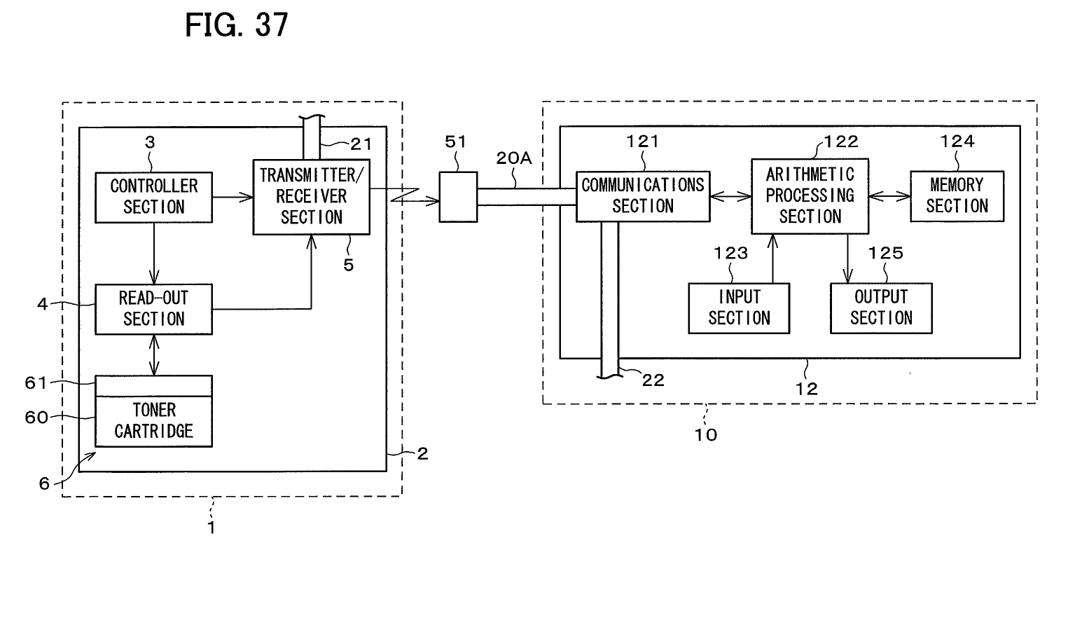

An example is shown in FIG. 37, where the transmitter/receiver section 5 provided in, or connected to, the image forming apparatus 2 transmits data to a second transmitter/receiver section 51 of the contract signer 1 via radio transmission, and the second transmitter/receiver section 51 transmits data on to the network 20 (telephone lines 20A) via physical transmission lines. Alternatively, the transmitter/receiver section 5 may be capable of connecting to a local network 21. The second transmitter/receiver section 51 may of course be connected to the a communications section 121 of the terminal 12 partly via radio transmission.

The sensor circuit 9 is composed of various sensors and peripheral circuits for processing signals from the sensors. The sensors include a door sensor and a cartridge sensor, and may be mechanical, optical, etc. The door sensor detects whether the door of the image forming apparatus 2 is open or closed. The cartridge sensor detects whether the toner cartridge 60 is installed in the image forming apparatus 2. The peripheral circuits include, among them, a filter circuit, a binarizer circuit, a voltage level adjusting circuit, and a waveform modifier circuit for modifying the waveforms of sensor outputs, so as to produce digital signals with 0 V to 5 V logical levels from sensor outputs.

The controller section 3 causes the read-out section 4 to access the IC chip 61 and read out toner cartridge data when, for example, the toner cartridge 60 is replaced. The controller section 3 further causes the transmitter/receiver section 5 to externally transmit the read-out data as required. The controller section 3 monitors signals from various sensors to give predetermined commands according to the contents of the signals. When a CPU is used to control the entire image forming apparatus, the CPU may double as the controller section 3.

Now, the contents of the data recorded in the toner cartridge 60 is described. The IC chip 61 stores in advance, for example, 0011 0001 0010 1101 1010, a 20-digit binary number which carries data (ID number) unique to a toner cartridge 60. The number of digits may vary. The number is generated by the service provider 10 and managed on a product-in-circulation data table of a product-in-circulation data memory section 124 of a terminal 12.

Next, the way the number represents data is described.

The first 4 digits represent the model of the toner cartridge 60. In this case, 16 models are distinguishable by the use of numbers 0000 through 1111. In the case of a color image forming machine using four toner cartridges 60, one for each of the four colors, Y (yellow), M (magenta), C (cyan), and Bk (black), the first two digits may represent color data. Table 1 gives such an example.

TABLE 1

| | First Digit | Second Digit |
|---|---|---|
| Bk | 0 | 0 |
| Y | 0 | 1 |
| M | 1 | 0 |
| C | 1 | 1 |

In this case, the remaining two digits can be used to distinguish between up to four models. An example is given in Table 2.

TABLE 2

| Product Name | Model Number | Third Digit | Fourth Digit |
|---|---|---|---|
| Toner Cartridge A | AR-2000TC | 0 | 0 |
| (for AR-2000) | | | |
| Toner Cartridge B | AR-2001TC | 0 | 1 |
| (for AR-2001) | | | |
| Toner Cartridge C | AR-2010TC | 1 | 0 |
| (for AR-2010) | | | |
| Toner Cartridge D | AR-2200TC | 1 | 1 |
| (for AR-2200) | | | |

Another example is given in Table 3, where two numbers represent toner cartridges A and B respectively, and the two others represent photosensitive cartridges C and D.

TABLE 3

| Product Name | Model Number | Third Digit | Fourth Digit |
|---|---|---|---|
| Toner Cartridge A | AR-2000TC | 0 | 0 |
| (for AR-2000) | | | |
| Toner Cartridge B | AR-2001TC | 0 | 1 |
| (for AR-2001) | | | |
| Photosensitive | AR-2000OPC | 1 | 0 |
| Cartridge C | | | |
| (for AR-2000) | | | |
| Photosensitive | AR-2001OPC | 1 | 1 |
| Cartridge D | | | |
| (for AR-2001) | | | |

These correspondence tables are prepared and stored in the terminal 12 of the service provider 10 as product-in-circulation data tables as will be detailed later.

The remaining sixteen digits give, in the foregoing example, toner cartridges 60 of model 0011 their own, unique numbers (unique data). Each of such toner cartridges 60 is assigned its own, unique number selected from 65536 numbers from 0000 0000 0000 0000 through 1111 1111 1111 1111. This data is also added to the product-in-circulation data table stored in the terminal 12 of the service provider 10. In the above description, the ID numbers were characterized as unique data that makes it possible to distinguish between individual toner cartridges 60; however, the model number and the ID number may collectively be treated as unique data.

Now, the structure of the terminal 12 (service management device) of the service provider 10 is described.

The terminal 12 is a personal computer (PC) or a work station (WS), and includes a communications section 121, an arithmetic processing section 122, an input section 123, a memory section 124, and an output section 125.

The communications section 121 is configured to detect the status of the product-in-circulation 6 in the image forming apparatus 2 and is a modem, for example, when the network 20 is telephone lines 20A. The communications section 121 may be capable of connecting to a local network 22.

The arithmetic processing section 122 executes operations on the data input via the communications section 121 or the input section 123, and is made of a CPU and memory. The memory is RAM or similar memory where results of operations are stored temporarily. If the operations are to be executed by software, a nonvolatile memory is provided to store a program to execute those operations. Alternatively, a memory section 124 (detailed later) may be provided to store a program that is read into RAM before it is executed.

The input section 123 is a keyboard, a mouse, a pointing device, an image scanner, a bar code scanner, or a similar device used to input data on contract signers 1, etc.

The memory section 124 (product-in-circulation data memory section, account factor memory section, basic account memory section, and list memory section) stores data entered via the communications section 121 or the input section 123, as well as results of operations executed by the arithmetic processing section 122. The memory section 124 is a hard disk, an optical disk, or a similar device. The contents of the memory section 124 include product-in-circulation data tables like those shown in Tables 1-3, contract signer data table (detailed later), service management table (management table recording updated data on the use of product-in-circulation) for contract signers, and application program which stores a processing flow of the service management method in accordance with the present invention. Note that, the memory section 124 corresponds to a recording medium of the present invention.

The foregoing tables and tables described later can be associated with each other using a common key as the main key. For example, the product-in-circulation data table, the service management table, the basic account table, and the unique data/contract signer ID table can be associated with each other by using unique data as the main key. The contract signer table, the service management table, the terminal table, and the unique data/contract signer ID table can be associated with each other using a contract signer ID as the main key.

The output section 125 corresponds to a CRT or a liquid crystal display for outputting data in the form of soft copies. Alternatively, the output section 125 corresponds to a printer for outputting data in the form of hard copies.

(Registration Process of a Product-in-Circulation Covered by the Service: Example 1)

The following will describe the workings of the system.

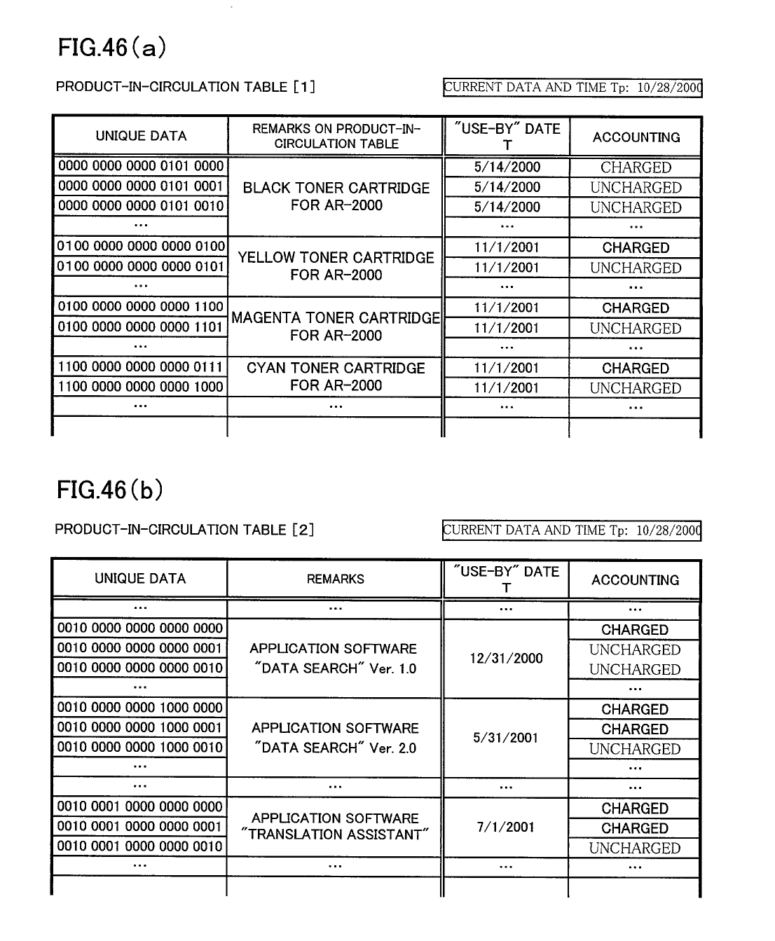

The service provider 10 creates the product-in-circulation data table [1] as shown in FIG. 46(a), and stores the table in the memory section 124. The product-in-circulation of the product-in-circulation data table [1] is covered by the service.

An important point of the product-in-circulation data table [1] is that the unique data of the product-in-circulation 6 and the expiring date data of the product-in-circulation 6 are associated with each other as a pair. Further, in the figure, the product-in-circulation data table [1] has “product-in-circulation note data” which indicates what is dealt as the -product-in-circulation 6, and “charged/non-charged data” which indicates whether the product-in-circulation 6 is charged or not.

The expiring date data is data required in calculating an account in the service of the present invention, and represents the period in which it is guaranteed that the product-in-circulation 6 is usable with a desired level of quality. The data is generally given by a date (and/or a time) of manufacture plus quality guarantee period known through experiment or actual use. The date of course varies depending on the kind of the product-in-circulation 6 and also depending on the date of manufacture and lot even for the same product-in-circulation 6. See, for example, the product-in-circulation data table [1]: the black toner cartridges for AR-2000 have different expiring dates T as unique data given in the form of “0000 XXXX XXXX XXXX XXXX” (X is either 0 or 1).

The charged/non-charged data is included subserviently and indicates whether the product-in-circulation 6 deserves to be provided in the service. Concretely, a product-in-circulation 6 indicative of “used” is a product which was used by any one of the contract signers 1 and cannot be provided in the service. Such a product may not be covered by the management if the current purpose is to manage the product in terms of validity as a subject of the service. A product-in-circulation 6 indicative of “unused” is a product which has not been used by the contract signer 1 and can be provided in the service. Such a product is valid as a subject to the service.

FIG. 46(b) shows an example of another product-in-circulation data table, and this is detailed later.

(Registration Process of a Product-in-Circulation Covered by the Service: Example 2)

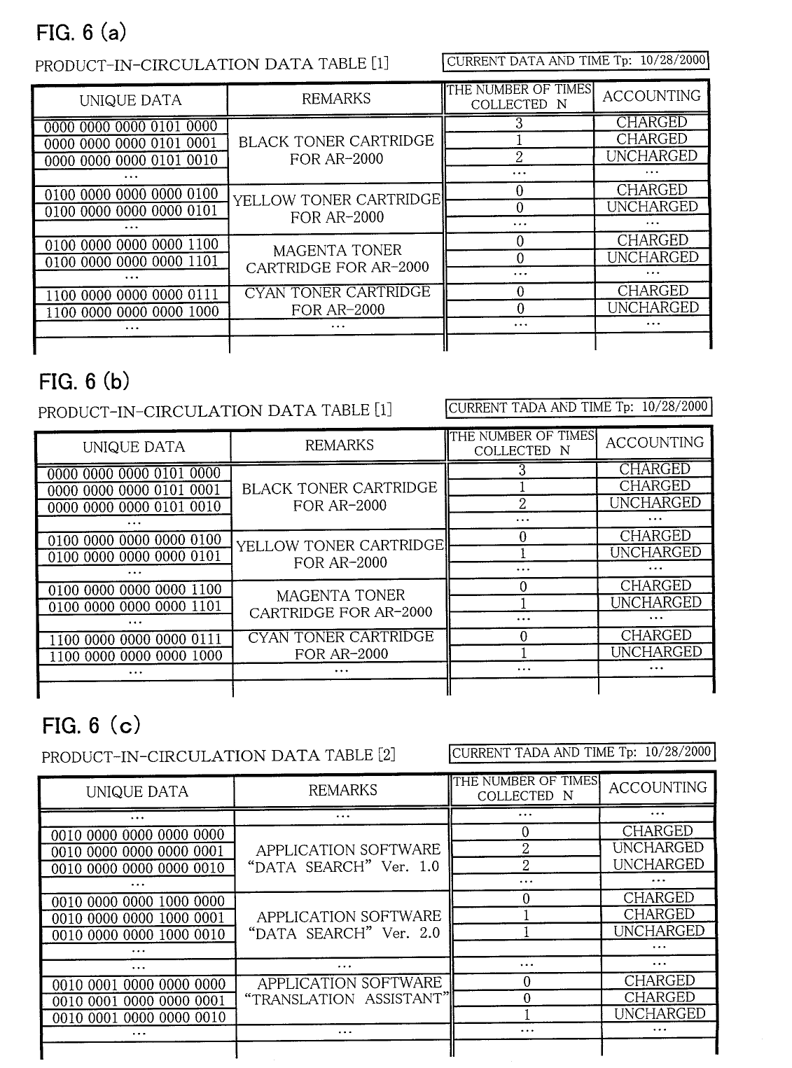

The service provider 10 creates the product-in-circulation data table [1] as shown in FIG. 6(a) and FIG. 6(b), and stores the table in the memory section 124. The product-in-circulation of the product-in-circulation table [1] is covered by the service.

An important point of the product-in-circulation data table [1] is that the unique data of the product-in-circulation 6 and number of times collected data of the product-in-circulation 6 are associated with each other as a pair. Further, the product-in-circulation data table [1] has “product-in-circulation note data” which indicates what is dealt as the product-in-circulation 6, and “charged/non-charged data” which indicates whether the product-in-circulation 6 is charged or not.

The number of times collected data is data required in calculating an account in the service of the present invention, and the data is managed by counting and renewing the number of times collected accumulated so far in a case where unused product-in-circulation 6 which has been collected is used again as an article covered by the service. An initial value is “0”, and varies with increase of the number of times collected as 1, 2, 3 . . . .

The charged/non-charged data is included subserviently and indicates whether the product-in-circulation 6 deserves to be provided in the service. Concretely, a product-in-circulation 6 indicative of “used” is a product which was used by any one of the contract signers 1 and cannot be provided in the service. A product-in-circulation 6 indicative of “unused” is a product which has not been used by the contract signer 1 and can be provided in the service.

FIG. 6(c) shows an example of another product-in-circulation data table, and this will be detailed later.

(Registration Process of Contract Signer Data)

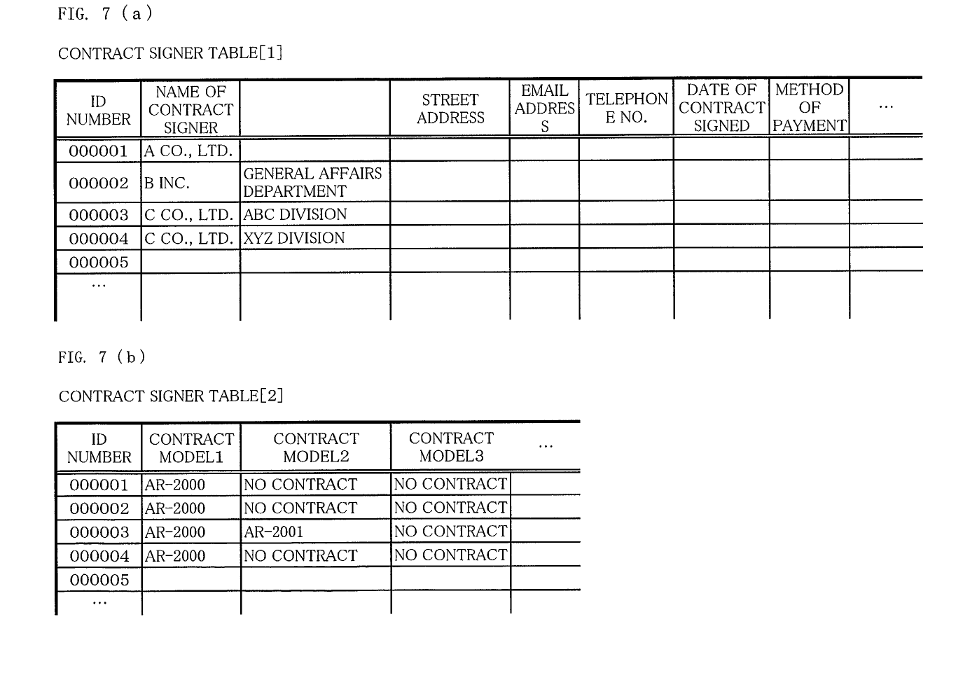

The service provider 10 obtains data on a contract signer 1 as advance data. As shown in the contract signer table [1] of FIG. 7(a), the data is data whereby one can specify the contract signer 1: for example, if the contract signer 1 is a company, the data includes a company name. The data should further include office names of a single company to distinguish between them if a separate contract is signed with each office.

Next, to process the contract signer data in the terminal 12, the service provider 10 issues a contract signer ID to each contract signer 1. Each contract signer ID is a unique number given to a contract signer 1: for example, 000125.

Then, address data is obtained to deliver a product-in-circulation 6 as serviced object. Further, payment method data is obtained to collect payments.

The foregoing data is stored in the memory section 124 of the terminal 12 in a form of an electronic file. FIG. 7(a) shows an example where the file is displayed on the output section 125 of the terminal 12.

Next, the service provider 10 dispatches a service person to the contract signer 1 to install and set up an image forming apparatus 2 and deliver the product-in-circulation 6. The image forming apparatus 2 is connected and set up so that it can communicate via the external network 20. A model number of the image forming apparatus 2 and an ID number which is unique to that particular image forming apparatus 2, as well as the issued contract signer ID, may be transmitted when the image forming apparatus 2 is connected to the external network 20.

If the service provider 10 has to know nothing but the model of the image forming apparatus owned by the contract signer 1, all the data the service provider 10 needs is the model number, product model number, or other data by which the service provider 10 can specify the model. However, if the contract signer 1 has more than one image forming apparatus of the same model, and the service provider 10 needs data about each image forming apparatus, manufacturing number or other unique data by which the service provider 10 can specify each image forming apparatus is essential.

If the image forming apparatus 2 is a copying machine, it is equipped with numeric keys to enter, for example, the number of pages to be printed; this input means can be readily used to enter the ID number of the contract signer and/or the ID number of the image forming apparatus 2 to the image forming apparatus 2. If the contract signer ID number is stored in nonvolatile memory after it is entered for the first time, the contract signer 1 does not need to enter the data again when it must be transmitted to the service provider 10. If the image forming apparatus ID number is stored in nonvolatile memory on delivery, it does not thereafter need to be entered, and these series of operations are automatically completed by electronic means. The nonvolatile memory is built in as a part of the controller section 3.

Thus, the contract signer table [2] is filled in as shown in FIG. 7(b). The table shows, for example, that the two image forming apparatuses, an AR-2000 model and an AR-2001 model, owned by the contract signer specified by the ID number 000003 are serviced in accordance with the present invention.

The contract signer table [1] and the contract signer table [2] can be combined as common data to associate ID numbers (contract signer IDs). Hence, by referring to FIG. 7(a), one can tell that the contract signer specified by the ID number 000003 in FIG. 7(b) is “ABC Division, D Co. Ltd.”

By this step, the terminal 12 can automatically detect the model(s) of the image forming apparatus(s) 2 owned by the contract signer 1 and collect data on the model(s) which is the serviced object.

When a performance-improved version of the toner cartridge 60 with a new model number is introduced into the market for use in the image forming apparatus 2, for example, the service provider 10 can provide the latest version of the toner cartridge 60 on the basis of the model data on the image forming apparatus 2. The ID number, which is unique to each piece of the product, is not essential; it is however included here. The ID number is useful for the service provider 10 to appropriately service its products, since the products can be possibly modified over an extended period of time albeit retaining the same old model numbers, and the modification may affect toner cartridges 60 and other products-in-circulation 6 in a way or the other. The ID number is also useful in providing additional services: for example, the service provider can inform the contract signers 1 of newly discovered defects of the image forming apparatus 2 based on the ID number before and after such a modification.

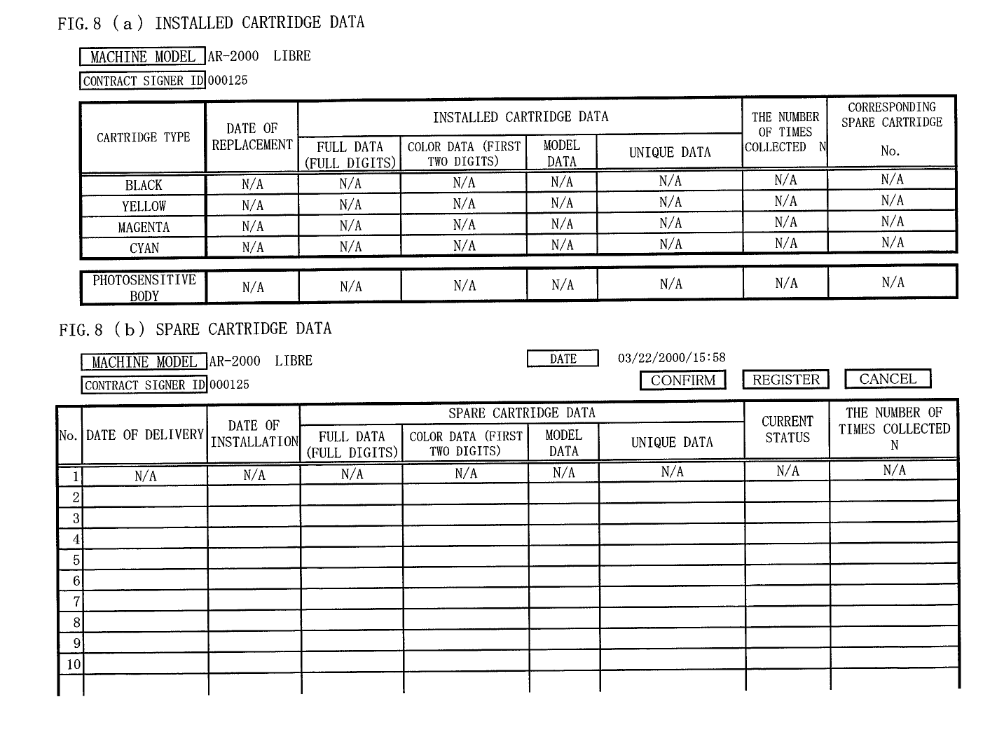

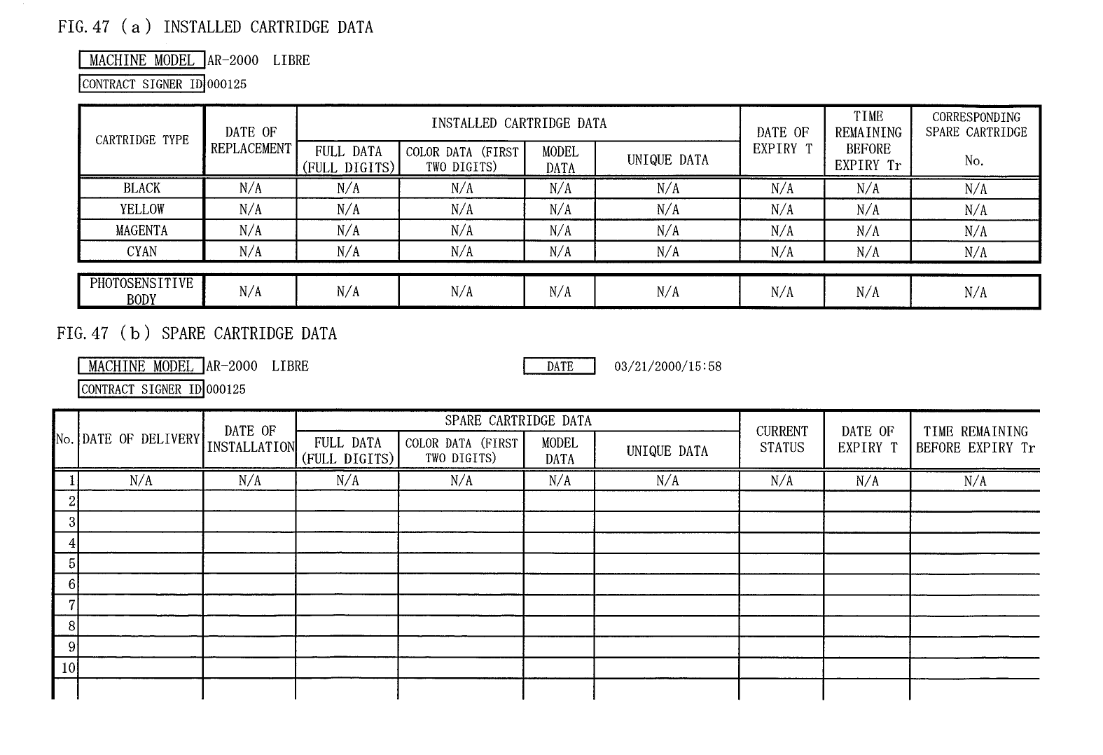

Note that, the terminal 12 of the service provider 10 creates a service management file (the foregoing service management table) for each contract signer 1 and stores them in memory section 124. FIG. 8(a), FIG. 8(b), FIG. 47(a), and FIG. 47(b) show an example of the file displayed on the output section 125 of the terminal 12. In this example, cartridges in use are shown in the table (FIG. 8(a)), and spare cartridges are shown in the table (FIG. 8(b)). Alternatively, the table of cartridges in use can be omitted. As default, as shown in FIG. 8(a), FIG. 8(b), FIG. 47(a), and FIG. 47(b), no data is given on the cartridges currently used in the image forming apparatus 2 of the contract signer 1 or the spare cartridges kept in stock by the contract signer 1.

(Registration Process of a Delivered Product-in-Circulation Data)

The service provider 10 collects data on all the toner cartridges 60 that are to be delivered to the contract signer 1 and stores the data in the terminal 12 of the service provider 10 immediately or later.

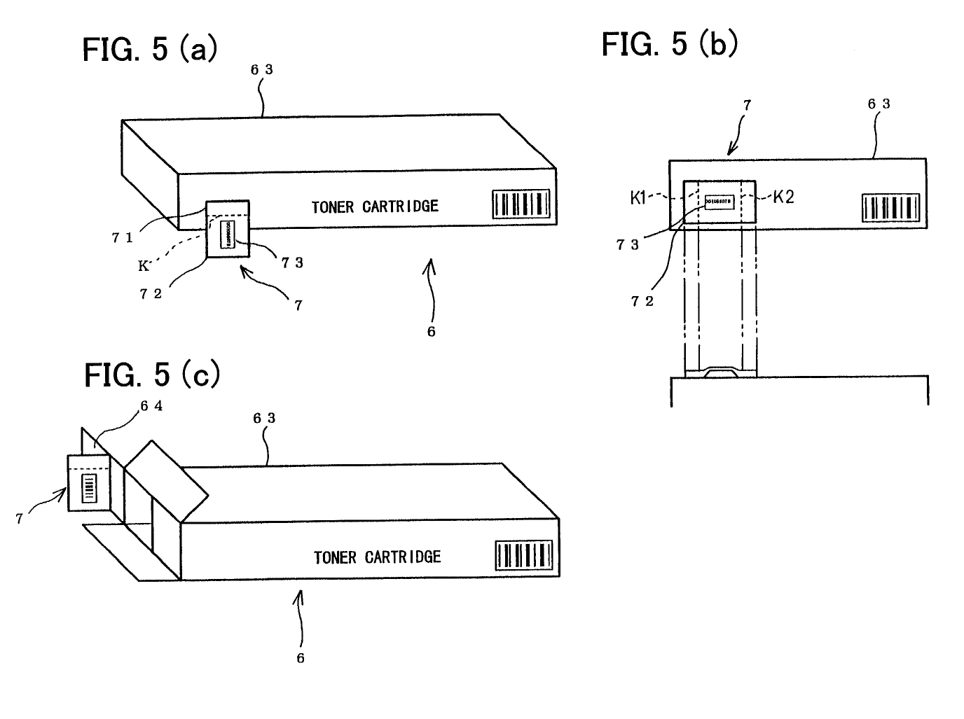

In order to collect the data, a data recording body (second data recording body) 7 which stores data (unique data on the product-in-circulation) is attached to a wrapping material of the product-in-circulation 6 so as to distinguish each toner cartridge 60 from the others as shown in FIG. 5(a) to FIG. 5(c) and the data generated in a data generating section 73 of the data recording body 7 is read out by means of a scanner when the product-in-circulation is delivered to the contract signer 1. The contents of the data recording body 7 are identical to the contents stored in the IC chip 61 in the toner cartridge 60: for example, the ID number given to the toner cartridge 60. However, the data may be stored in different ways: it may stored in the form of a bar code that is readable by a bar code scanner. In the present invention, the ID number stored in the IC chip 61 as unique data on a product-in-circulation is not secret and does not need special protection; the ID number can be created easily without encryption, encoding, or other complex data processing.

By thus separately attaching a data recording body 7 whose contents (i.e., unique data of the product-in-circulation) are identical to those of the IC chip 61 to the packing material 63 of the product-in-circulation 6, the service person can obtain data on the delivered product-in-circulation 6 from the data recording body 7 attached to the packing material 63 or the surface of the product-in-circulation 6, when the product-in-circulation 6 is delivered. The service person does not have to open the packing material 63 etc. to take out the product-in-circulation 6 and obtain the unique data stored on the product-in-circulation 6, and therefore the commodity value of the product is not lost since the packing is not opened.

Having collected the data, the service person pulls off the data recording body 7 to confirm that the data has been read out. By thus forming the data recording body 7 so that it can be detached from the product-in-circulation 6, one can tell based on the presence or absence of the data recording body 7 whether the product has been delivered or not. Since the data recording body 7 can be taken back, even if the scanner is out of order or other inconvenience occurs, it is possible to avoid such situation where the advance registration cannot be performed on the delivery site, so that the servicemen can still take it back to a service station where he/she can feed the data and complete advance registration.

In these cases, the data recording body 7 is attached so that it can be detached without opening the toner cartridge 60: as shown in FIG. 5(a), a part 71 of the data recording body 7 is attached to the external surface of a protection member such as the wrapping material 63 or the packaging material 62, by using adhesive or staplers, so that a part 72 where the data is written can be pulled off the part 71 along a tear-off line K.

The data recording body 7 is made of a film member, such as paper or resin, or a sheet member that is sufficiently thick and does not curl or cause other inconveniences. If the data recording body 7 is made of a hard sheet member, it is cut off along the line K. In view of durability and readability of data, hard resin is preferred.

FIG. 5(b) shows an alternative method to attach the data recording body 7, in which it is attached on its back, where no data is formed, to the packing material 63 of the product-in-circulation 6 by using adhesive or other similar material, and the part 72, in which data 73 is written, is torn off the attached part 71 along the tear-off lines K1 and K2.

A further alternative is shown in FIG. 5(c), in which the data recording body 7 is attached to the interior 64 of the lid of the protection member 63, but is assessable without damaging the product. By so doing, the data recording body 7 is not damaged during circulation and can therefore be made of paper or another fragile material.

In the description above, it was assumed that the product-in-circulation 6 was packed in packing material 63 during circulation; the data recording body 7 was therefore attached to the packing material 63. In practice, the packing material refers to the ultimate exterior of the product-in-circulation 6. However, the data recording body 7 may be inserted into a pocket part of the packing material 63, which is formed in a pocket manner.

As detailed in the foregoing, the IC chip 61 and the data recording body 7 need to store the same data, but not necessarily in the same manner.

The data read out by the scanner is immediately transmitted to the terminal 12 of the service provider 10 by communications means (not shown). Alternatively, the data read out by the scanner is stored on a floppy disk, memory stick, or a similar medium so that the medium can be taken back to the service station for later retrieval and input to the terminal 12 of the service provider 10.

When the data read out by the scanner is transmitted immediately by communications means, the read out data and the contract signer ID number are transmitted in pairs to the terminal 12. By so doing, the terminal 12 can associate the contract signer 1 with the data on the product-in-circulation 6 delivered to the contract signer 1.

Now, operations of the terminal 12 will be described in more detail. The terminal 12 specifies the contract signer 1 based on the incoming data from the communications section 121. This is achieved by the arithmetic processing section 122 specifying the contract signer ID contained in the incoming data. Alternatively, when the unique data and contract signer ID of a product-in-circulation are stored in the memory section 124 so that they are related to each other, the terminal 12 can specify the contract signer 1 based on the incoming unique data from the communications section 121.

Next, the arithmetic processing section 122 recalls the service management tables related to the specified contract signer 1 (FIG. 8(a), FIG. 8(b), FIG. 47(a), and FIG. 47(b)). The management table is made for each contract signer 1, when it becomes clear which models the contract signer 1 wants to be serviced, for example, when a contract is made.

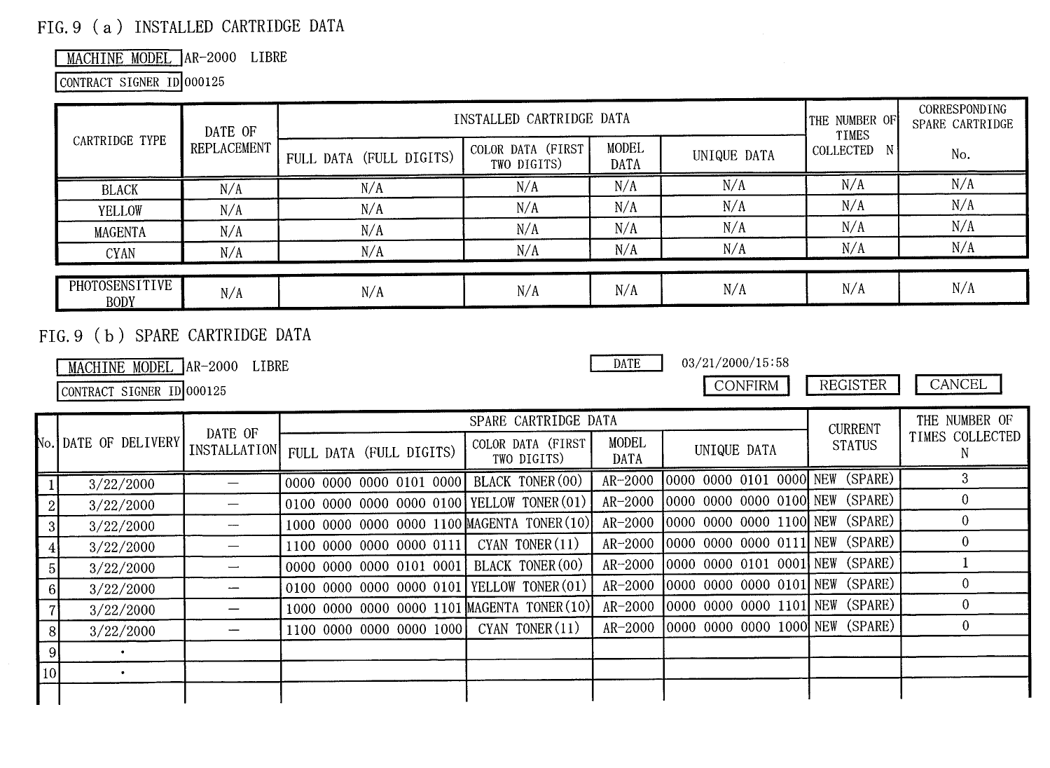

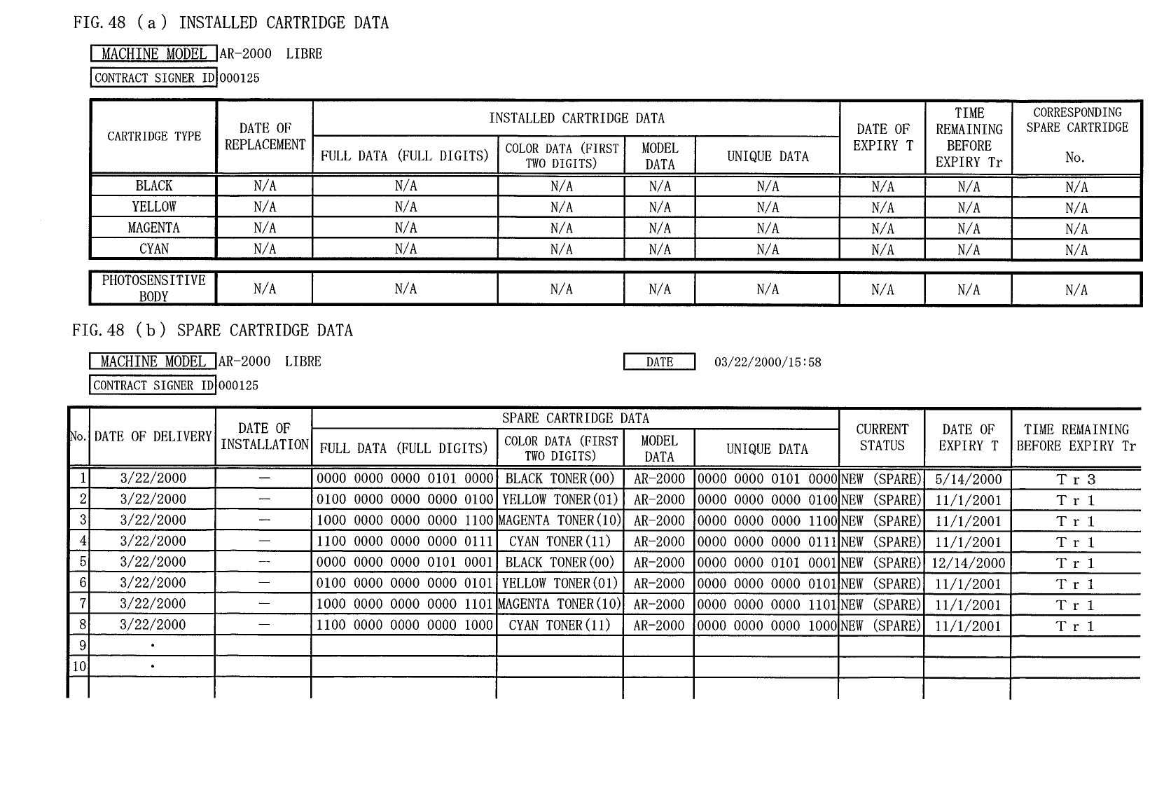

Then, the arithmetic processing section 122 retrieves the ID number of the toner cartridge 60 contained in the incoming data. The ID number goes in the “FULL DATA (FULL DIGITS)” cell in FIG. 8(a), FIG. 8(b), FIG. 47(a), and FIG. 47(b). FIG. 9(b) and FIG. 48(b) show the management table after the full incoming data is entered. Spare cartridges are numbered in the order of the incoming data; alternatively, they may be sorted by color. The full incoming data may be temporarily stored in a virtual memory region (or processing region) of the memory section 124 to sort cartridges by color by identifying the color data (the first two digits of the full data) contained in the full data, and automatically entered to the spare cartridge table as shown in FIG. 9(b) and FIG. 48(b). In such a situation, cartridges of the same color are sorted by the ID numbers, and their data is entered into the table in the ascending order of the ID numbers.

A further alternative is possible, where the data read out by the scanner is stored in combination with a contract signer ID number in a portable data terminal or a similar device at the installation spot and then taken back to a service station of the service provider 10. The service person can transfer the data stored in the portable data terminal to the terminal 12 after establishing a physical line connection or radio communications such as infrared communications between the terminal 12 and the portable data terminal.

A further alternative is possible, where the part 72 of the data recording body 7 is collected and taken back without using a scanner at the installation spot. The data is then input to the terminal 12 by reading out the part 72 using a bar code scanner or another input section 123 connected to the terminal 12 of the service provider 10 or by manual input through a keyboard or a similar input device. In this case, the unique data of the product-in-circulation 6 is again input in combination with the contract signer ID data. The earlier real-time method of electronic on-the-spot readout and transmission of data is more reliable in that it can eliminate a possibility of delivering goods that do not appear on the delivery slip by error, and in view of these advantages, is more preferred.

The unique data of the product-in-circulation 6 may be entered manually through a keyboard or a similar input device at the terminal 12 of the service provider 10 in combination with the contract signer ID data before the product-in-circulation 6 is dispatched from the service provider 10 to the contract signer 1.

Hence, the terminal 12 of the service provider 10 can store the number of the toner cartridges 60 that have been supplied to the specific contract signer 1, but are yet to be used, as well as their model numbers and ID numbers.

In the present embodiment, it is assumed that data is electronically read out and immediately transmitted on the spot.

The terminal 12 of the service provider 10 updates the data based on incoming data. Specifically, FIG. 9(b) and FIG. 48(b) show a case where black, yellow, magenta, and cyan toner cartridges 60 are supplied, two for each color, eight in total, and twenty-digits, unique code data is entered for each cartridge. Note that, in the description of FIG. 9, the display which indicates each type of the toner cartridges 60 etc. includes not only the code data but also actual names such as “black toner” subserviently in the light of the user interface. In the table shown in the figure, the model data of the toner cartridges 60, etc. is not only represented in the form of code, but also accompanied by actual names, like “black toner” as an aid to the user. The arithmetic processing section 122 determines for each toner cartridge 60 whether or not the data on the toner cartridge 60 is entered into the spare cartridge table for the first time so far, and the table automatically shows “NEW (SPARE)” in all the cells under “CURRENT STATUS.”

Date of delivery, expiring date data, and period-before-expiry are additionally entered in FIG. 48(b). Date of delivery and the number of times collected data are additionally entered in FIG. 9(b).

Date when the unique data of the product-in-circulation 6 was entered into the spare cartridge table by the input section 123 or the communications section 121 is automatically entered into a cell which indicates date of delivery. Since a timer section (not shown) is provided in the terminal 12, in a case where the arithmetic processing section 122 detects that the unique data of the product-in-circulation 6 was entered into the spare cartridge table, current time and date data is obtained from the timer section so as to input the obtained time and date data to the “DATE OF DELIVERY” cell. In more detail, when the “FULL DATA (FULL DIGITS)” cell which indicates “SPARE CARTRIDGE DATA” is filled and “REGISTRATION BUTTON” is clicked, the arithmetic processing section 122 confirms whether the “FULL DATA (FULL DIGITS)” cell is filled or not. When the arithmetic processing section 122 confirms that the “FULL DATA (FULL DIGITS)” cell is filled, the “DATE OF DELIVERY” which was obtained by the foregoing step is automatically entered.

Further, the product-in-circulation data tables shown in FIG. 46(a), FIG. 46(b), FIG. 6(a) to FIG. 6(c), or the Tables 1 to 3 are referred to by using the unique data of the product-in-circulation 6 entered into the “FULL DATA (FULL DIGITS)” as a retrieving key, so that the color data (the first two digits) and “MACHINE DATA” are automatically entered.

Alternatively, the service provider 10 may enter the date of delivery by the input section 123. By so, it is possible to input a precise value in a case where the date data of the timer section differs from the actual date.

Next, the way the expiring date data (expiring date T) is obtained is described.

The arithmetic processing section 123 refers the product-in-circulation data table shown in FIG. 46(a) and FIG. 46(b) on the basis of the unique data of the product-in-circulation 6 so as to read a expiring date T from the “EXPIRING DATE DATA” cell.

In more detail, retrieval is performed with respect to “FULL DATA (FULL DIGITS)” of FIG. 47(b) and FIG. 48(b) etc. When the data is entered, the unique data of the product-in-circulation 6 is read out. The read out data is temporarily stored in a RAM of the arithmetic processing section 122. When nothing is entered, the processing is finished.

Next, the arithmetic processing section 123 reads out the product-in-circulation data table [1] shown in FIG. 46 from the memory section 124, and obtains an expiring date T with respect to the product-in-circulation 6 by using the obtained unique data of the product-in-circulation 6 which has been temporarily stored in the RAM as a retrieving key (the data is stored in the RAM temporarily). The arithmetic processing section 123 copies the obtained expiring date T in the “USE-BY DATE T” cell of the spare cartridge data table shown in FIG. 47(b).

As shown in FIG. 48(b), “EXPIRING DATE T” is filled in related to the unique data of the product-in-circulation by the foregoing operation.

The “IN-USE” cartridge table in FIG. 48(a) shows the same contents as that in FIG. 47(a). No data is updated right after delivery, since data is entered to the table when the unique data of the product-in-circulation 6 is obtained via a network or the use of the product-in-circulation 6 is confirmed by another means such as telephone or e-mail.

Next, the way the number of times collected data N is obtained is described.

The arithmetic processing section 122 refers the product-in-circulation data table shown in FIG. 6 on the basis of the unique data of the product-in-circulation 6 so as to read a value of the number of times collected (=N times) from the “NUMBER OF TIMES COLLECTED (=N TIMES)” cell. In more detail, retrieval is performed with respect to “FULL DATA (FULL DIGITS)” of FIG. 8(b) and FIG. 9(b) etc. When the data is entered, the data value (unique data of the product-in-circulation 6) is read out. The read out data is temporarily stored in a RAM of the arithmetic processing section 122. When nothing is entered, the processing is finished.

Next, the arithmetic processing section 122 reads out the product-in-circulation data table [1] shown in FIG. 6(a) to FIG. 6(c) from the memory section 124, and obtains a value of the number of times collected (=N times) with respect to the product-in-circulation 6 by using the obtained unique data of the product-in-circulation 6 which has been temporarily stored in the RAM as a retrieving key, so as to store the data in the RAM temporarily. The arithmetic processing section 122 copies the obtained the number of times collected data N in the “NUMBER OF TIMES COLLECTED (=N TIMES)” cell of the spare cartridge data table shown in FIG. 8(b).

As shown in FIG. 9(b), “NUMBER OF TIMES COLLECTED (=N TIMES)” is automatically filled by the foregoing operation.

Note that, in the spare cartridge data table, there is a case where a line specified by No. # (# is 1, 2, 3 . . . ) is called a record.

When the unique data of the product-in-circulation 6 is obtained via a network, or when use of the product-in-circulation 6 is confirmed by other means such as a telephone call or an electric mail, data is entered into the cartridge data table, shown in FIG. 9(a), which is being used, so that the cartridge data table does not vary at a time of delivery, and its content is the same as that shown in FIG. 8(a).

(Using Confirmation Process of a Delivered Product-in-Circulation)

The service person opens a necessary toner cartridge 60 that enables the image forming apparatus 2 to operate, and installs that toner cartridge 60 in the image forming apparatus 2. Having already been connected and properly set up for external communication, the image forming apparatus 2 transmits the data on the installed toner cartridge 60 to the terminal 12 of the service provider 10. The data is transmitted together with the contract signer ID to enable the terminal 12 to tell from which contract signer 1 the data is coming in.

Automated execution of the foregoing operations is now described. The image forming apparatus 2 is typically equipped with various sensors to detect opening of doors and installation of the toner cartridge 60, and the controller section 3 monitors these sensors. As installation of toner cartridge 60 is detected on the basis of signals from a toner cartridge sensor, the controller section 3 gives a command, causing the read-out section 4 to read out the data stored in the IC chip 61 of the toner cartridge 60. The controller section 3 then gives another command to the transmitter/receiver section 5, causing the transmitter/receiver section 5 to the transmit data. This operation will be described in detail later.

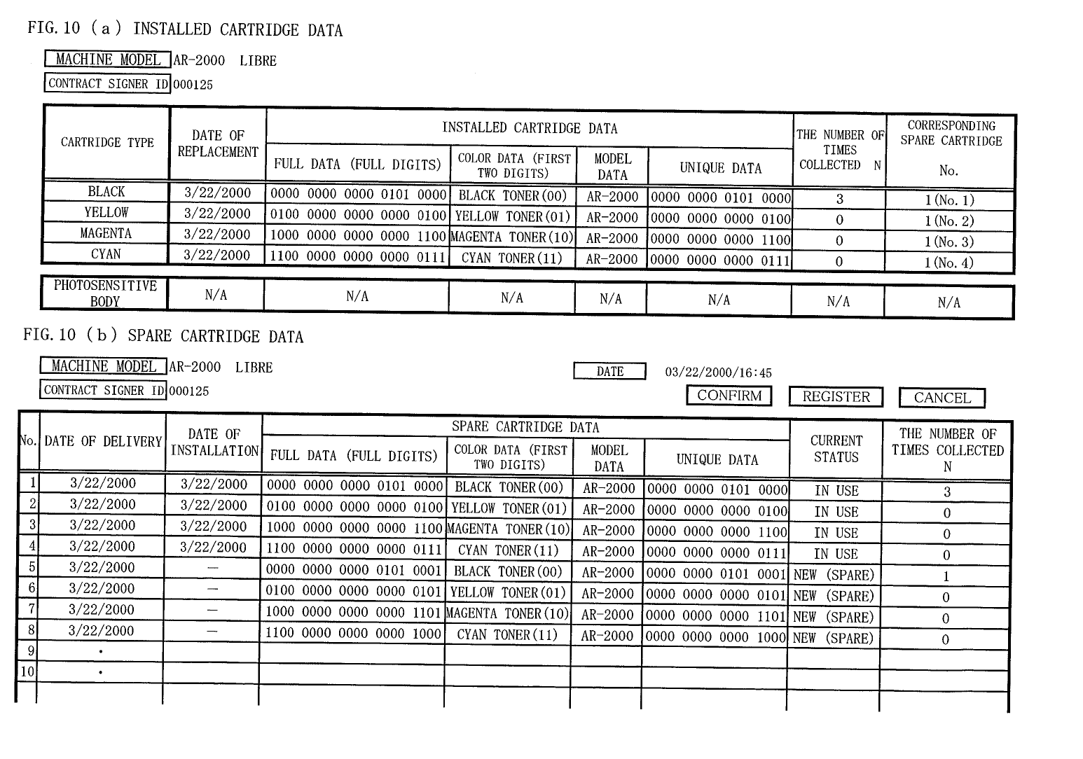

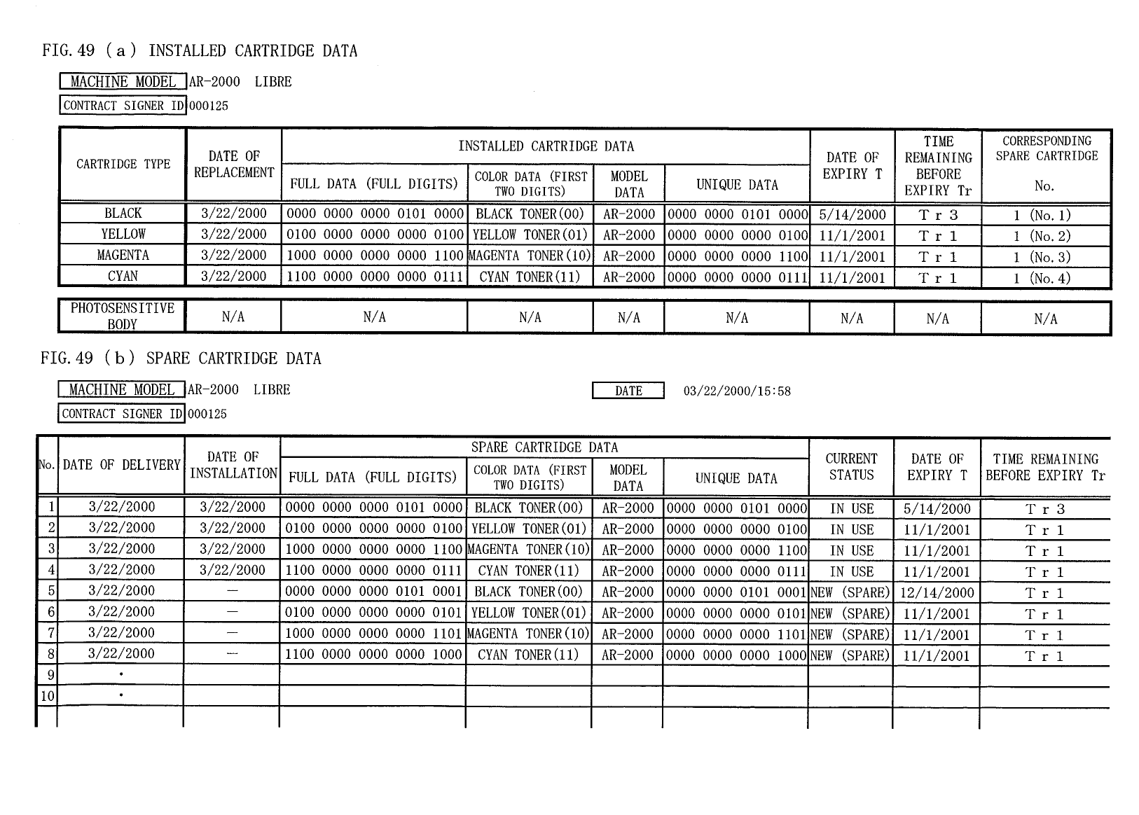

FIG. 10(a) and FIG. 49(a) show results of the arithmetic processing section 122 of the terminal 12 of the service provider 10 having updated the data on cartridges currently used in the image forming apparatus 2 of the contract signer 1 on the basis of the incoming data from the communications section 121. FIG. 10(b) shows results of the arithmetic processing section 122 having updated data on some of the toner cartridges 60: they first appeared as spare cartridges in the column under “CURRENT STATUS,” but the display is now updated from “NEW (SPARE)” to “IN USE” as a result of the foregoing operation.

The arithmetic processing section 122 checks the table of cartridges in use for the same unique data as that of the toner cartridge 60 contained in the data received by the communications section 121, to determine whether or not the toner cartridge 60 has been newly installed. Alternatively, the arithmetic processing section 122 checks the table of spare cartridges for the same unique data as that of the toner cartridge 60 contained in the data received by the communications section 121, to determine whether or not the toner cartridge 60 has been newly installed: if the same unique data is sorted in the table as “NEW (SPARE)” in the column under “CURRENT STATUS” and is also received by the communications section 121, the unique data is that of a newly installed toner cartridge 60.

This completes initial set-up and registration.

In the foregoing description, it was assumed that the model number, the unique ID number, and other data of the image forming apparatus 2 were automatically transmitted to the terminal 12 of the service provider 10. An alternative configuration is possible where the service provider 10 executes registration through the input section 123 of the terminal 12.

(Replacement Process of the Product-in-Circulation)

Now, the operations of the arithmetic processing section 122 when a toner cartridge 60 is replaced will be described.

A machine manager or user of the contract signer 1 who has a contract with the service provider 10 replaces an old toner cartridge 60 with a new one in spare stock based on a “Replace Toner Cartridge” message given by the image forming apparatus 2. The present embodiment will focus on a case where only black toner has run out.

The old toner cartridge 60 (spare cartridge No. 1) shown in FIG. 10(b) and FIG. 49(b) is removed from the image forming apparatus 2, and a new toner cartridge 60 (spare cartridge No. 5) is installed replacing the old one.

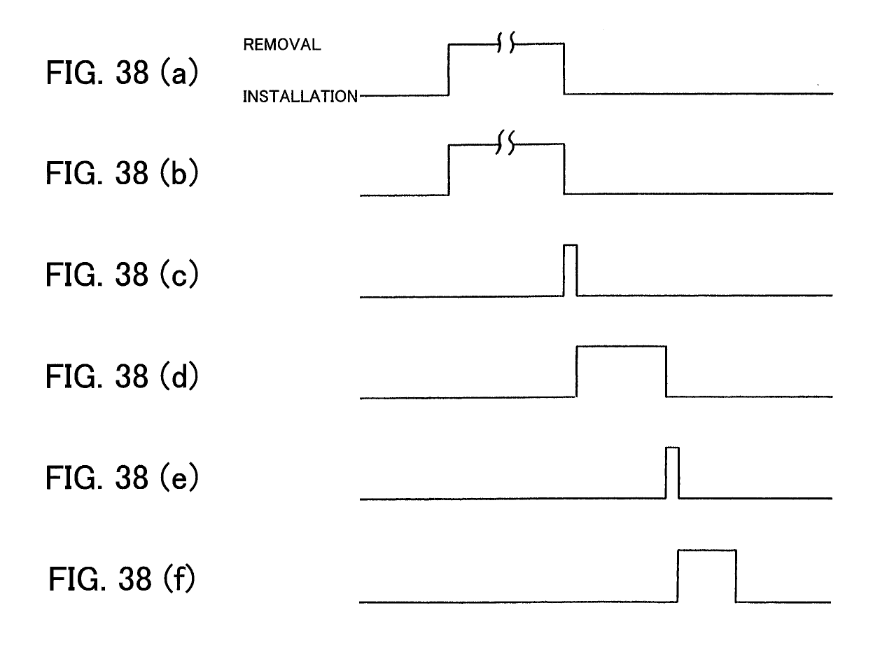

Referring to FIG. 38, the following will describe internal operations of the image forming apparatus 2.

The image forming apparatus 2 is typically equipped with a sensor to detect a toner cartridge 60 being installed. The arithmetic processing section 122 detects installation and removal of a toner cartridge 60 on the basis of sensor reactions.

FIG. 38(a) and FIG. 38(b) show, as an example, the installation/removal operation of a toner cartridge 60 and associated sensor outputs. When there is a toner cartridge 60 installed, the sensor output signal is low; when there is no toner cartridge 60 installed, the sensor output signal is high.

The sensor circuit 9 produces a trigger pulse shown in FIG. 38(c) based on the sensor output signal. Specifically, a pulse signal is produced with a fixed width when the sensor output signal falls. This is achieved by a circuit including a mono multivibrator: the circuit feeds the sensor output signal to the mono multivibrator and produces a pulse that rises at a fall of the sensor output signal. The sensor output signal may be fed to a Shmit trigger circuit, filter circuit, etc., before supplied to the mono multivibrator to prevent noise and chattering in the sensor output signal from causing malfunction of the mono multivibrator.

The installation timing of the toner cartridge 60 is thus detected, and the read-out section 4 is triggered at this timing.

As the trigger is produced, the read-out section 4 accesses the IC chip 61 on the toner cartridge 60. FIG. 10(d) shows the duration of the access to the IC chip 61 by the read-out section 4. Specifically, the signal is a strobe signal, and address specification and data reading are done in the duration. The read out data is stored in RAM or other volatile memory.

At the fall of the strobe signal, the pulse signal of FIG. 10(e) is produced with a fixed width.

The trigger pulse is used as a timing signal for the transmitter/receiver section 5 to transmit the data read out by the read-out section 4. The transmitter/receiver section 5, for example, processes data appropriately to communications system based on the trigger pulse, before transmitting it as shown in FIG. 10(f).

With these operations, the image forming apparatus 2 transmits data on the unused toner cartridge 60 to the terminal 12 of the service provider 10.

In the description so far, it was assumed that a sensor was disposed to detect a toner cartridge 60 installed in the image forming apparatus 2. If there is no such sensors, a door sensor may be used. The door is provided to allow internal access when the toner cartridge 60 needs to be replaced or jammed paper needs to be removed. As a safety precaution, the door is usually equipped with a sensor to detect the opening/closure of the door. To replace the toner cartridge 60, the door must be opened and then shut. Therefore, an access timing to the toner cartridge 60 may be produced based on signals from the door sensor, hence, the opening/closure of the door.

Alternatively, for a machine with no sensors at all, the controller section 3 may be programmed to cause a reading at a regular interval.

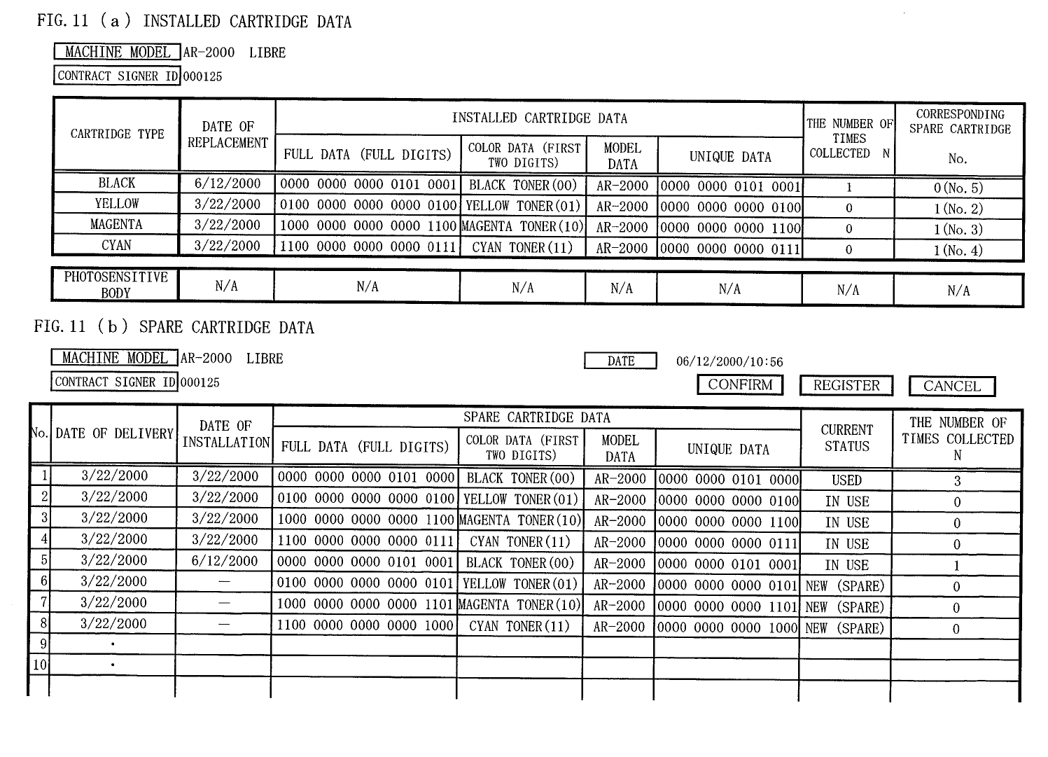

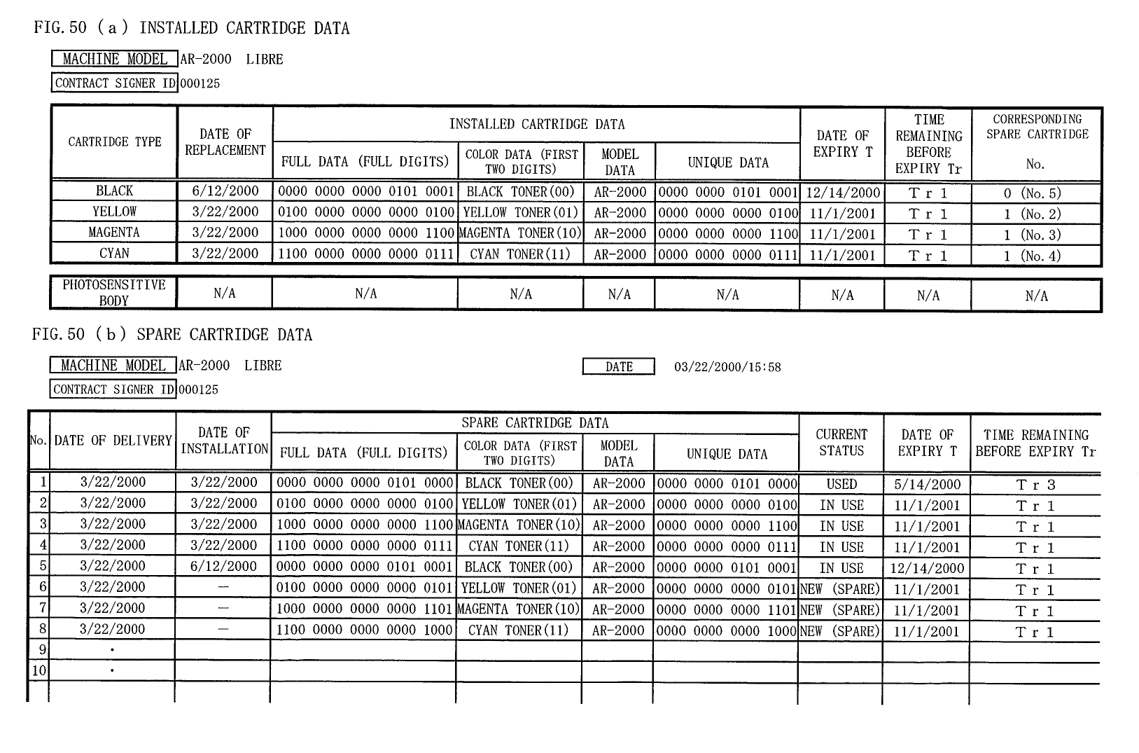

At the terminal 12 of the service provider 10, the current status for the spare cartridges No. 1 and No. 5 is updated to “USED” and “IN USE” respectively as shown in FIG. 11(b) and FIG. 50(b). In the in-use cartridge table, the data (date of replacement, full data, unique data, expiring date, period-before-expiry, number of times collected data, spare cartridge) is updated only on the black toner cartridge as shown in FIG. 11(a) and FIG. 50(a).

That is, the arithmetic processing section 122 compares the unique data of the toner cartridge 60 whose status is represented as “NEW (SPARE)” in the “CURRENT STATUS” column of the spare cartridge table with the unique data contained in the data received by the communications section 121; if the unique data of the toner cartridge 60 (spare cartridge No. 5) is detected, the arithmetic processing section 122 recognizes that the spare cartridge No. 1 of the same color is replaced with a spare cartridge No. 5. In other words, the arithmetic processing section 122 detects changes in the unique data of the product-in-circulation 6 received via the communications section 121, so that it serve as a replacement recognition section for recognizing replacement, i.e., purchase, of the product-in-circulation 6 by the contract signer 1.

Based on the recognition, the arithmetic processing section 122 updates the current status of the spare cartridge No. 5 to “IN USE.” Concurrently, the arithmetic processing section 122 detects that the new toner cartridge 60 (spare cartridge No. 5) is for black toner and recognizes that the toner cartridge 60 (spare cartridge No. 1) also for black toner is used up and updates the current status of the spare cartridge No. 1 to “USED.” The arithmetic processing section 122 updates the spare cartridge table through these recognition operations.

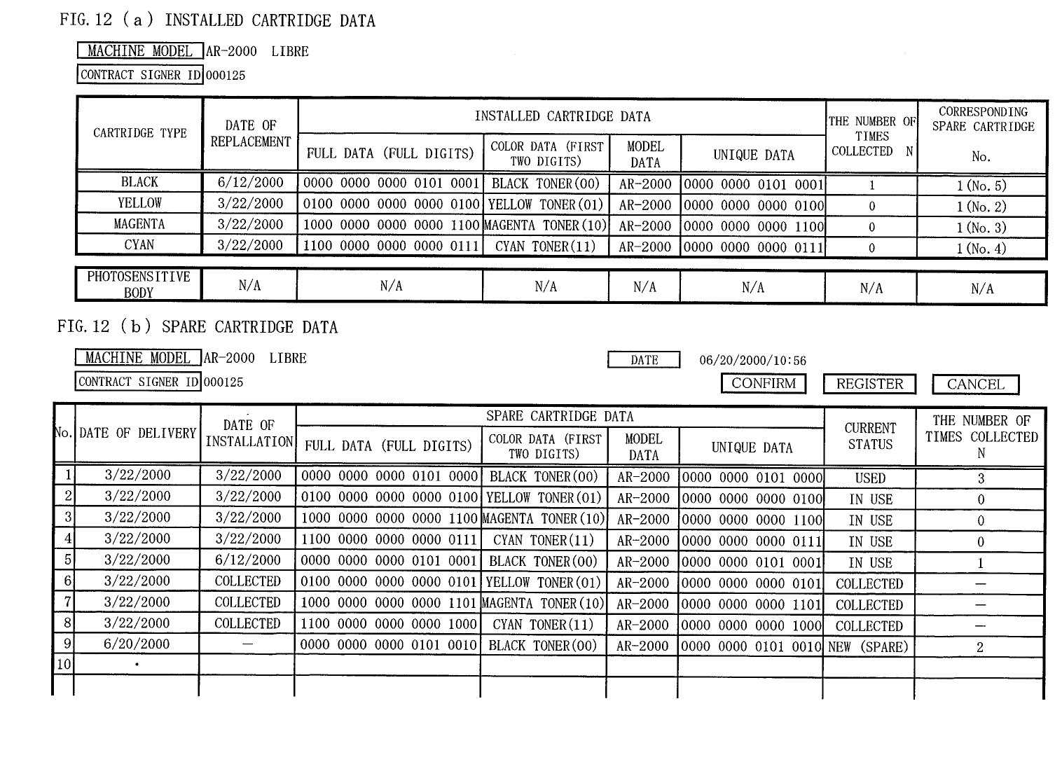

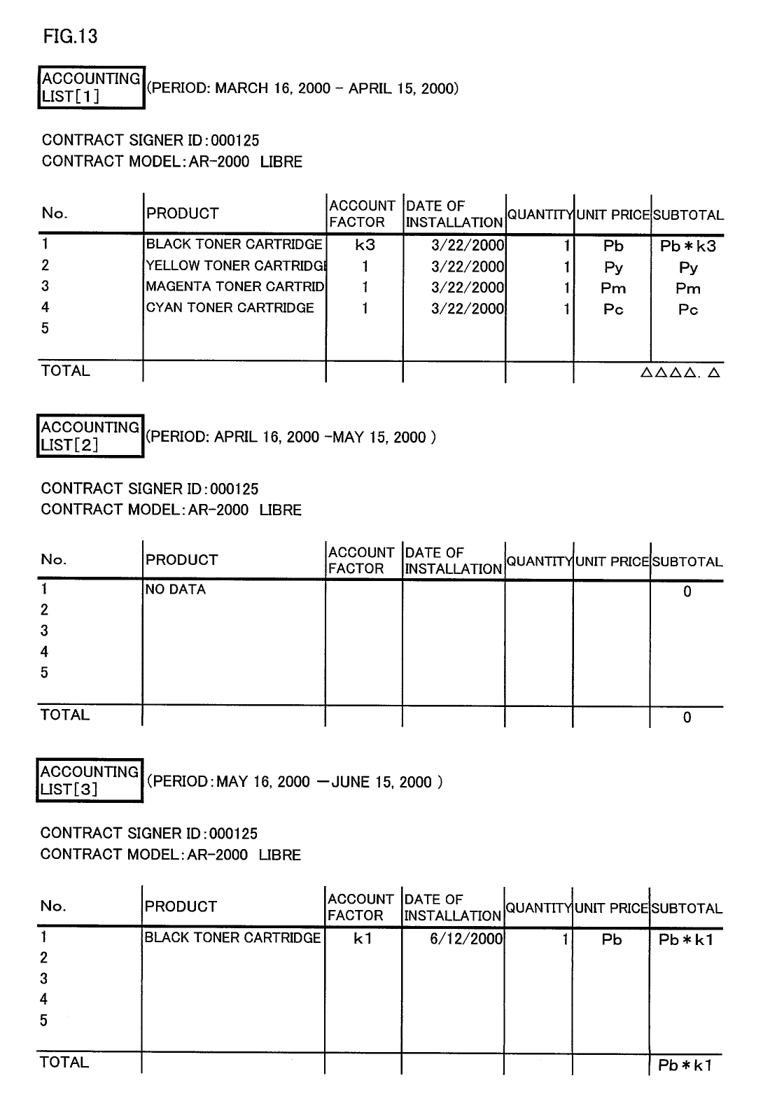

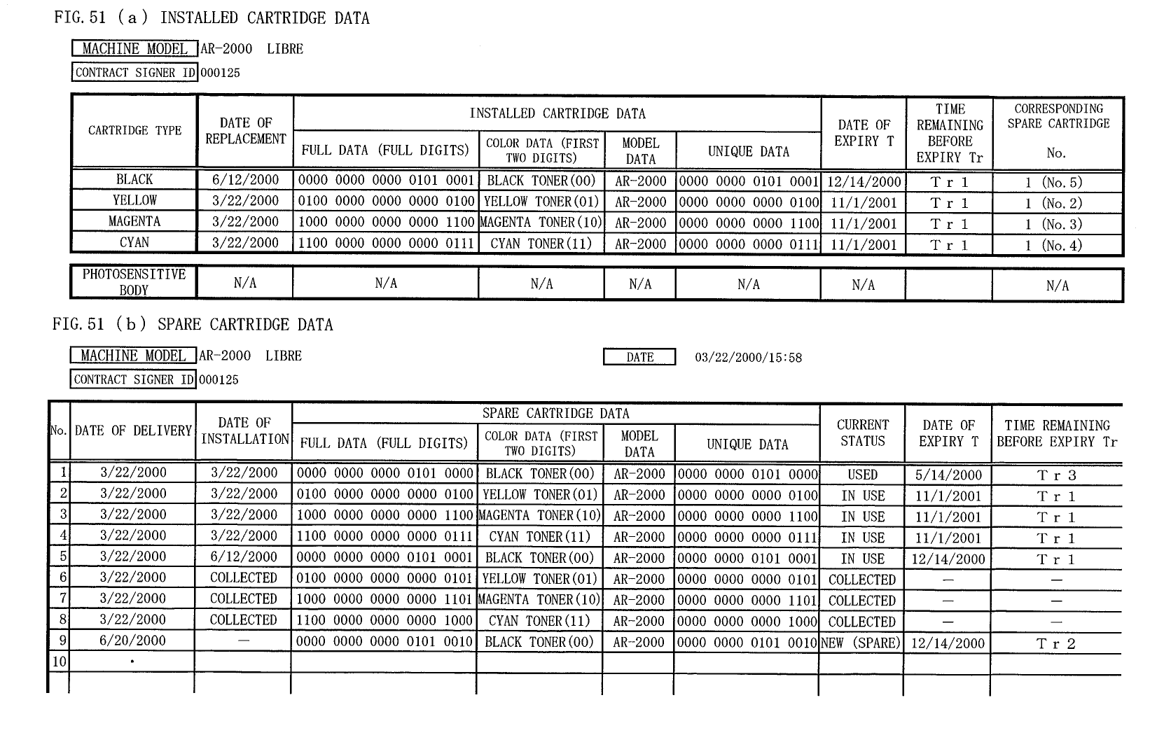

Now, there is no more spare black toner cartridge left, and the service provider 10 dispatches at least a black toner cartridge to the contract signer 1. FIG. 12(a), FIG. 12(b), FIG. 51(a), and FIG. 51(b) show such a situation. New spare cartridge data is added for No. 9 by a process similar to the foregoing initial setup and registration.

Thus, the service provider 10 always monitors the spare toner cartridge data and prevents the contract signer 1 from running out of the consumable product by dispatching a new spare toner cartridge 60 to the contract signer 1 when or before the contract signer 1 runs out of spare toner cartridges 60.

To cause the terminal 12 to electronically execute the foregoing operations, the arithmetic processing section 122 subtracts Nu from Nf where Nf is the number of toner cartridges delivered, and Nu is the number of toner cartridges used; if Nf-Nu equals 0, the arithmetic processing section 122 executes steps to instruct a dispatch. Nf is stored in the memory section 124 for individual contract signers 1. Nf is retrieved from the memory section 124 before executing the foregoing process and updated when a new cartridge is delivered. Nf may be set equal to the largest of the numbers successively assigned to the cartridges (the numbers appear in FIG. 11(b) in the column under “NO.”).

Nu is calculated as follows.

The memory section 124 have in records the accumulative number of cartridges used up and in used to the previous update. As latest data is entered to the terminal 12, the number of cartridges newly put in use this time is added to the accumulative number to keep Nu updated. Specifically, this is achieved, for example, in FIG. 11(b), by adding up the number of cartridges sorted as “USED” or “IN USE” under “CURRENT STATUS.” The accumulative number of cartridges used and in use, which is stored in the memory section 124, is update also in this case.

The instruction for a delivery may be a message popping up on the output section 125 of the terminal 12. Alternatively, the instruction may be sent via the communications section 121 and then over the local network 22 to the delivery department of the service provider 10 in the form of, for example, electronic mail. Further, a notice of delivery may be sent in advance via the communications section 121 and then over the network 20 (telephone lines 20A) to the contract signer 1.

Spare toner cartridges 60 may be dispatched to the contract signer 1 when N′ grows smaller than N, where N is a predetermined reference value larger than 0, and N′ is the number of spare cartridges kept in stock at the contract signer 1. When this is the case, the contract signer 1 has a smaller risk of running out of the product than when setting N=0; however, cartridges are dispatched more frequently. This is a trade-off situation between low risk and high frequency; experience will tell a suitable value for N. (Account Calculation Process) Next, an account calculation process will be explained. FIG. 13 shows a list of consumable products which are to be charged (account lists [1] to [3]). For example, one month is one charging period. The consumable product list, for example, is generated by extracting, from a spare cartridge table shown in FIG. 10(b), FIG. 11(b), FIG. 49(b), and FIG. 50(b), data of used cartridges accumulated for a month: from a closing date (in the present embodiment, 15 in every month) to a previous month. This is achieved by extracting cartridges which has been used or is being used during the period from the closing date to the previous month.

Thus, a product-in-circulation 6 which is to be charged is specified.

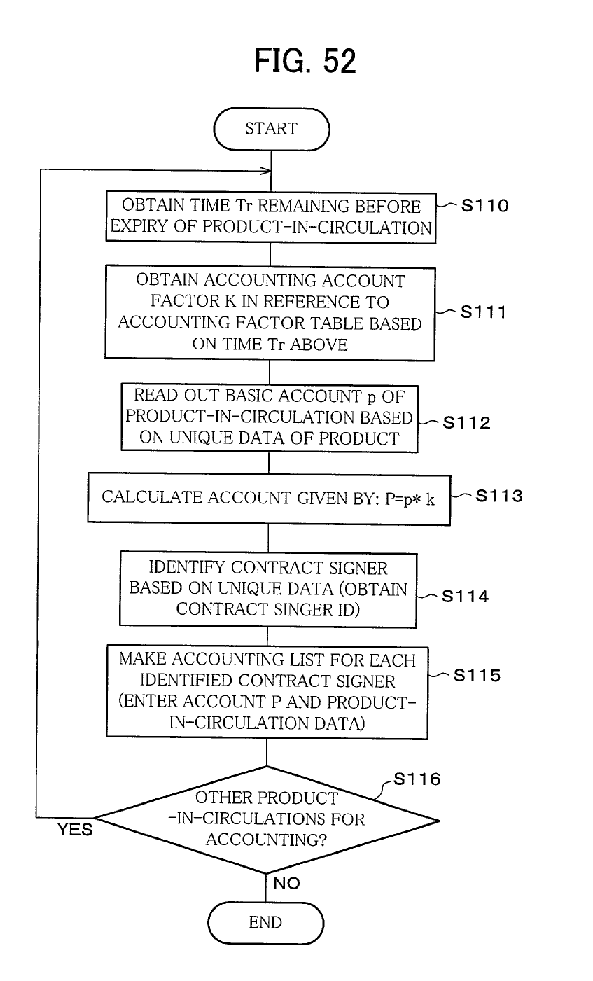

Now, referring to FIG. 52, the following will describe a first example of an accounting process, which is a feature of the present invention.

Step 110 [S110]

First, a period-before-expiring Tr is obtained as expiring date data of the product-in-circulation 6.

Specifically, in reference to the spare cartridge table in FIG. 48(b), etc., a corresponding period-before-expiring Tr is read out based on the unique data of the product-in-circulation 6.

Step 111 [S111]

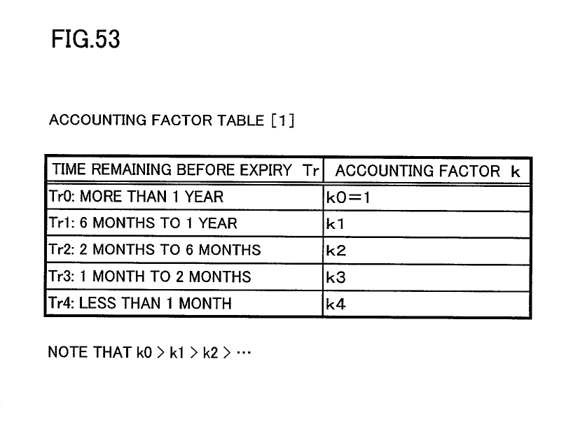

The accounting factor table shown in FIG. 53 is read out from the memory section 124 based on the period-before-expiring Tr to obtain an accounting factor k corresponding to the obtained period-before-expiring Tr. The accounting factor k is temporarily stored in the RAM in the arithmetic processing section 122.

Step 112 [S112]

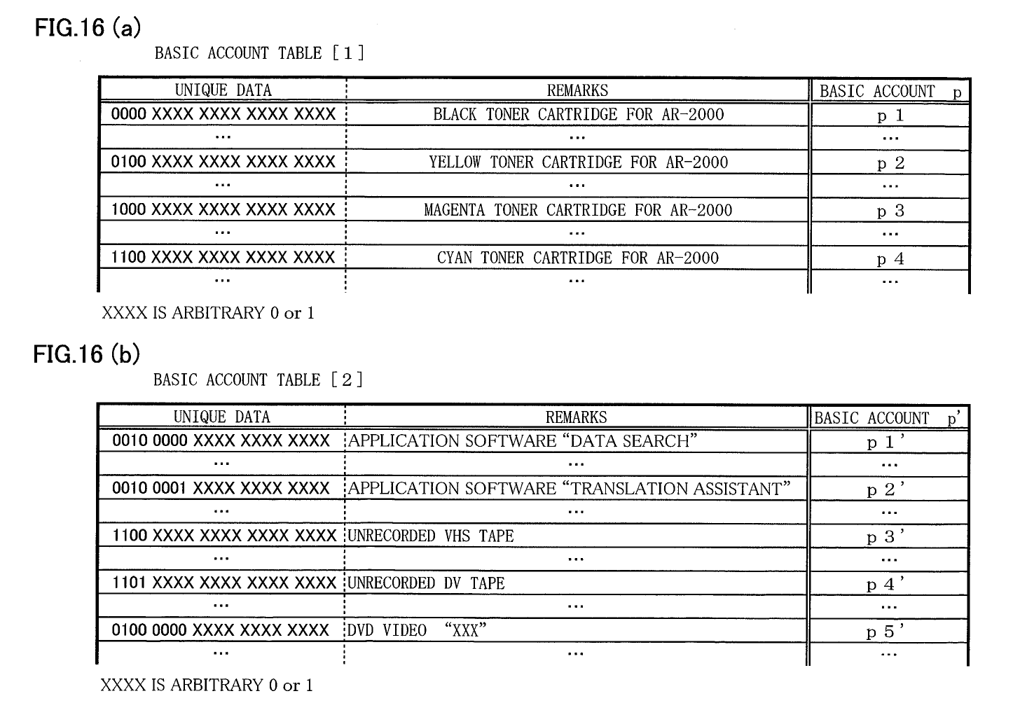

Next, the basic account table [1] shown in FIG. 16(a) is read out from the memory section 124 based on the unique data of the product-in-circulation 6 to obtain a basic account p. The basic account p is temporarily stored in the RAM in the arithmetic processing section 122.

Step 113 [S113]

The accounting factor k is multiplied with the basic account p, both temporarily stored in the RAM, to calculate an account P in consideration of the period-before-expiring Tr.

Step 114 [S114]

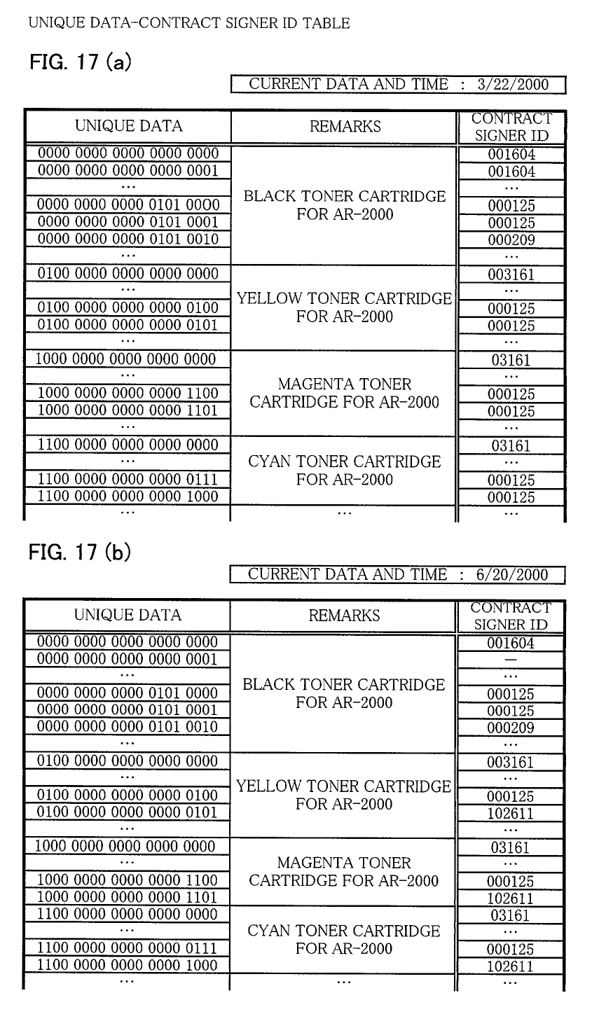

Referring to the unique data/contract signer table in FIG. 17(a), the contract signer 1 is identified by obtaining his/her contract signer ID based on the unique data of the product-in-circulation 6.

Step 115 [S115]

The account list shown in FIG. 13 is created for each contract signer 1 based on the results from the steps so far.

Step 116 [S116]

It is determined whether there are any additional products-in-circulation 6 subject to the accounting; if there are none, the process terminates here, and if there are some, the process returns to Step 110 to repeat the same steps for those products-in-circulation 6.

Note that Step 114 may be skipped if the process is continued to execute Step 110 and its succeeding steps repeatedly for the same contract signer 1.

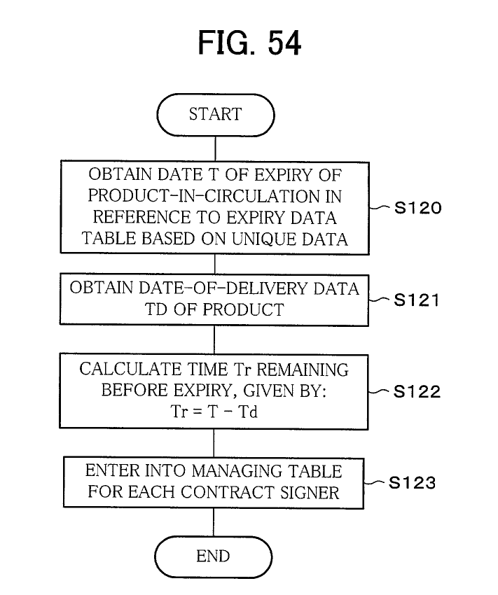

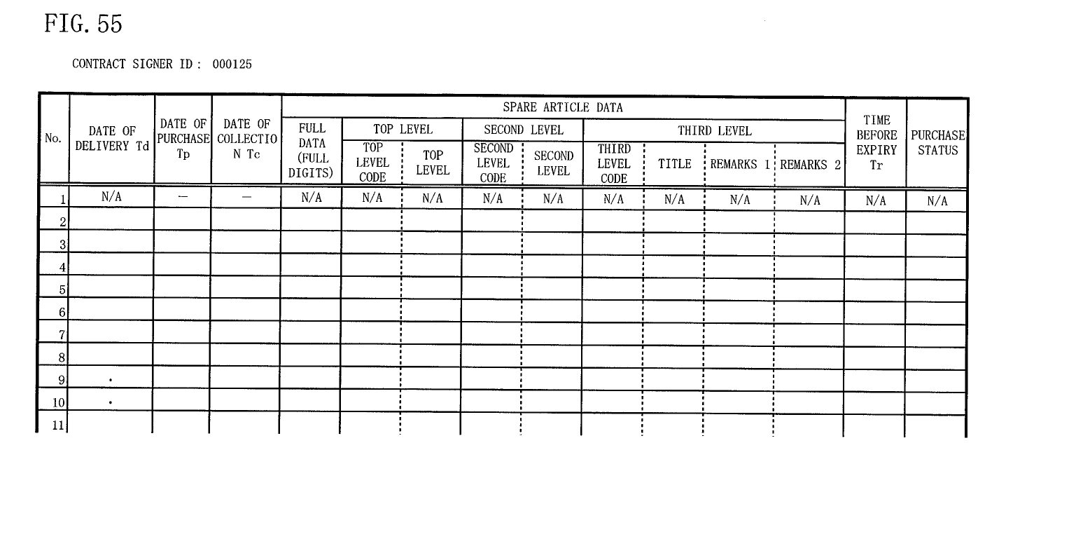

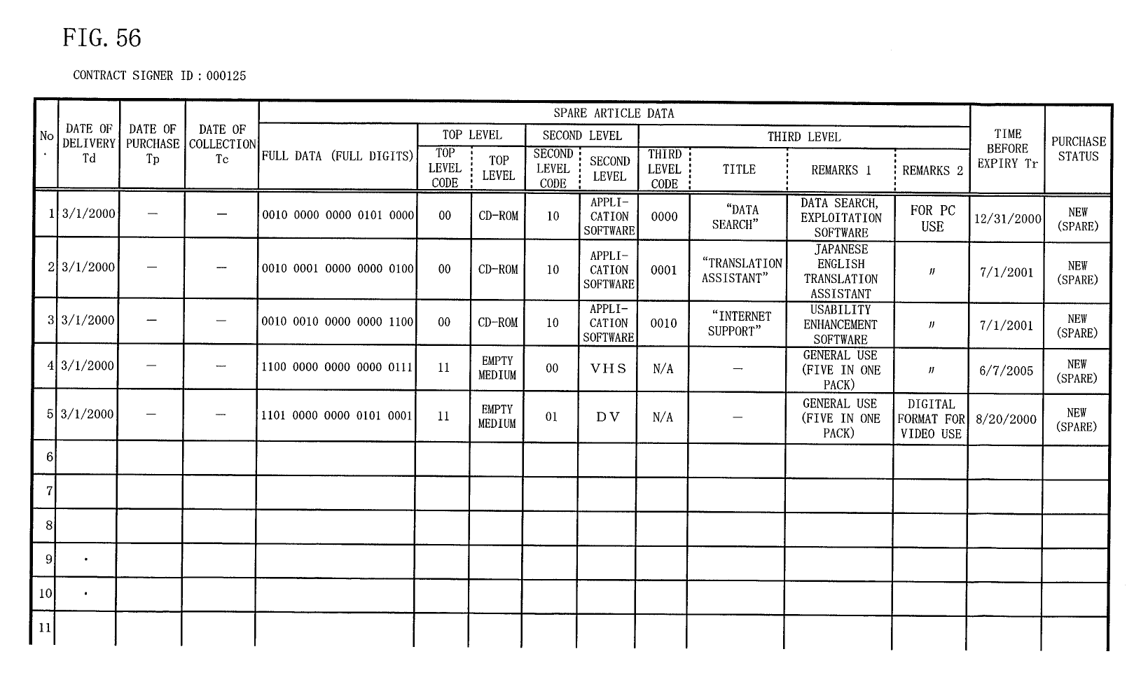

Referring to FIG. 54, the following will describe how to calculate the period-before-expiring Tr which was used to calculate the account.

Step 120 [S120]

First, referring to the product-in-circulation data table [1] shown in FIG. 46(a), an expiring date T is obtained based on the unique data of the product-in-circulation 6.

Step 121 [S121]

Next, referring to the spare cartridge table (FIG. 48(b), etc.) for each contract signer 1, a delivery date (or installation date) Td is obtained of the product-in-circulation 6.

Step 122 [S122]

Now, the period-before-expiring Tr is calculated from T and Tp above as:

Tr=T−Td

Incidentally, the period-before-expiring Tr is obtainable based on either the delivery date or the installation date. This is optional and determined by the service provider 10 at their disposal. In the latter case, the service provider 10 can offer services which better reflect the actual use by the contract signer 1 and efficiently solve the problem of low sales of products-in-circulation 6 with a short expiring period.

Step 123 [S123]

Finally, the calculated result is entered in the “Period-before-expiring Tr” data cell in the spare cartridge table of the contract signer 1. In FIG. 48(b), etc. the data is entered by means of symbols which are managed according to the table shown in Table 4.

TABLE 4

| Representation | Period-Before-Expiring |
|---|---|
| Tr0 | More than 1 Year |
| Tr1 | 6 Months to 1 Year |
| Tr2 | 2 Months to 6 Months |
| Tr3 | 1 Month to 2 Months |
| Tr4 | Less than 1 Month |

In the foregoing, the delivery date when the product-in-circulation 6 was delivered to the contract signer 1 or the installation date was used as date and time data to calculate the period-before-expiring Tr. Alternatives include the date of a delivery instruction for the product-in-circulation 6 or the actual delivery date.

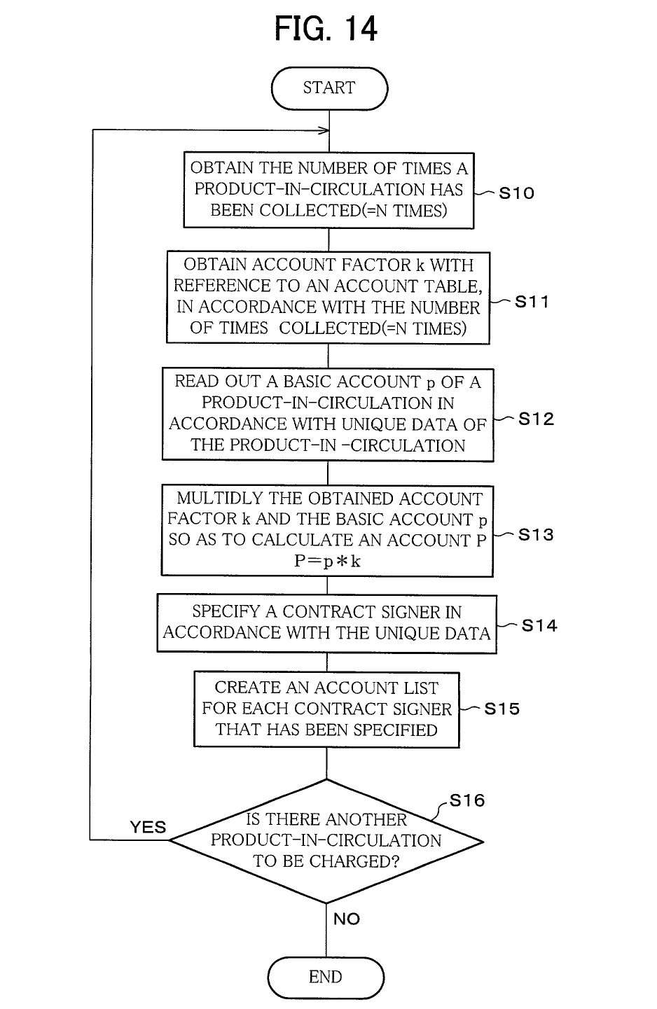

Referring to FIG. 14, a second processing flow of the account calculation will be described.

Step [10] (S10)

The number of times collected (=N times) of the product-in-circulation 6 is obtained.

In more detail, a product-in-circulation data table [1] shown in FIG. 6(a) to FIG. 6(c) is read out from the memory section 124 so as to obtain the number of times collected (=N times) of the product-in-circulation 6 in accordance with the unique data of the product-in-circulation.

Step [11] (S11)

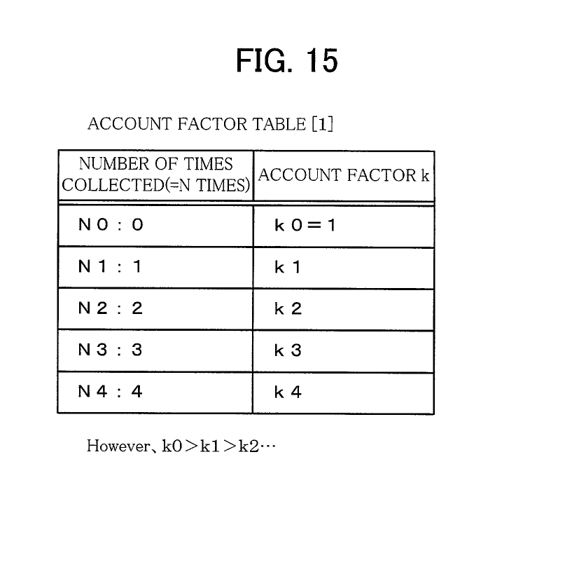

An account factor table [1] shown in FIG. 15 is read out from the memory section 124 in accordance with the number of times collected (=N times) so as to obtain an account factor k. The account factor k is stored temporarily on the RAM of the arithmetic processing section 122.

Step [12] (S12)

A basic account table [1] shown in FIG. 16 is read out from the memory section 124 in accordance with the unique data of the product-in-circulation 6 so as to obtain a basic account p. The basic account p is stored temporarily on the RAM of the arithmetic processing section 122.

Step [13] (S13)

The account factor k and the basic account p, both of which are stored temporarily on the RAM, are multiplied so as to calculate an account p considering the number of times collected (=N times).

Step [14] (S14)

Referring to a unique data/contract signer table shown in FIG. 17, a contract signer 1 is specified by obtaining a contract signer ID in accordance with the unique data of the product-in-circulation 6.

Step [15] (S15)

In accordance with a result obtained by the foregoing processes, an account list shown in FIG. 13 is made for each contract signer 1.

Step [16] (S16)

Whether or not there is another product-in-circulation 6 which is to be charged is confirmed, and if there is not another product-in-circulation 6, the process is finished, and if any, the process goes back to step 10 so as to perform the same process with respect to the product-in-circulation 6.

Note that, in a case where a process performed after step 10 is repeated with respect to the same contract signer 1 successively, the step 14 may be omitted.

FIG. 13 shows a list of past three months.

The account list [1] shows that an account factor k for a black toner cartridge is k3 (<1), and the account factor k for Y, M and C toner cartridges is k0=1. This clarifies that these factors are adjusted according to the number of times collected (=N times) or the period-before-expiry Tr.

As described above, in the present invention, only the toner cartridge 60 which is actually used by the contract signer 1 is charged, and an unused toner cartridge 60 is not charged. This forms the basis on which the account is calculated, which is further changed in accordance with the expiry date of the product-in-circulation 6. Thus, the contract signer 1 can use the image forming apparatus 2 without stocking unnecessary toner cartridges 60, running out of consumable products, and performing complicated management. Also, by setting the account to be a reasonable price with respect to a product-in-circulation 6 whose expiry date is coming soon, etc., the contract signer can use the product-in-circulation 6 with a sense of safety and is encouraged to make the purchase.

Further, it is possible to set the account to be a reasonable price with respect to a product-in-circulation 6 whose number of times collected (=N times) is large, so that it is possible to remove uneasiness that the contract signer 1 feels with respect to use of the product-in-circulation 6, and to make such situation where the product-in-circulation 6 can be purchased easily. The service provider 10 can reduce an amount of the stock by promoting sales of the product-in-circulation 6 whose number of times collected (=N times).

Installation of a new toner cartridge 60 is detected, so that the number of spare cartridges is confirmed. Thus, it is possible to realize conventional management of the image forming apparatus 2 itself and management of the stock of the spare toner cartridges 60 at once.

(Collection Process)

In a typical form in which the image forming apparatus 2 is used for the extended period of time, a new product-in-circulation 6 is supplemented to the contract signer 1. However, there occurs a case where the product-in-circulation 6, which has been delivered to and kept in the installation spot, is required to be returned, due to cancellation of the contract or similar case. FIG. 12(b) and FIG. 51(b) show an example thereof, and is a management table in a case where Y, M, and C toner cartridges shown in No. 6 to No. 8 are returned.

Data “COLLECTION” is entered into a “USE DATE” cell and a “CURRENT STATUS” cell. The “COLLECTION” data is entered via the input section 123 on the terminal 12. However, in a case where the system causes a product to be returned after a prescribed duration has passed since date of delivery, the “COLLECTION” data may be entered automatically at a time when the scheduled date of collection. However, in this case, this is nothing but a scheduled, and whether a collection operation has been actually performed or not is not confirmed. Thus, it is necessary to give an instruction for collection additionally. Furthermore, data such as “SCHEDULED TO COLLECT”, “INSTRUCTION FOR COLLECTION”, and “SCHEDULED DATE OF COLLECTION (month, date, year)” etc. are displayed until whether the collection operation has been actually performed or not is confirmed. After the collection is confirmed, “COLLECTION” or “COLLECTION IS CONFIRMED” may be displayed. By so doing, it is possible to confirm the current status of the collection without fail.

The foregoing situation occurs, for example, in a case where the service contract with respect to toner cartridges of only Y, M, and C colors is cancelled since an image forming apparatus 2 which can perform color printing is used to perform only the monochro printing, or in a case where it is found that the toner cartridges of Y, M, and C colors are consumed much more slowly than a black cartridge is and it is more advantageous to both the service provider 10 and the contract signer 1 that the toner cartridges of Y, M, and C colors which has been delivered are returned.

In a case where the collection operation is performed, the product-in-circulation data table is updated as shown in FIG. 6(b). That is, in the spare toner cartridge table of FIG. 12(b), a value of the number of times collected data of the product-in-circulation 6 shown in No. 6 to No. 8 is updated, and “1” is entered with increment of +1 with respect to the previous value “0”.

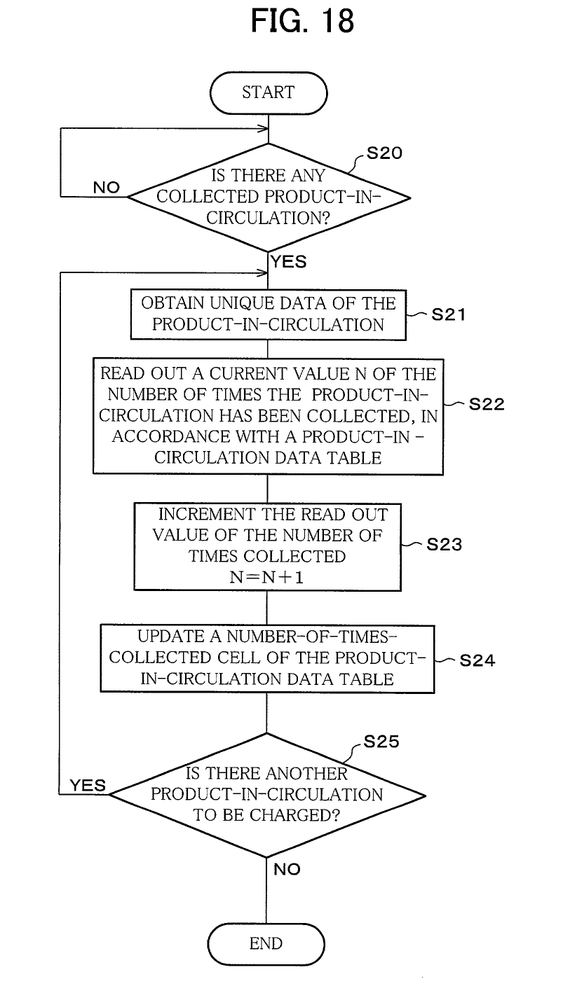

Referring to FIG. 18, a processing flow, in which the number of times collected is updated, is described as follows.

Step [20] (S20)

First, whether any product-in-circulation has been collected or not is judged. The judgement is achieved, for example, by retrieving a product-in-circulation 6 indicative of the “COLLECTION” data entered in the “USE DATE” cell of the spare cartridge table. Alternatively, this is achieved by confirming whether or not there is a product-in-circulation 6 judged to have been collected referring to a collection table (not shown). The collection table is a file for managing unique data of a product-in-circulation 6 and whether or not there is the product-in-circulation 6 having the unique data. If it is made electronic, it is possible to perform a retrieving process by computer processing easily. Note that, in a case where it is certain that the collection has been performed, the foregoing judgement may be performed without waiting for the confirmation on whether the product has been collected or not, when the instruction for collection is given.

Step [21] (S21)

The unique data of the product-in-circulation is obtained. In the foregoing example, this is achieved by reading out the unique data of the product-in-circulation 6 which is checked in the “COLLECTION” cell in the collection table.

Step [22] (S22)

The obtained unique data is used as a retrieving key, so that a value N, the current number of times the product-in-circulation has been collected, is read out in accordance with the product-in-use data table [1].

Step [23] (S23)

The read out value, the number of times collected, increases with increment of +1 as follows.

N=N+1

Step [24] (S24)

The “NUMBER OF TIMES COLLECTED” cell of the product-in-circulation data table is updated.

Step [25] (S25)

Whether any other products-in-circulation are to be updated or not is judged. When the update is not required, the process is finished, and when the update is required, the process goes back to the step 21.

It is rational that the service provider 10 provides an unused product-in-circulation 6, which has been collected in this way, to another contract signer 1.

FIG. 17(b) shows an example of a unique data/contract signer table in a case where a product-in-circulation 6, collected from a contract signer whose contract signer ID is 000125, is delivered to another contract signer 1 (contract signer ID: 102611). Comparison of FIG. 17(a) and FIG. 17(b) clarifies that three products-in-circulation 6 which were represented by the contract signer ID: 000125 on Mar. 22, 2000 are represented by the contract signer ID: 102611 on Jun. 20, 2000.

In this case, it is possible to use a contract signer table [2] shown in FIG. 7(b) so as to retrieve a contract signer 1 who receives the provision of the collected product-in-circulation 6.

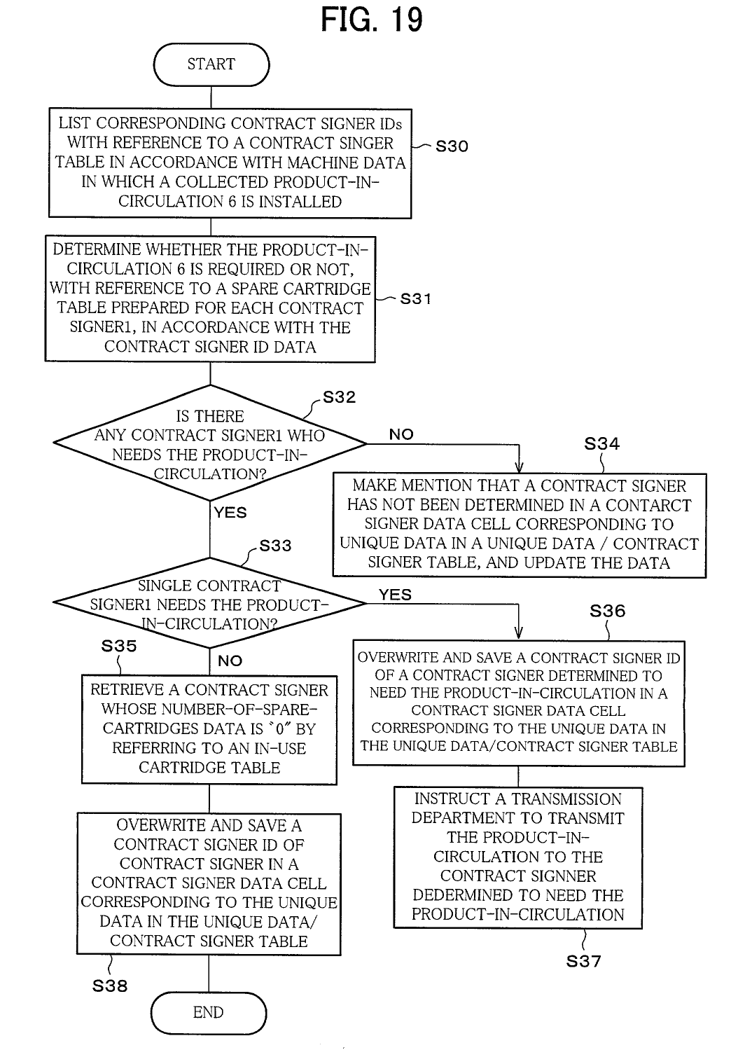

Referring to FIG. 19, a processing flow of the foregoing update is described as follows.

Step [30] (S30)

Referring to the contract signer table [2], the first detection is performed by listing corresponding contract signer IDs in accordance with machine data (in this example, the machine data of AR-2000, an image forming apparatus).

Step [31] (S31)

Referring to the spare cartridge table prepared for each contract signer 1, whether the product-in-circulation 6 is required or not is judged in accordance with the contract signer ID data.

The judgement on whether the product-in-circulation 6 is required or not is performed as follows. For example, spare cartridges number data of FIG. 10(a) FIG. 49(a), FIG. 11(a), FIG. 11(a), FIG. 50(a), FIG. 12(a), and FIG. 51(a) is retrieved so as to detect whether a value is “0” or “1”, that is, whether a spare cartridge is stocked or not. If the value is “0”, this means that the spare cartridge is not stocked. Then, it is necessary to avoid situations where the image forming apparatus 2 becomes inoperative because he/she has run out of the toner cartridge 60, when the contract signer 1 wants to use the image forming apparatus 2 for the extended period of time; thereby, it can be determined that the contract signer still needs the service with respect to the collected product-in-circulation 6.

Step [32] (S32)

As a result of the foregoing judgement, whether a contract signer 1, judged to need the product-in-circulation 6, exists or not is detected. If the contract signer 1 exists, the process goes to step 33, and if the contract signer 1 does not exist, the process goes to step 34.

Step [33] (S33)

As a result of the foregoing detection, if contract signers 1 judged to need the products-in-circulation 6 exist, the number of the contract signers 1 is detected. If plural contract signers 1 exist, the process goes to step 35. If a single contract signer 1 exists, the process goes to step 36.

Step [34] (S34)

As a result of the foregoing detection, if there is no contract signer 1 judged to need the product-in-circulation 6 exists, in the unique data/contract signer table, such content that a contract signer 1 has not been determined is entered into the contract signer data cell corresponding to the unique data, so that the unique data/contract signer table is updated. In this case, such content that a contract signer 1 has not been determined is entered by deleting a contract signer ID which has been already entered, and by entering “SUSPENSION” or “-” etc.

Step [35] (S35)

When there are more than one contract signer 1 is judged to need the product-in-circulation 6 in S33, referring to an in-use cartridge table, a contract signer 1, who is retrieved first from the contract signers 1 whose spare cartridges number are “0”, is determined as a candidate. Note that, the candidate may be determined as follows. Referring to the spare cartridge table, a period from the installation date of a product-in-circulation 6 in use to the current date is calculated. If a contract signer 1 whose calculated period is longer than that of any other contract signer 1 is detected, the contract signer 1 may be determined as the candidate. According to the process, a contract signer 1, who needs the earliest supplement of the product-in-circulation 6, is predicted, so that it can be described that this process is more rational. The prediction may be performed in other ways.

Step [36] (S36)

If a single contract signer 1 is judged to need the product-in-circulation 6 at a ramification command of step 33, in the unique data/contract signer table, a contract signer ID of the contract signer 1 judged to need the product-in-circulation 6 is overwritten and saved in the contract signer data cell corresponding to the unique data.

Step [37] (S37)

Following the operation in S36, a dispatch department and a similar department are instructed to dispatch the product-in-circulation 6 to the contract signer 1 judged to need the product-in-circulation 6.

Step [38] (S38)

Meanwhile, after candidates are determined from the contract signers 1 whose spare cartridge data is “0” in the operation of S35, in the unique data/contract signer table, a contract signer ID of the contract signer is overwritten and saved in the contract signer data cell corresponding to the unique data.

By the foregoing processes, if the unique data/contract signer table shown in FIG. 17(b) is referred to, the unique data is used as a retrieving key, so that it is possible to confirm and specify the latest contract signer 1 of a product-in-circulation 6 having the unique data.

Further, when a product-in-circulation 6 whose contract signer ID data is not entered, this means that where the product-in-circulation 6 is to be delivered has not been determined yet. Thus, the product-in-circulation 6 is to be provided as a serviced object to the contract signer 1 who needs the product-in-circulation 6.

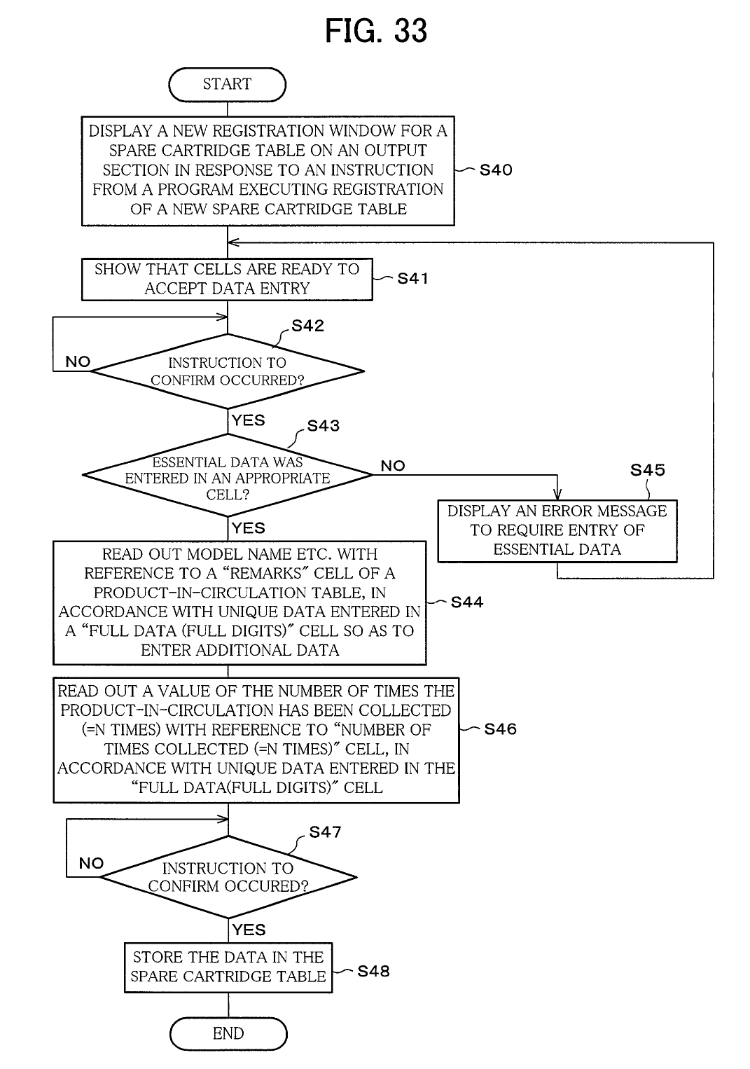

Next, the following is a description of a processing procedure of the arithmetic processing section 122 for executing a registration process of a new service management table (a new in-use cartridge table and a new spare cartridge table) and update thereof. This is described referring to FIG. 33 to FIG. 36.

(1) Registration Process of a New Spare Cartridge Table

Step [40] (S40)

First, in response to an instruction from a program executing registration of a new spare cartridge table, the output section 125 displays a new registration window for a spare cartridge table shown in FIG. 8(b). The program executing registration of a new spare cartridge table is nothing but the program executing S41-S48 detailed below. The program is pre-installed in the memory section 124 in the terminal 12 and launched at detection of a click on an on-screen execution button of the program for new registration displayed on the output section 125.

Step [41] (S41)

Cells showing “CONTRACT SIGNER ID,” “MACHINE MODEL DATA,” and “FULL DATA (FULL DIGITS)” in the column under “SPARE CARTRIDGE DATA” are now ready to accept data entry and are displayed to show the machine is waiting for data entry through the input section 123. For example, a prompt message appears encouraging the user to enter data and notifying where to enter. FIG. 8(b) shows the table after “CONTRACT SIGNER ID” (not shown) and “MAIN BODY MODEL” data have been entered.

Step [42] (S42)

A check button (not shown) is displayed on screen, allowing the person to confirm the data entered in the registration window. If the button is clicked on, the arithmetic processing section 122 executes S43. Otherwise, the arithmetic processing section 122 stands by.

Step [43] (S43)

In S44, the arithmetic processing section 122 checks as to whether every piece of essential data was entered in an appropriate cell. If there is no piece of essential data missing, the arithmetic processing section 122 executes S44. Otherwise, the arithmetic processing section 122 executes S45.

Step [44] (S44)

In S44, the product name and model number are read out in reference to the “REMARKS” cells in the product-in-circulation data table [1] shown in FIG. 6(a) and FIG. 6(b) on the basis of the unique data entered in the “FULL DATA (FULL DIGITS)” cell, and then pasted to “COLOR DATA,” “MODEL DATA,” and other cells in the spare cartridge table. The “DATE OF DELIVERY” cell may be automatically filled in with the date of the entering of unique data into the “FULL DATA (FULL DIGITS)” cell, i.e., the date of the delivering of the toner cartridge 60 to the contract signer 1, in response to the entering. To this end, a timer function of the terminal 12 is used.

This step is intended to improve the operation efficiency of the operator of the terminal 12. The unique data (or full data in this case) of the toner cartridge 60 is numerically represented, and the operator cannot figure out a specific product name, model number etc. from the numeric data alone. The step is optional and not essential if the processing is handled all by a computer.

Step [45] (S45)

If there is any piece of essential data missing in S43, the arithmetic processing section 122 executes S45 where a prompt message appears encouraging data entry, before returning to S41. To be more specific, the arithmetic processing section 122 causes an error message like “Essential Data Missing. Try Again.” to be displayed on-screen with a check button, and executes S41 again in response to a click on the button. In the second session of S41, the data entered in the previous session is not deleted, but retained as was entered: the cells are simply ready again for data entry.

Step [46] (S46)

Referring to the “NUMBER OF TIMES COLLECTED (=N TIMES)”! cell shown in FIG. 6(a) and FIG. 6(b), the number of times collected of the corresponding product-in-circulation 6 is read out in accordance with the unique data entered in the “FULL DATA (FULL DIGITS)”, and is pasted on the “NUMBER OF TIMES COLLECTED (=N TIMES)” cell.

Step [47] (S47)

Following to operations of S46, the arithmetic processing section 122 checks as to whether registration of a new spare cartridge table has been completed and a registration instruction has been made by a click on a registration button.

Step [48] (S48)

The data entered in the spare cartridge table is recorded to complete the new registration. As a result, the manager window changes from that shown in FIG. 8(b) to that shown in FIG. 9(b).

By executing these steps, the terminal 12 of the service provider 10 can store the number, model types, ID numbers, and other data on the toner cartridges 60 that has been delivered to the contract signer 1, but are yet to be use.

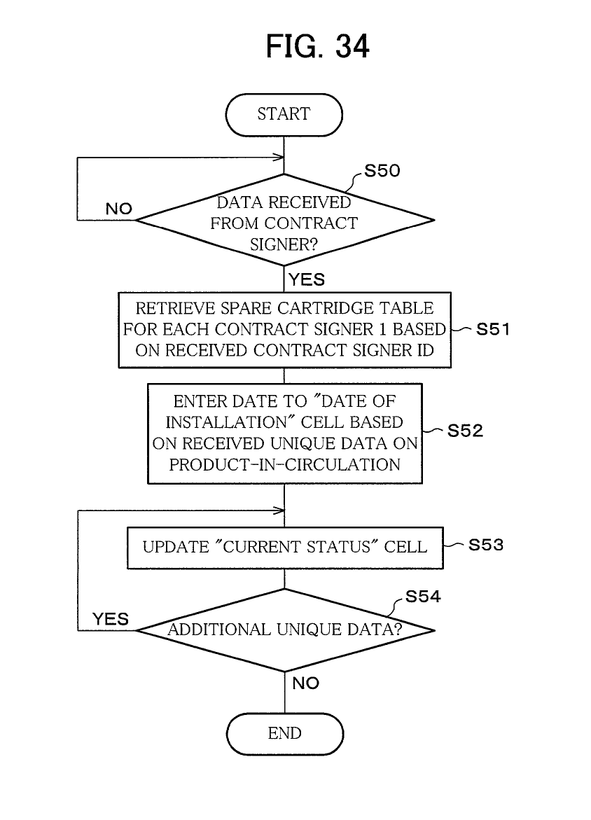

(2) Update Process 1 of a Spare Cartridge Table Next, referring to FIG. 34, an update process of the spare cartridge table will be described.

Step [50] (S50)

Judgement on whether or not data (contract signer ID and unique data of a product-in-circulation 6) is received from the contract signer 1 via the communications section 121 is performed.

Step [51] (S51)

In accordance with the received contract signer ID, the spare cartridge table (see FIG. 9(b)) for each contract signer 1, which is stored in the memory section 124 by the process of the new registration, is read out, and the read out spare cartridge table is displayed on the output section 125 as required.

Step [52] (S52)

In accordance with the received unique data of the product-in-circulation 6, date is entered in the “USE DATE” cell. Reception date can be entered as the foregoing date. This date entry may be made, as described above, based on the timer function of the terminal 12, whereby the timer value at a time when the unique data is received is read out and copied.

Step [53] (S53)

“IN USE” is entered in the “CURRENT STATUS” cell. The “CURRENT STATUS” cell is described as follows. In the “CURRENT STATUS” cell, five items, that is, “NO DATA”, “UNUSED (SPARE)”, “IN USE”, “USED”, and “COLLECTION” are prepared in advance. In the registration window, an initial value “NO DATA” is automatically selected and entered. Further, after the registration is completed, “NO DATA” is changed to “UNUSED (SPARE)”.

In the present update process, unique data obtained by reception is checked with the registered unique data, and “UNUSED (SPARE)” is changed to “IN USE” in the “CURRENT STATUS” cell corresponding to the registered unique data identical to the obtained unique data.

Step [54] (S54)

Whether any other unique data has been received or not is judged. If any other unique data has not been received, the foregoing data is updated and the process is finished. If another unique data has been received, the process returns to step 53.

(3) Update Process 2 of a Spare Cartridge Table

The foregoing steps are executed in a case where use of a product-in-circulation 6 is detected for the first time. However, in a case where a machine 2 is used for an extended period of time, a replacement process of the product-in-circulation 6 occurs.

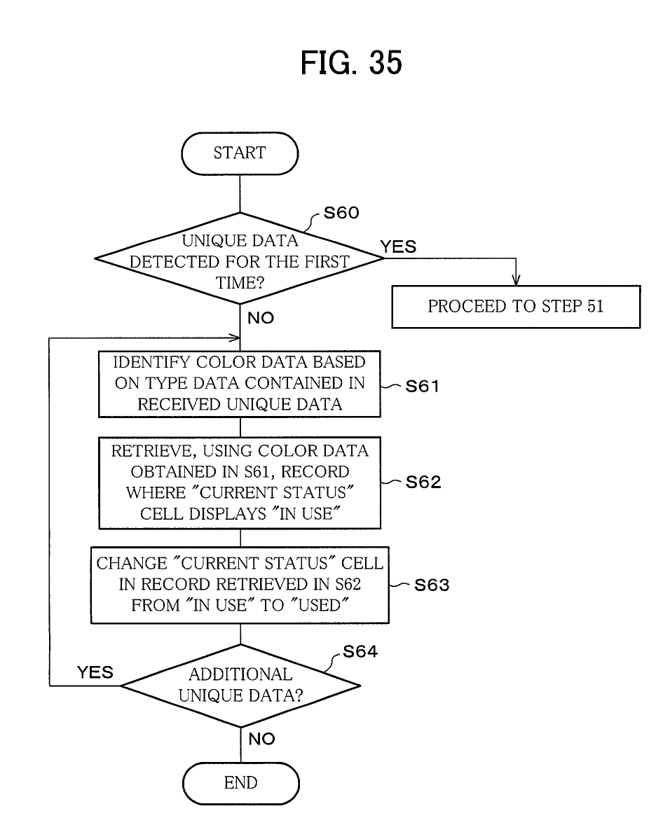

Next, referring to FIG. 35, an update process of the spare cartridge table performed in the replacement process will be described.

Step [60] (S60)

First, whether the unique data is detected for the first time or not is judged. If the unique data is detected for the first time, processes after the foregoing step 51 are performed. If the unique data is judged to be detected in the replacement process, the following processes are performed.

Specifically, the foregoing judgement is performed as follows. Upon reception of the unique data, a spare cartridge table concerning the corresponding contract signer 1 is read out, so as to detect whether or not there is a record which was entered as “IN USE” in the “CURRENT STATUS”. In a case where a product-in-circulation 6 is used for the first time, unique data 6 is also detected for the first time. This means that entrance of “IN USE” has not been performed. While, in a case where the replacement of the product-in-circulation 6 is performed, the unique data 6 has been detected twice or more. This means that “IN USE” has been entered in the “CURRENT STATUS” cell.

In an example of FIG. 10(b), entrance of “IN USE” exists in each of four records (records No. 1 to No. 4).

Step [61] (S61)

Type data of incoming unique data is read out so as to specify calor data. The specification of the color data is as follows. According to the foregoing rules whereby unique data is created, the first four digits in the incoming unique data is the data representing type. Thus, the color data is specified by reading out the first four digits and referring to the product-in-circulation data table given in FIG. 1 to FIG. 3 etc.

Taking the case of FIG. 11(b) as an example, the incoming unique data was a record indicated by No. 5. In accordance with the first four digits, “0000” , the data is judged to be that of a black toner cartridge compatible with AR-2000 model, an image forming apparatuses 2.

Note that, in a case where only one image forming apparatus 2 as a serviced object for the contract signer 1 exists, machine data can be omitted. Thus, color data may be specified in accordance with the first two digits.

Step [62] (S62)

A record which has been entered as “IN USE” in the “CURRENT STATUS” cell is retrieved by using the color data obtained in the foregoing step 62. The example of FIG. 10(b) shows that the record is No. 1 record.

Step [63] (S63)

The record retrieved by the foregoing step 62 is updated so that its “CURRENT STATUS” cell is changed from “IN USE” to “USED”. Further, a record No. 5 corresponding to the incoming unique data is updated so that its “CURRENT STATUS” cell is changed from “UNUSED (SPARE)” to “IN USE”.

Step [64] (S64)

Whether there is another corresponding unique data or not is judged. If there is not another corresponding unique data, the foregoing data is updated and the process is finished. If there is another unique data, the process returns to step 61.

FIG. 11(b) shows an example of a result of the foregoing processes. This shows that the records No. 1 and No. 5 are updated.

(4) Update Process 3 of a Spare Cartridge Table

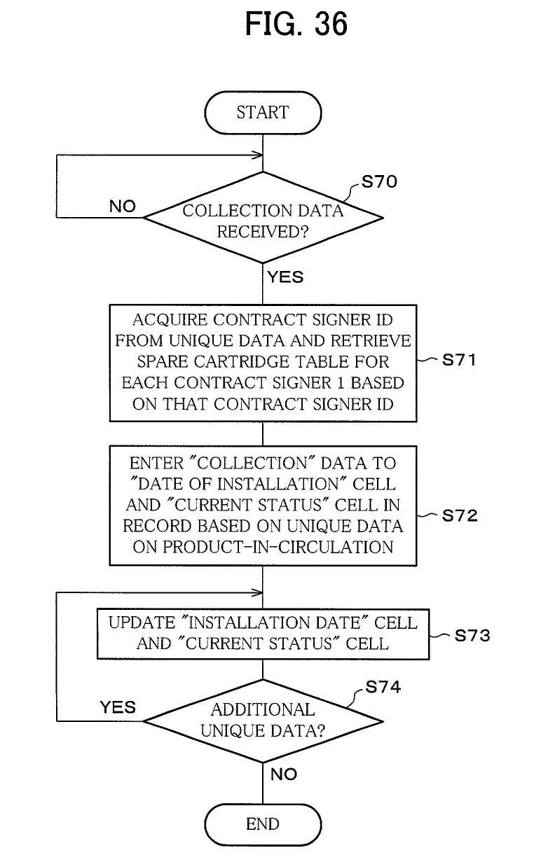

Referring to FIG. 36, an update process of the spare cartridge table performed in a collection process of a product-in-circulation 6 will be described.

Step [70] (S70)

First, whether or not there is a product-in-circulation 6 which is to be collected is judged on the basis of reception or entrance of arbitrary collection data.

Step [71] (S71)

In a case where there is the product-in-circulation 6 which is to be collected, contract signer ID is obtained from unique data of the product-in-circulation 6 so as to read out a spare cartridge table for each contract signer 1 in accordance with the contract signer ID.

Step [72] (S72)

In accordance with the unique data of the product-in-circulation 6, “COLLECTION” is entered in the “USE DATE” cell and the “CURRENT STATUS” cell of a corresponding record.

Step [73] (S73)

The “USE DATE” cell and the “CURRENT STATUS” cell of the corresponding record are updated.

Step [74] (S74)

Whether or not there is another unique data of the product to be collected is judged. If there is not another unique data, the process is finished. If there is another unique data, the process returns to step 72.

FIG. 12(b) shows an example of a result of the foregoing processes. This shows that the records No. 6 to No. 8 are updated.

Basically, the in-use cartridge table is created by merely extracting a part of the foregoing spare cartridge table. The data content of the spare cartridge table is not changed, but how the content is displayed is rearranged. In this way, main data is based on the spare cartridge table and independent rectification of data is forbidden in the in-use cartridge table, so that it is possible to keep the consistency in the both tables.

In more detail, when there are plural records, entered in the “USE DATE” cell, which are identical to each other in terms of color type data, a record whose “USE DATE” is the latest is displayed in the spare cartridge table.

Thus, in an example shown in FIG. 9(a) and FIG. 9(b), data is partially entered into the spare cartridge table, but no data has been entered into the “USE DATE” cell, so that no data is entered into the in-use cartridge table.

Further, in an example shown in FIG. 11(b), there are two records having “00” as color data: records No. 1 and No. 5. As a result of comparison of two “USE DATE” cells of the both records, data of the records No. 5 is displayed.

When a contract signer 1 uses not genuine products but pirated versions such as imitative products which has been delivered by a service provider 10, this is detected as follows.

For example, data received by the communications section 121 is checked with data that the arithmetic processing section 122 registered in a service management table shown in FIG. 12(b) etc. As a result of checking, in a case where the arithmetic processing section 122 detects that the same ID number as the ID number which has already been registered as “USED” is included, or the same individual number (unique data) as an individual number (unique data) which has been already registered is included, there is a possibility that pirated versions such as imitative products are used. Then, the arithmetic processing section 122 performs a process for informing the use of the pirated version to the service provider 10 (display process, electric mail transmission process etc.).

Thus, the service provider 10 dispatches a service person to the contract signer 1 who may be using pirated versions such as imitative products, so that it is possible to confirm whether the pirated versions are used or not, and the service provider 10 spies out a circulating path of the pirated versions such as imitative products, so that it is possible to employ necessary measures to eradicate the pirated versions.

Note that, the data received by the communications section 121 is checked with data registered in each of all the service management tables created with respect to all the contract signers 1 respectively. Further, the following arrangement may be made. When a product-in-circulation 6 is manufactured or wrapped, an ID number management file for managing ID numbers assigned to respective products-in-circulation 6 is stored in memory means of the memory section 124, and the data received by the communications section 121 is checked with all the ID numbers registered in the ID number management file. In this case, when the communications section 121 receives an ID number which has not been registered in the ID number management file or similar data, the arithmetic processing section 122 can judge that the product is not a genuine product that is actually manufactured.

In an embodiment in which the communications section 121 receives contract signer ID and an ID number of a product-in-circulation 6 always in a set, if both the contract signer ID and the ID number of the product-in-circulation 6 are checked with registered data respectively, it is possible to improve accuracy in checking the use of the pirated versions such as imitative products.

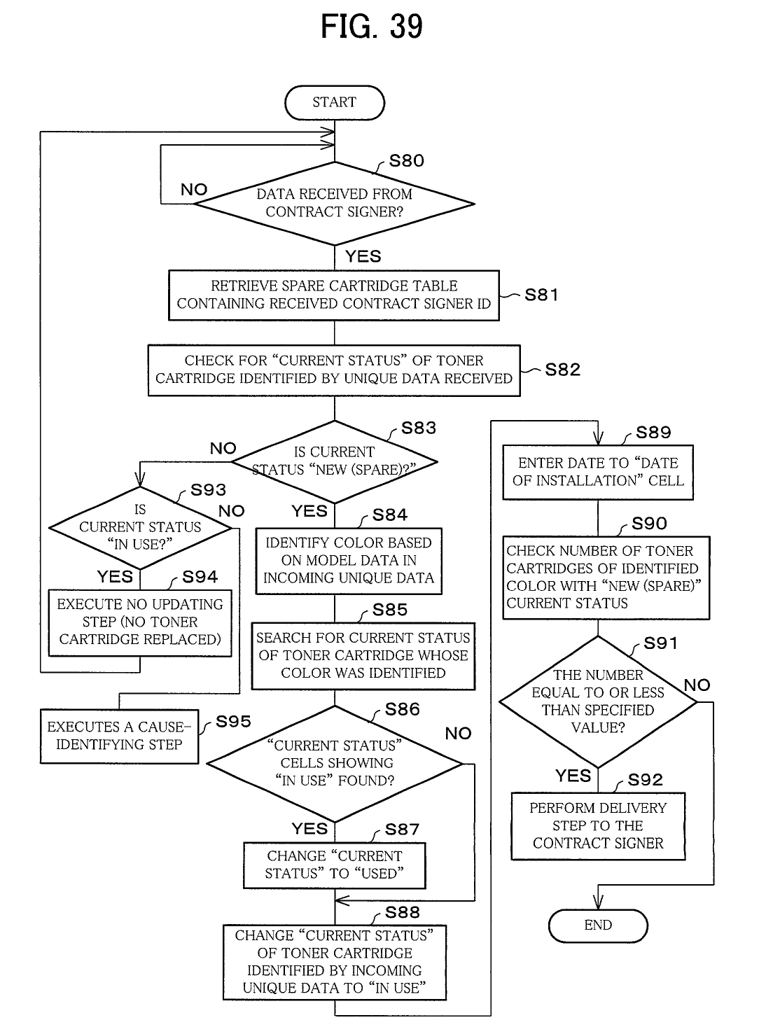

FIG. 39 is a flow chart which shows how the arithmetic processing section 122 operates with respect to an automatic update process and stock management of the spare cartridge table, and a detection process of the pirated versions. The flow chart will be further described.

Step [80] (S80)

First, judgement on whether or not data of a product-in-circulation 6 (contract signer ID, unique data of a toner cartridge 60 etc.) is received from an image forming apparatus 2 of a contract signer 1 is performed via the communications section 121. If the data is received, the process goes to S81. If not, reception of the data is waited for.

Step [81] (S81)

Contract signer ID is detected from the data of the product-in-circulation 6 received in S80. In accordance with the detected contract signer ID, a spare cartridge table (FIG. 10(b)) to which corresponding contract signer ID is attached is read out from plural spare cartridge tables stored in the memory section 124. Note that, the read out spare cartridge table is displayed on the output section 125 as required.

Step [82] (S82)

Next, a toner cartridge 60 which includes the unique data (full data) received in S80 is retrieved in the “STATUS CURRENT” cell of the spare cartridge table.

Step [83] (S83)

Further, whether or not “UNUSED (SPARE)” is recorded in the corresponding “CURRENT STATUS” cell is judged. As a result of the judgement, if “UNUSED (SPARE)” is recorded in the “CURRENT STATUS” cell, the process goes to S84. If not, the process goes to S93.

Step [84] (S84)

In a case where the “CURRENT STATUS” cell is judged to be “UNUSED (SPARE)”, color data is read out from the unique data (full data) of the toner cartridge 60 received in S80, so that color of the toner cartridge 60 is specified. The specification is performed as described above (see step [61]).

Step [85] (S85)

Next, the toner cartridge 60 whose color data is specified in S84 is retrieved in the “CURRENT STATUS” of the spare cartridge table.

Step [86] (S86)

After the retrieval of the toner cartridge 60 performed in the “CURRENT STATUS” cell is completed, whether or not there is a “CURRENT STATUS” cell, in which “IN USE” is recorded, is judged. As a result of the judgement, if there is the “CURRENT STATUS” cell in which “IN USE” is recorded, the process goes to S87. If not, the process goes to S88.

Namely, if there is not the “CURRENT STATUS” cell in which “IN USE” is recorded, this is a case where the unique data is detected in the image forming apparatus 2 of the contract signer 1 for the first time since the unique data was registered in the spare cartridge table. That is, one of unused toner cartridges 60, which have already been delivered to the contract signer 1, is installed in the image forming apparatus 2 for the first time, and its unique data is read out by the read-out section 4 so as to be transmitted to the terminal 12.

While, if there is the “CURRENT STATUS” cell in which “IN USE” is recorded, this is a case where the toner cartridge 60 in which “IN USE” is recorded is replaced with the toner cartridge 60 whose unique data have been received. That is, the toner cartridge which have been installed in the image forming apparatus 2 is removed, and is replaced with one of unused toner cartridges which have been delivered to the contract signer 1. As a result, its unique data is read out by the read-out section 4 so as to be transmitted to the terminal 12.

Step [87] (S87)

In S86, if there is the “CURRENT STATUS” cell in which “IN USE” is recorded, the present step is executed, and the “CURRENT STATUS” cell is updated so that “IN USE” is changed to “USED”. Then, the process goes to S88.

Step [88] (S88)

In the present step, as to the toner cartridge 60 which includes the unique data (full data) of the toner cartridge 60 received in S30, the “CURRENT STATUS” cell is updated so that “UNUSED (SPARE)” is changed to “IN USE”.

Thus, in a case where the toner cartridge 60 is installed in the image forming apparatus 2 for the first time, and also in a case where the toner cartridge 60 having been installed is replaced with a new toner cartridge 60, “IN USE” is recorded in the “CURRENT STATUS” cell of the spare cartridge table, so that the toner cartridge 60 installed in the image forming apparatus 2 can be specified in accordance with the record.

Step [89] (S89)

Further to operations of S88, in the present step, in a case where “unused (spare)” is recorded in the “CURRENT STATUS” cell of the toner cartridge 60 whose unique data is received in S80, date at a time when the unique data is detected is entered in its “USE DATE” cell. This automatic date entry is made, as described above, based on the timer function of the terminal 12, whereby the timer value at a time when the unique data is received is copied.

Step [90] (S90)

Next, as to the toner cartridges 60 which includes the color data specified in S84, the number of the toner cartridges 60 whose “CURRENT STATUS” cell indicates “NEW (SPARE)” is checked.

Step [91] (S91)

The number obtained in S90 is then compared with a prescribed value to determine whether the number of toner cartridges 60 of “NEW (SPARE)” becomes not more than the prescribed value. If the number is not more than the prescribed value, the process goes to S92.

If the number exceeds the prescribed value, the update of the spare cartridge table is finished. Alternatively, the process may return to S80 to repeat the update of the spare cartridge table.

Step [92] (S92)

If the number of toner cartridges 60 of “NEW (SPARE)” is not more than the prescribed value in S91, it means that the contract signer 1 is running out of stock of toner cartridges 60 of that color; a delivery step is performed to supply toner cartridges 60 to the contract signer 1. Please refer to the foregoing for details about inventory management.

Step [93] (S93)

Meanwhile, in S83, if the current status of the toner cartridge 60 specified by the incoming unique data is not “NEW (SPARE),” the present step is executed, so as to judge whether the current status is “IN USE” or not.

Step [94] (S94)

If the current status is “IN USE” in S93, it is judged that no toner cartridge 60 in the image forming apparatus 2 has been replaced, but a toner cartridge 60 in use has been removed and reinstalled for some reasons as will be detailed later. When this is the case, the spare cartridge table is not updated.

Step [95] (S95)

Meanwhile, if the current status is not “IN USE” either in S93, it means, among other possibilities, that there is no record about the toner cartridge 60 or that its current status is “USED” or “COLLECTION;”, there must be something wrong. Since it is suspected that the toner cartridge installed in the image forming apparatus 2 is a pirated version, a cause-identifying process is performed. Specifically, an on-screen warning is displayed on the output section 125 or the situation is informed to a managing department of the service provider 10 by means of e-mail or other means via a local network 22 to which the communications section 121 is connected.

The present invention is applicable not only to a printer, but also to a system constituted by two or more devices (e.g., host computer, interfaces, readers, printers) and a stand-alone device (e.g., a copying machine, a facsimile).

The object of the present invention can be of course achieved by (i) a memory medium provided in the system or device to record thereon program codes of software that realizes the functions of the foregoing embodiments and (ii) the computer (or CPU, MPU, etc.) provided in the system or device to read and execute the program codes recorded on the memory medium.

When this is the case, the program codes per se that is read in from the memory medium realize the functions of the foregoing embodiments, and the memory medium recording the program codes thereon is the present invention.

Examples of the memory medium to record the program codes include floppy disks, hard disks, optical disks, magneto-optical disks, magnetic tapes, and nonvolatile memory cards.

The program codes may be provided in such a form that they can be downloaded to the memory section 124 in the terminal 12 from another computer system via a transmission medium, such as a communications network.

By reading and executing the program codes, the computer can realize the functions of the foregoing and following embodiments. In addition, needless to say, the OS (operating system), etc. running on the computer entirely or partly performs actual processing based on instructions in the program codes to realize the functions of the foregoing embodiments.

Needless to say, after the program codes read out from the memory medium are written into memory provided in an extension keyboard inserted in the computer or an extension unit connected to the computer, the CPU, etc. provided in the extension board or extension unit may entirely or partly perform actual processing based on instructions in the program codes to realize the functions of the foregoing embodiments.

When the present invention is applied to the foregoing memory medium, the memory medium stores program codes equivalent to the aforementioned flowcharts.

The scope of the present invention is not limited to the foregoing embodiments and may be varied in many ways within the metes and bounds of the claims.

Note that, through the whole descriptions, the main parts of the present invention relate to a replacement service of consumable products and degradable products. Thus, it is not necessarily basic or essential to sign contract with respect to a main body of an image forming apparatus. That is, it is needless to say that the service of the present invention can be applied to a main body of an image forming apparatus which a contract signer leases, rents, or purchases from another company.

However, when a person, who makes leasing contract or rental contract with respect to a main body of an image forming apparatus or purchases the main body, makes contract concerning the service of the present invention at the same time, it is possible to perform the procedure required in the present invention smoothly.

The present invention is applicable not only to copying machines, printers, etc., but to all the replacement parts that have a short lifetime than the main machine. It is preferred if unique data of a product-in-circulation is created and can be read by the main body, since removal and installation of the replacement part are electronically detectable.

[Embodiment 2]

In embodiment 1, it was assumed that the image forming apparatus 2 covered in the contract for use by the contract signer 1 is connected to the terminal 12 of the service provider 10 around the clock. In view of the frequency of replacing cartridges. the connection may be made, for example, once a day, a week, or even a month. In such cases, the contract signer 1 and the service provider 10 makes an advance arrangement on a time to transmit data from the contract signer 1. Supposing that a connection is made once a day at 24:00, memory means (not shown) records events which happened from 0:00 to 23:59 and transmits that data to the terminal 12 of the service provider 10 at the preset connection time.

If an old toner cartridge 60 was replaced, data on the newly installed toner cartridge 60 is transmitted; if the old toner cartridge 60 was not replaced at all, either data on the currently installed toner cartridge 60 or data indicating that no change took place is transmitted. Transmitting data of any kind even when the toner cartridge 60 was not replaced makes it possible to tell failed connections from cases where the toner cartridge 60 was really not replaced.

Meanwhile, the terminal 12 of the service provider 10 is “activated” at least during the time period in which data is transmitted from the contract signer 1, for example, from 23:55 to 24:05 (covering five minutes before and after connection is started). “Activation” here is an operation to cause the terminal 12 to appropriately process the data transmitted from the contract signer 1.

The limited connection time as above reduces connection fees over a telephone line network and power consumption by the communications machines (5, 121, etc.) of both the contract signer 1 and the service provider 10.

The image forming apparatus 2 is typically powered off at night and other non-business hours. However, when the connection time is set in non-business hours as in above, if the main switch for the image forming apparatus 2 is turned off, the communications means is also cut of f power and cannot start up to establish a connection. The communications means (transmitter/receiver section 5) should be therefore powered separately from the rest of the image forming apparatus 2. The memory (memory means) is preferably rewritable, nonvolatile memory so that it will not lose records when the communications means is turned off by an error.

[Embodiment 3]

Paper is sometimes jammed in the device during the use of the image forming apparatus 2 because of problems mostly caused by the device's transport system. To remove the jammed paper, the detachable toner cartridge 60 and its associated components need to be removed and then reinstalled in the image forming apparatus 2.

Such removal and reinstallation of a cartridge, which is irrelevant to replacement of a cartridge at all, adds complexity to data transmission, if data is transmitted as described in the foregoing embodiment.

Such useless data is also unwanted by the service provider 10 who receives it. In addition, if the date of replacement is updated, the service provider 10 possibly fails to correctly charge the contract signer 1.

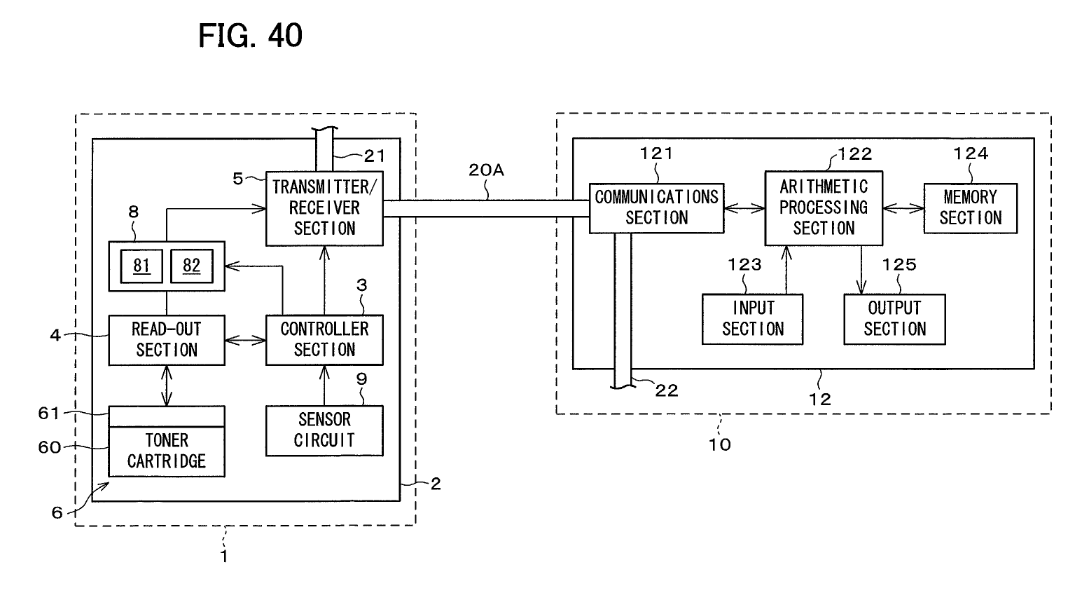

Therefore, an arrangement is made in the present embodiment, whereby if a cartridge is removed and then reinstalled, no cartridge data is transmitted. To this end, as shown in FIG. 40, the image forming apparatus 2 is provided with a computing section 8. Composed of a memory section 81 and a comparator section 82, the computing section 8 causes the comparator section 82 to compare the latest data fed from the read-out section 4 with the data stored in the memory section 81. If the two sets of data disagree with each other, the data is transmitted to the transmitter/receiver section 5 to update the records stored in the memory section 81. If they agree, a step is executed so that no data is transmitted and hence no records are updated.

The computing section 8 is not necessarily provided separately, but integrated as part of the controller section 3.

In addition, in an image forming apparatus that comes complete with a memory device, such as a hard disk, to perform functions related to image formation, the hard disk can be used as the memory section 81.

[Embodiment 4]

The process described in the previous embodiment was realized by an arrangement in the contract signer 1. Trouble is that the computing section 8 needs be provided separately for additional cost.

In view of this problem, in the present embodiment, the process is realized by the service provider 10. If the incoming data is identical to the data registered as “IN USE,” the arithmetic processing section 122 determines that the cartridge has been removed and then reinstalled and updates no data; if the two sets of data are not identical, the arithmetic processing section 122 determines that the cartridge has been replaced and takes a step to update the spare cartridge table and the installed cartridge table. The process is realized by the same hardware as described in the previous embodiment or executed by means of software in the terminal 12. The latter is preferred for its versatile applicability, low cost, and a wide range of choices of control methods.

[Embodiment 5]

In embodiments 1 to 4, products-in-circulation 6 that are essential to the operation of the image forming apparatus 2 were subjected to the service as examples. The present invention is not however limited to these examples and is applicable to provision of more general products to contract signers 1.

In the following embodiment, the term, ordinary products, is used referring to products in such conditions that they can be bought up straightly by typical consumers, thereby inclusive of, in addition to the actually used or consumed goods, containers and cases holding them and packing and wrapping members.

Here, the degradable and consumables rewrapped, repacked, or otherwise further processed to contain the ordinary product and a unique data forming section (first data recording body), such as the foregoing IC chip 61, in which a product-specific ID number and other data is stored, are redefined as a product-in-circulation. In these senses, some ordinary products can be packed and wrapped anew (packaged) as a new product in the subject service. The product-in-circulation in accordance with the present invention includes products that are repacked and rewrapped in, for example, manufacture by the manufacturer itself with an enclosed first data recording body to sell them in packages or set goods. In the present system, products-in-circulation will be sometimes referred to simply as products Examples of such products include four or two tires or wheels sold in a bundle and everyday commodities or liquors, teas, and coffees sold in a package.

The product-in-circulation may be further processed, for example, to attach the data storage bodies 7.

Such examples include, as well as products bought by end users, components of products if the contract signer 1 is a module manufacturer. For example, in the case of a computer device equipped with a liquid crystal display, the liquid crystal display, liquid crystal module, liquid crystal driver are all products-in-circulation.

Further examples include toiletries, such as shampoo and soap; cosmetics; sanitary products for babies and the aged; automobile parts, such as tires and moduled components; office supplies; data storage media, such as books, compact disks, video tapes, and digital video disks; preserved foods; clothes; medical supplies; ICs and other electronic components; toys; electric appliances and components; machinery and its components; pharmaceutical products; propane gas container; house and other building materials; metals; and plastic materials.

Further, as would be clear from the above examples, if actually used or consumed goods that are sold in powder, liquid, gas, or near-liquid form and that are uncountable can be measured when put in a container of a fixed capacity, they are encompassed in the scope of the present invention.

(Network System)

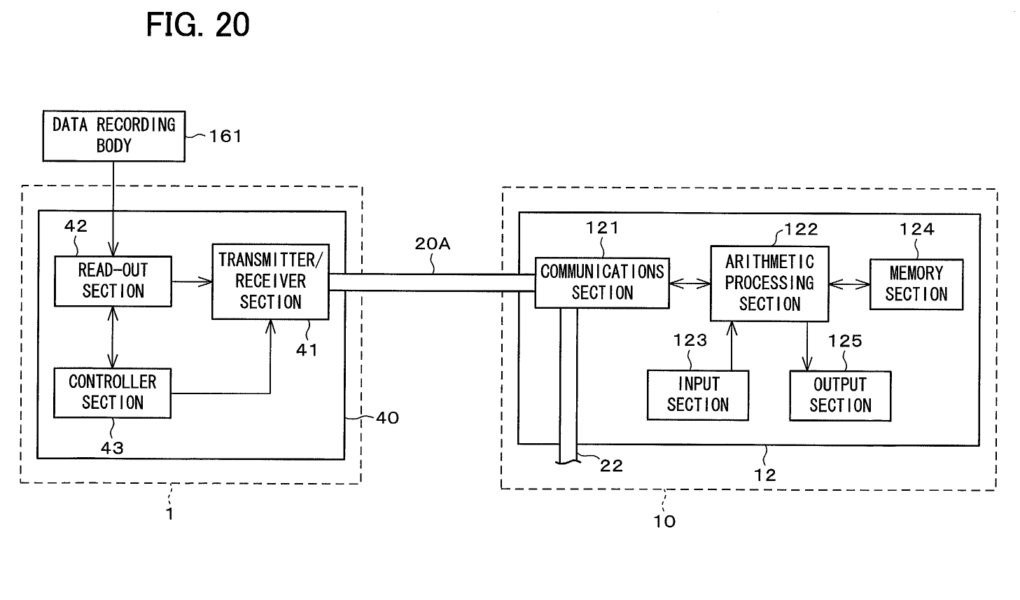

As shown in FIG. 20, the service provider 10 first provides a second terminal 40 to the contract signer 1 and delivers a product 65, such as paper as a supply product for a printer; a CD, DVD, or other optical disk, or a video tape on which images, movies, music, application software, or game software is stored. For consistency with embodiments 1 to 4, the product 65 here should be actually called the product-in-circulation 6; however, the terminology is used when products-in-circulation, such as toner cartridges 60, that are necessary to operate the machine need be distinguished from others. Under these circumstances, there are no specific restrictions on the kinds and numbers of products delivered. However, packaged products are excluded, and two or more products should be involved to effectively apply the present invention.

The service provider 10 gives the contract signer 1 brochures, etc. with a list of products delivered next time and onwards where necessary. Thus, the contract signer 1 can determine and order products delivered next time and onward. This is beneficial to both sides: the contract signer can buy those products that exactly match his/her needs, and the service provider 10 can increase the sales. Brochures are not essential and may be replaced with something else: for example, the service provider 10 makes a list of selected products-in-circulation 6 in advance so that the contract signer 1 selects what he/she would need from the list and that the service provider 10 can determine the products-in-circulation 6 to be delivered in advance in reference to the selection. Details will be given later.

In reference to the block diagram of FIG. 20 illustrating the hardware, the second terminal 2 provided to the contract signer 1 is connected to the terminal 12 of the service provider 10 via the transmitter/receiver section 41 and the telephone lines 20A, etc. The transmitter/receiver section 41 is, for example, a modem and may be connected via a similar network like CATV or a dedicated network system, instead of telephone lines.

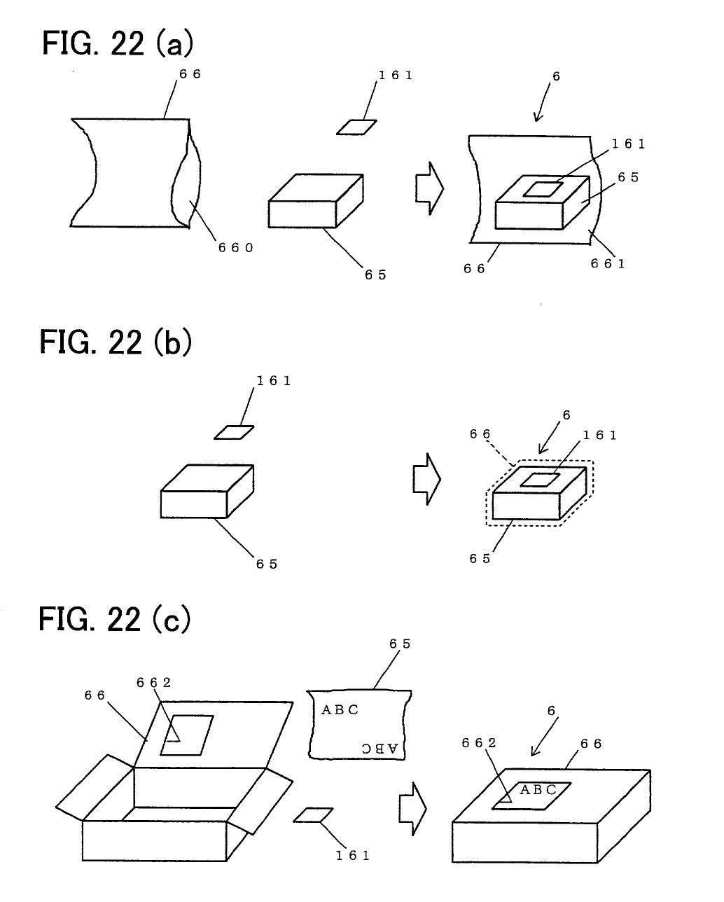

Specifically, the second terminal 40 is basically constructed of a read-out section 42 for reading data from a data recording body 161 (first data recording body replacing the IC chip 61) that accompanies the product 65 shown in FIG. 22(a) for example; a controller section 43 for executing the control; and the transmitter/receiver section 41 for externally supplying the read-in data.

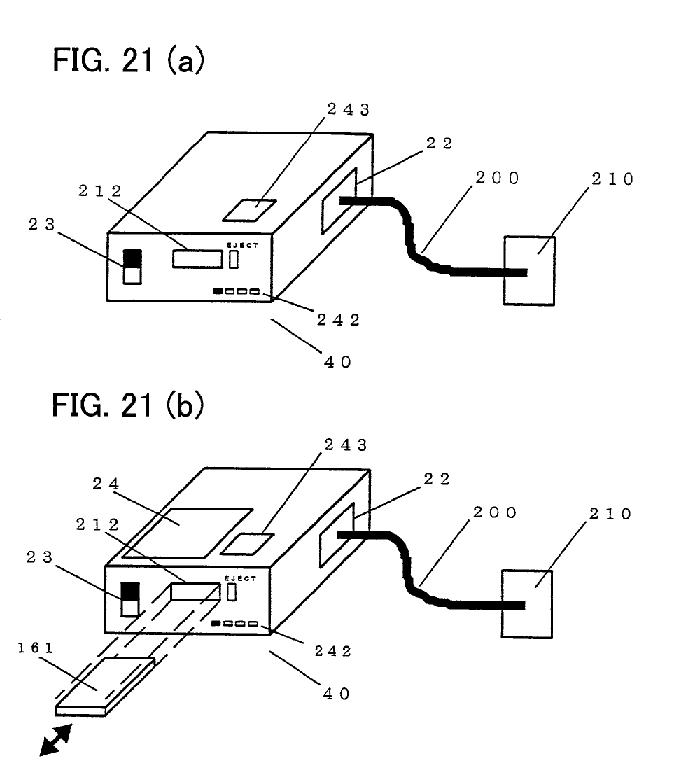

FIG. 21 shows the exterior of the second terminal 40. The second terminal 40 includes, for example, a power switch 23 for the whole device, a read slot 212 in which a read-out section 42 is housed and the data recording body 161 is disposed, a connector 22 to the transmitter/receiver section 41, and a display section 243. A power supply cable and connector to the second terminal 40 are omitted.

The second terminal 40 is connected via a communications cable 200 to a network connector 210 installed in a house.

As shown in FIG. 21(b), when, for example, the data recording body 161, such as an IC card, is deliberately inserted or connected in the read slot 212 of the second terminal 40, the controller section 43 automatically reads electronic data. Then, when a submission button 243 is pressed, the controller section 43 causes the transmitter/receiver section 41 to externally transmit the data.

The submission button 243 can be omitted if the transmission is done automatically.

The terminal 12 of the service provider 10 register, update, correct, etc. the data of the contract signer 1 through the network 20 (telephone lines 20A) and/or the input section 123.

(Request of Products-in-Circulation)

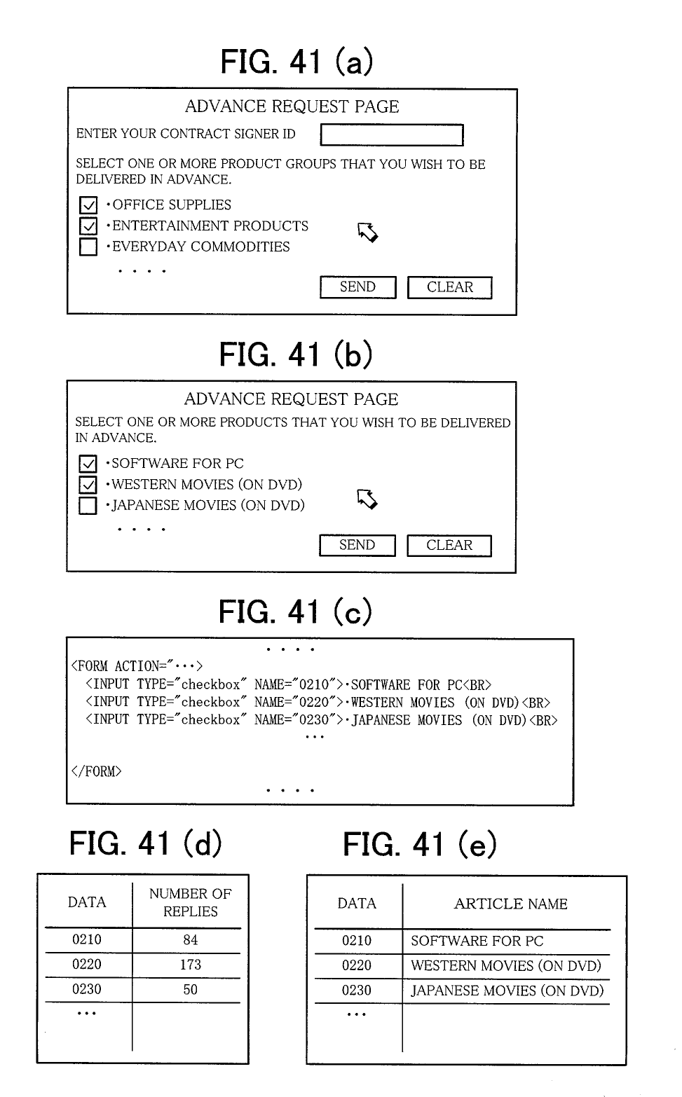

In reference to FIG. 41, the following will describe how to determine the products-in-circulation 6 to be delivered in advance to the contract signer 1 in view of wishes of the contract signer 1.

FIG. 41(a) and FIG. 41(b) show an example of a page (hereinafter, advance request page) enabling the contract signer 1 to make a request over the Internet for products-in-circulation 6 to be delivered in advance.

Both have an entry box to enter the contract signer ID as data that confirms that the contract signer is an authorized user to receive service in accordance with the present invention.

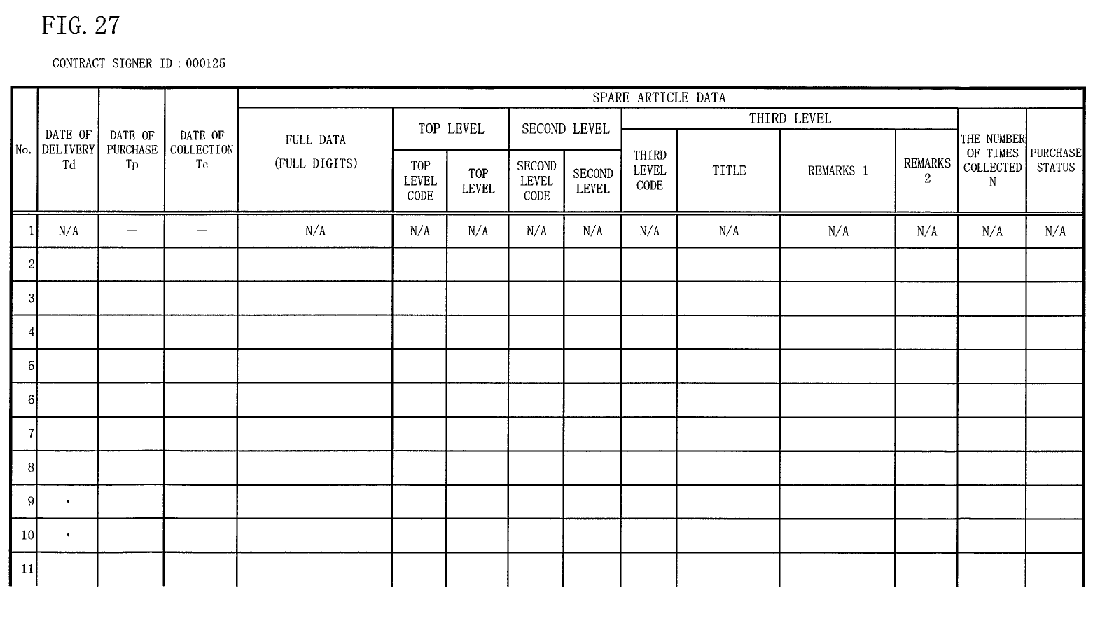

FIG. 41(a) is for making a rough request for groups of products, such as office supplies, entertainment products, and everyday commodities. FIG. 16(b) shows subgroups. These pages can be used selectively. Alternatively, if “Entertainment Products” is selected in FIG. 16(a), for example, the advance request page of FIG. 16(b) appears showing subgroups to invite the contract signer to makes more entries. When this is the case, the advance request page of FIG. 16(b) needs no entry box to enter the contract signer ID. As will be detailed in reference to FIG. 27, the advance request page may show specific names of products-in-circulation, such as “XYZ” data search and exploiting software.

The contract signer 1 selects a preferred product group, product name, or the specific name of a product-in-circulation in the advance request page and then clicks on the submission button to transmit the results of the questionnaire to the terminal of the service provider 10. The terminal is typically a dedicated Web server, but the foregoing terminal 12 may be used instead.

FIG. 41(c) shows some source codes for the advance request page of FIG. 41(b) written in HTML (Hypertext Markup Language). As can be seen here, the questionnaire can be conducted very easily by the use of a <FORM>tag. To enable the user to select two or more options, “checkbox” is used as the TYPE attribute of the <Input>tag. The file is stored in the Web server.

In an embodiment where the terminal 12 is used in place of the Web server, a list of products-in-circulation 6 that can be delivered to the contract signer 1 written in the HTML is stored in a memory section (third memory section) 124 of the terminal 12 and transmitted from the terminal 12 to the terminal 40 as an HTML document in response to a request by the second terminal 40 having a browser function. Thus, the contract signer 1 can access the list of products-in-circulation 6 stored in the terminal 12.

The service provider 10 then collects request results from the contract signer 1.

Specifically, when the contract signer 1 selects “Software for PCs” as shown in FIG. 41(b), the code “0210” specified in the NAME attribute is transmitted via the transmitter/receiver section 41 to the terminal 12 according to the source code of FIG. 41(c). Likewise, the code “0220” matched with “Western Movies (DVD)” selected by the contract signer 1 is simultaneously transmitted.

Therefore, the terminal 12 collects advance request data for each contract signer 1 in the form of, for example,

(Contract Signer ID)+(Code Data Selected by Contract Signer)

Next, the terminal 12 counts advance request data sent from all the contract signers 1. FIG. 41(d) shows an example of a count table. The codes appearing in the data column correspond one to one to options in FIG. 41(a) and FIG. 41(b) as dictated in the file of FIG. 41(c). FIG. 41(e) shows which product is represented by which code. The “Number of Replies” column in the count table shows the number of replies (requests) counted for each code.

Next, with respect to the number-of-replies column in FIG. 41(c), the codes are rearranged in a descending order of the number of replies.

Next, for example, the top ten items are designated as products-in-circulation 6 to be delivered in advance, that is, products-in-circulation 6 subjected to the service management method in accordance with the present invention. The service provider 10 can freely determine how many products-in-circulation 6 should be subjected to the service.

Next, in reference to FIG. 41(e), the codes of the products-in-circulation 6 selected by the foregoing process are translated into product names, etc. so that people can understand.

If there are not many contract signers 1, the products-in-circulation 6 to be delivered in advance may be determined as preferred by each contract signer 1.

The foregoing process is handled by the arithmetic processing section 122. A counting program and a request program stipulating the above procedures are stored in the memory section 124.

In this manner, the contract signer 1 makes an advance request for products-in-circulation 6 delivered to the contract signer 1 to select the products-in-circulation 6 he/she wishes to buy; the contract signer 1 is thereby supplied with the most suitable products-in-circulation 6 and is more likely to buy the supplied products. Further, the service provider 10 can prepare products-in-circulation 6 based on the counted advance requests. This facilitates ordering, inventory management, etc. of the service provider 10.

By presenting to the contract signer 1 a list of products-in-circulation 6 made in view of advance requests, the service provider 10 can inform the contract signer 1 of popular products-in-circulation 6. This would further improve the likelihood of the contract signer 1 to buy products and reduce bad inventory that would not lead to purchase.

The service provider 10 can recognize popular and unpopular products-in-circulation 6 based on, for example, the results of the advance request from the contract signer 1. By feeding back such results of the advance request quickly when selecting products-in-circulation 6 that are to be subjected to the service, the service provider 10 can provide service with more efficiency: for example, the likelihood of the contract signer 1 buying products would be enhanced.

(Configuration of Product-in-Circulation)

In reference to FIG. 22 to FIG. 24, the following will describe products-in-circulation 6.

FIG. 22(a) shows an example of preparing a product-in-circulation 6 by wrapping the product 65 and the data recording body 161 (data holder section) with transparent wrapping material 66 that is shaped like a plastic bag with an opening 660 through which the product 65 and the data recording body 161 enter the bag-like wrapping material 66. The wrapping material 66 is sealed after the product 65 and the data recording body 161 are placed inside by thermally closing the opening 660 (seal section 661).

To protect the data recording body 161 from damage due to the product 65 colliding or rubbing against the data recording body 161 inside the wrapping material 66, the data recording body 161 is adhered or secured to the product 65 using tape, etc as necessary.

If the wrapping material 66 can accommodate a larger volume than that of the product 65, the resultant product-in-circulation 6 is likely to be far larger in volume than the product 65. To prevent this from happening, the wrapping material 66 may be evacuated when sealed.

FIG. 22(b) shows an example of wrapping the product 65 and the data recording body 161 with wrapping material 66 that can be used for laminate wrapping. In comparison with the method of FIG. 22(a), the material 66 fits the product 65 and the data recording body 161 and thereby prevent the product 65 from colliding and damaging the data recording body 161. Also, the wrapping material 66 adds little to the total volume.

All the foregoing examples of the wrapping material 66 were made of transparent resin so that the content is visible from the outside without opening the seal.

FIG. 22(c) shows an example of placing the product 65 and the data recording body 161 in wrapping material 66 that is shaped like a cardboard box. In the foregoing two examples, the product 65 was wrapped in transparent wrapping material 66 and therefore visible from the outside after being wrapped. To meet the demand, the cardboard-box-shaped wrapping material 66 is provided with an opening 662 that is covered with transparent resin film; the product 65 thereby becomes visibly recognizable. To confirm the attachment of the data recording body 161, no special arrangement is necessary other than placing the data recording body 161 at such a place that it is at least partly visible from the outside through the opening 662.

In the foregoing examples, card-shaped media, such as a magnetic card and an IC card, are suitably used as the data recording body 161. Details of the data recording body 161 will be given later.

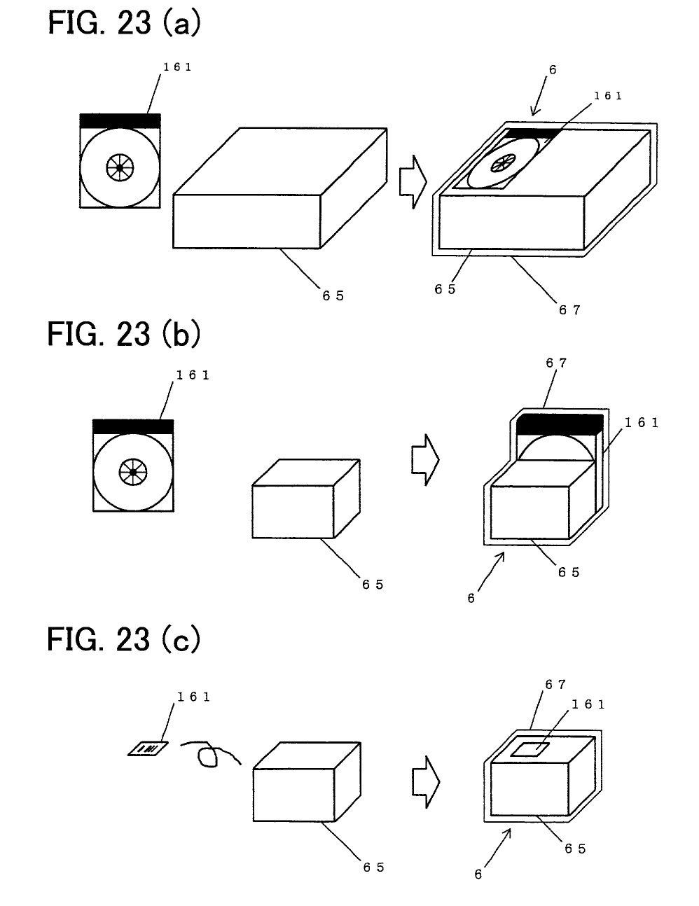

FIG. 23(a) and FIG. 23(b) show examples where a disk-shaped medium is used as the data recording body 161. FIG. 23(a) shows a data recording body 161 smaller than the product 65. The product 65 is, for example, 100 sheets of A4-sized recording paper. FIG. 23(b) shows a data recording body 161 as large as or larger than the product 65. The product 65 is, for example, a cartridge for use with an inkjet printer. In either case, the product 65 and the data recording body 161 are wrapped fittingly using the transparent resin film 67.

FIG. 23(c) shows an example where a medium with a bar code is used as the data recording body 161. When such data is created, the data recording body 161 is attached to the product 65 with the data-formed surface down and wrapped fittingly with transparent resin film 67, to prevent the data content from being visually and easily read and reproduced in manufacture of fake copies and to protect the data-formed surface from damage. Instead of being wrapped fittingly, the data recording body 161 may be adhered to the product 65 using adhesive tape, etc.

Further, some products 65 may be packed and wrapped in a single package. For example, 100 sheets of ordinary paper, 20 sheets of photographical paper, and sticker paper, all for use in inkjet printers, may be wrapped in a single package. In such cases, the packages will be handled as a new product to which a service management method is applied in accordance with the present invention. FIG. 23 shows examples.

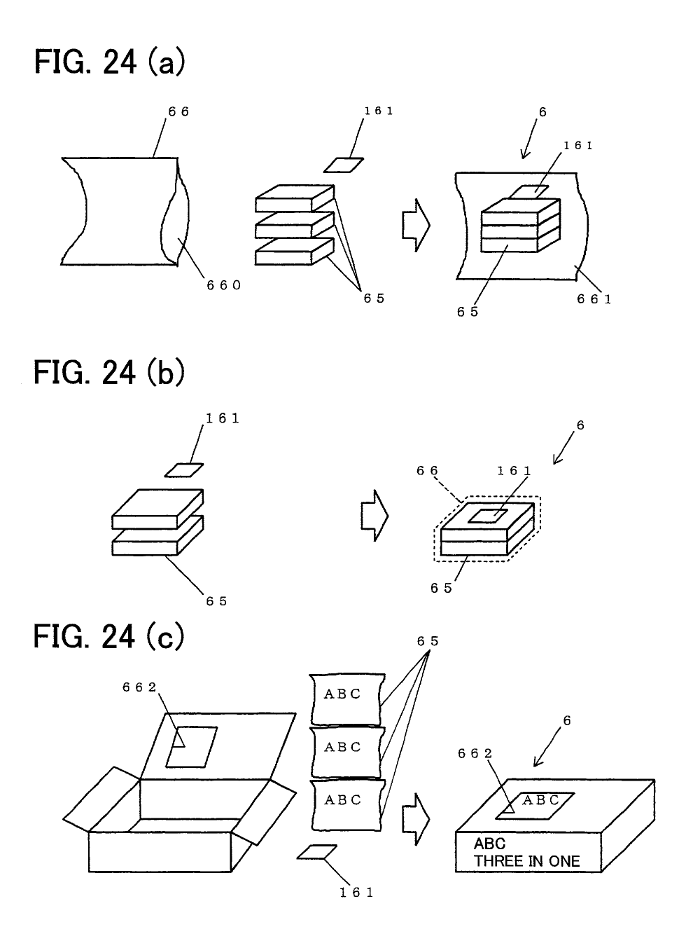

FIG. 24(a) to FIG. 24(c) correspond to FIG. 22(a) to FIG. 22(c) respectively.

So far, the wrapping material (packing and wrapping member) 66 was made at least partly transparent for easy recognition of the product 65, since the entire product 65 was repacked and rewrapped. If the product 65 is only partly wrapped, the product 65 is bare in the other parts; the wrapping material 66 is therefore not necessarily transparent.

(First Data Recording Body, Example 1)

The data recording body 161 preferably stores thereon or therein the unique data of the product. For example, in the example of FIG. 22(b), the data recording body 161 is an IC chip storing unique data in the form of electronic data.

A product model number and an ID number are recorded in advance in EEPROM, mask ROM, or other nonvolatile ROM in an IC chip or recorded by an easy method, such as a bar code. To eradicate unauthorized copies, the former is preferred, because copies or similar products are difficult to manufacture.

In the present invention, the IC chip basically does not have to record anything more than a product model number and an ID number for specific product.

The IC card or IC chip is not anything special. Commercially available memory and cards, i.e., compact flashes (CF), smart media (SM), memory sticks (MS), all registered trademarks, can be used.

The IC card or IC chip required in the present invention basically does not have to record anything more than a product model number and an ID number for specific product or be rewritable under typical circumstances. The IC card or IC chip therefore only needs limited memory capacity and functions, which helps a lot in trimming down the memory controller and other software, as well as hardware, in size.

(First Data Recording Body, Example 2)

Now, another data formation method will be described.

Reversible recording material can be used as the data recording body 161. For example, some methods, such as thermochromism, photochromism, and electrochromism, exploit heat, light, magnetism, or electricity to record and delete data.

Among them, heat-sensitive storage media which exploit heat energy are easy to handle and already commercially used in supermarkets and car parts shops. The storage media are advantageous in that they can be recycled and reused. Reversible heat-sensitive storage media can be divided into different types: examples include types that exploit coloring and decoloring properties of a leuco dye which is a electron-donating dye precursor, those that exploit scattering of light caused by phase separation or phase change of a polymer compound, and those that exploit optical changes between transparency and opacity (murkiness) caused by a variation in a refractive index.

The read-out means can be basically means for reversible heat-sensitive storage media.

(First Data Recording Body, Example 3)

Another data formation method will be described.

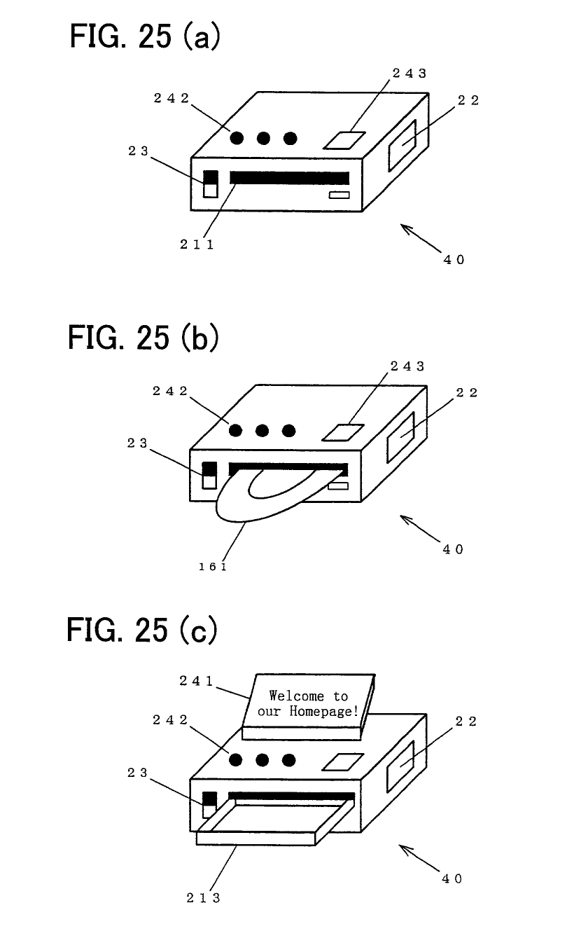

FIG. 25(b) shows a data recording body 161 that is a magneto-optical recording medium. The medium is already in commercial use as an MD for music and data recording, MD2, MO, etc. It can store data repeatedly and is reusable. The read-out means can be basically a driver or pickup for magneto-optical recording media and needs no modification. Therefore, putting the system on sale is relatively easy and requires no new investment in plant facilities.

The present invention requires only a small data-recording capacity which is much smaller than actual capacities of commercial used disks. Therefore, relatively small disks can be used. In this case, conventional pickups can be used with a small modification added to the design. The data recording body 161 needs to be small in size so that it can be attached to the product: 5-cm disks are preferred to 12-cm disks. Meanwhile, in the field of optical disks, studies are continuously conducted to reduce the size of the disk. The commercial system, if manufactured in compliance with these standards and sale phase, can be introduced and utilized with no special investment in plant facilities and leaves possibilities open for other applications.

The unused capacity of the data recording body 161 can be utilized to additionally store product lists for a next delivery, data on new products, advertisement, and user's manual for the product 65 in text, video, audio or other format in advance.

(First Data Recording Body, Example 4)

In the foregoing, the unique data of a product was magnetically or electronically recorded in a magnetic card, an IC chip, or an IC card. A lower-cost, easier method will be now described.

The data recording body 161 will be described in detail. As shown in FIG. 23(c), the data recording body 161 is, for example, a 15 mm×50 mm medium on which a decimalized, nine-digit alphanumeric, such as A00000001 or A99999999, is printed. The alphanumeric is data by which the product-in-circulation 6, a consumable, can be identified. The notation and the number of digits are not limited to this example. The data can be represented by binary alphanumeric or have fourteen digits. The data may be represented by numbers alone, not by alphabets. The recording medium may come in other dimensions: if there are a variety of products to which the medium is attached, the medium is preferably of such a size that match to the smallest product so that storage media of a single size can be packed together with products of various sizes and a single type of read-out means can be used with regardless of the size of the product.

The alphanumeric is now described in terms of meaning.

The leftmost digit is data to specify the type of product and can represent up to 26 distinct types by the use of 26 alphabets.

The numeric part is an ID number of, for example, the A-type product. Each piece of the product is assigned its unique number.

The data does not have to be printed: it may be recorded in various forms including punched holes, lumps and dents, and a bar code.

The medium may be made of paper, plastic, metal, or their composite. Paper media are disposable and can be manufactured at low cost and treated easily after disposal. Plastic ones are durable and therefore can be recycled or reused. Metal ones, being more durable and more suited to recycling and reuse, are environmentally friendly.

The thickness of the medium, although variable depending on the material and overall size, should be decided in view of the dimensions of various data cards already in actual use. If the thickness of a paper or plastic medium is too small, the medium may curl up.

The smaller the media, the smaller conventional consumables can accommodate the media. However, if the media are too small, they are difficult to handle and easy to lose. Media smaller than a postage stamp would be impracticable.

(Unique Data of Product, Example 1)

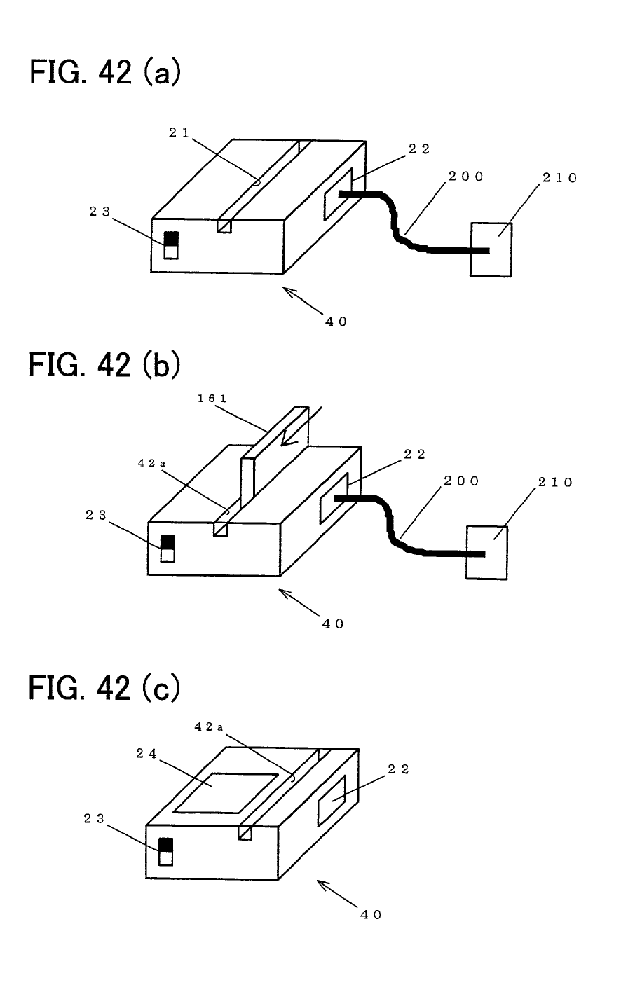

The data recording body 161 has preferably unique data of the product recorded thereon or therein. For example, the data recording body 161 is a magnetic card as shown in FIG. 42(b) and has unique data recorded magnetically.

In the present invention, the data recording body 161 basically records only a product model number and an ID number for that particular product.

Next, the recorded data is described in terms of its content. The magnetic card records data to specify the product 65 in the form of binarized 20-digit number: for example 0011 0001 0010 1101 1010. The number of digits may vary. Binary notation is used here in compliance with principles of memory; decimal notation might be used instead for better man-to-machine interface and would make it possible for general, non-expert people with no knowledge about binary numbers to handle the data represented by familiar decimal notation without binary-decimal conversion.

Now, the number is described in terms of its meaning.

The first four digits are data to identify the type of product 65 and in this case can represent up to 16 distinct types by the use of numbers from 0000 through 1111. For example, the first two digits represent product's top level groups and the next two digits represent groups of a next level. A possible combination of digits and groups of both levels is shown in Table 5.

TABLE 5

| | | First 4 Bits | | | |
|---|---|---|---|---|---|
| | | | | Sec- | |
| Product Group | | Top Level | | ond Level | |
| Top Level | Second Level | Group Bits | | Group Bits | |
| A6 IJ Paper | Ordinary Paper | 0 | 0 | 0 | 0 |
| A6 IJ Paper | Special Paper | 0 | 0 | 0 | 1 |
| A6 IJ Paper | Glossy Paper | 0 | 0 | 1 | 0 |
| A6 IJ Paper | Photographic Paper | 0 | 0 | 1 | 1 |
| A4 IJ Paper | Ordinary Paper | 0 | 1 | 0 | 0 |
| A4 IJ Paper | Special Paper | 0 | 1 | 0 | 1 |
| A4 IJ Paper | Glossy Paper | 0 | 1 | 1 | 0 |
| A4 IJ Paper | Photographic Paper | 0 | 1 | 1 | 1 |
| A3 IJ Paper | Ordinary Paper | 1 | 0 | 0 | 0 |
| . . . | . . . | . . . | . . . | . . . | . . . |
| Postcard | Ordinary Paper | 1 | 1 | 0 | 0 |
| . . . | . . . | . . . | . . . | . . . | . . . |

To be more specific, the top level group bits are designated to stipulate paper sizes, and the second level group bits are designated to stipulate paper types.

For example, the top level group bits “00” represent a product 65 that is A6-size inkjet paper, and there are prepared four sets of second level group bits to further categorize the product 65 under these top level group bits: “00,” “01,” “10,” and “11” that represent ordinary paper, special paper, glossy paper, and photographic paper respectively.

Similarly, the top level group bits “01” represent that a product 65 that is A4-size inkjet paper, and there are prepared four sets of second level group bits to further categorize the product 65 under these top level group bits: “00,” “01,” “10,” and “11” that represent ordinary paper, special paper, glossy paper, and photographic paper respectively.

The top level group bits “11” represent a product 65 that is inkjet paper of a postcard size with postcode boxes, etc. printed on the back side, and there are prepared four sets of second level group bits to further categorize the product 65 under these top level group bits: “00,38 “01,” “10,” and “11” that represent ordinary paper, special paper, glossy paper, and photographic paper respectively.

The remaining sixteen digits, in the foregoing example, are an ID number of the product identified by the model number 0011 (A6-size photographic inkjet paper). Each piece of the product is assigned its unique number selected from 65536 numbers of 0000 0000 0000 0000 through 1111 1111 1111 1111.

Thus, if the contract signer 1 buys two pieces of the product 65, or two packs of A6-size photographic inkjet paper, the two pieces or packs are assigned different ID numbers. Thus, the service provider 10 can obtain precise purchase data based on ID number data.

If sticker paper, photocopy paper, or OHP transparencies for use with inkjet printer are added as a product 65, the top level group should be assigned three or more bits.

A bit or bits may be allocated to distinguish between packs of paper containing different numbers of sheets, for example, a pack of 20 sheets of photographic paper and a pack of 50 sheets of photographic paper.

(Unique Data of Product, Example 2)

So far, we have dealt with inkjet printer paper of a single manufacturer. Different models of even a single manufacturer require suitable paper of different properties. Also, there is special paper suited for a certain image forming method, such as special paper for use with video printers. The present invention is easy to adapt to these applications.

In addition, as will be detailed below, the present invention can handle inkjet printer paper of several manufacturers at the same time.

The data recording body 161 records data to identify the product 65 in the form of binarized 24-digit number: for example 000011 000101 011010 101101. The number of digits may vary. The 24-digit number is now described in terms of meaning.

The first six digits are data to identify the type of product 65 and in this case can represent up to 64 distinct types by the use of numbers from 000000 through 111111. For example, the first two digits represent product's top level groups, the next two digits represent second level groups, and the last two digits represent third level groups. A possible combination of digits and groups of three levels is shown in Table 6.

TABLE 6

| | | | First 6 Bits | | | | | |
|---|---|---|---|---|---|---|---|---|
| Product Group | | | | | Sec- | | | |
| Top | Second | Third | Top Level | | ond Level | | Third Level | |
| Level | Level | Level | Group Bits | | Group Bits | | Group Bits | |
| A Corp. | A6 | Ordinary | 0 | 0 | 0 | 0 | 0 | 0 |
| IJ Paper | | Paper | | | | | | |
| A Corp. | A6 | Photo- | 0 | 0 | 0 | 0 | 0 | 1 |
| IJ Paper | | graphic | | | | | | |
| | | Paper | | | | | | |
| A Corp. | A6 | Special | 0 | 0 | 0 | 0 | 1 | 0 |
| IJ Paper | | Paper | | | | | | |
| A Corp. | A6 | Glossy | 0 | 0 | 0 | 0 | 1 | 1 |
| IJ Paper | | Paper | | | | | | |
| A Corp. | A6 | Ordinary | 0 | 0 | 0 | 1 | 0 | 0 |
| IJ Paper | | Paper | | | | | | |
| . . . | . . . | . . . | . . . | . . . | . . . | . . . | . . . | . . . |
| A Corp. | B5 | Ordinary | 0 | 0 | 1 | 0 | 0 | 0 |
| IJ Paper | | Paper | | | | | | |
| . . . | . . . | . . . | . . . | . . . | . . . | . . . | . . . | . . . |
| A Corp. | Post- | Ordinary | 0 | 0 | 1 | 1 | 0 | 0 |
| IJ Paper | card | Paper | | | | | | |
| . . . | . . . | . . . | . . . | . . . | . . . | . . . | . . . | . . . |
| B Corp. | A6 | Ordinary | 0 | 1 | 0 | 0 | 0 | 0 |
| IJ Paper | | Paper | | | | | | |
| . . . | . . . | . . . | . . . | . . . | . . . | . . . | . . . | . . . |
| C Corp. | A6 | Ordinary | 1 | 0 | 0 | 0 | 0 | 0 |
| IJ Paper | | Paper | | | | | | |
| . . . | . . . | . . . | . . . | . . . | . . . | . . . | . . . | . . . |
| D Corp. | A6 | Ordinary | 1 | 1 | 0 | 0 | 0 | 0 |
| IJ Paper | | Paper | | | | | | |
| . . . | . . . | . . . | . . . | . . . | . . . | . . . | . . . | . . . |
| D Corp. | Post- | Glossy | 1 | 1 | 1 | 1 | 1 | 1 |
| IJ Paper | card | Paper | | | | | | |

To be more specific, the top level group bits are designated to stipulate manufacturer data, the second level group bits are designated to stipulate paper sizes, and the third level group bits are designated to stipulate paper types.

For example, the top level group bits “00” represent a product 65 that is inkjet paper of A Corp., and there are prepared four sets of second level group bits to further categorize the product 65 under these top level group bits: “00,” “01,” “10,” and “11” that represent A6, A4, B5, and postcard sizes respectively. Further, there are prepared four sets of third level group bits to further categorize the product 65 under these second level group bits: “00,” “01,” “10,” and “11” that represent ordinary paper, photographic paper, special paper, and glossy paper respectively.

Similarly, the top level group bits 37 01” represent a product 65 that is inkjet paper of B Corp., and there are prepared four sets of second level group bits to further categorize the product 65 under these top level group bits: “00,” “01,” “10,” and “11” that represent A6, A4, A3, and postcard sizes respectively. Further, there are prepared four sets of third level group bits to further categorize the product 65 under these second level group bits: “00,” “01,” “10,” and “11” that represent ordinary paper, photographic paper, special paper, and glossy paper respectively.

The top level group bits “10” and “11” represent products 65 that are inkjet paper of C Corp. and D Corp. respectively.

The remaining digits, in the foregoing example, are an ID number of the product 65 identified by the model number 000011 (A6-size inkjet, glossy paper of A Corp.)

(Unique Data of Product, Example 3)

Other contents of recorded data are now described. The data recording body 161 records in advance data to identify the product 65 in the form of binarized 20-digit number: for example, 0011 0001 0010 1101 1010. The number of digits may vary.

The 20-digit number is now described in terms of meaning.

The first four digits are data to identify the type of product 65 and in this case can represent up to 16 distinct types by the use of numbers from 0000 through 1111. For example, the first two digits represent product's top level groups and the next two digits represent groups of a next level. A possible combination of digits and groups of both levels is shown in Table 7.

TABLE 7

First 4 Bits

| | | | | Sec- | |
|---|---|---|---|---|---|
| Product Group | | Top Level | | ond Level | |
| Top Level | Second Level | Group Bits | | Group Bits | |
| A Corp. | Model a1 | 0 | 0 | 0 | 0 |
| Cartridge | | | | | |
| A Corp. | Model a2 | 0 | 0 | 0 | 1 |
| Cartridge | | | | | |
| A Corp. | Model a3 | 0 | 0 | 1 | 0 |
| Cartridge | | | | | |
| A Corp. | Model a4 | 0 | 0 | 1 | 1 |
| Cartridge | | | | | |
| B Corp. | Model b1 | 0 | 1 | 0 | 0 |
| Cartridge | | | | | |
| B Corp. | Model b2 | 0 | 1 | 0 | 1 |
| Cartridge | | | | | |
| B Corp. | Model b3 | 0 | 1 | 1 | 0 |
| Cartridge | | | | | |
| B Corp. | Model b4 | 0 | 1 | 1 | 1 |
| Cartridge | | | | | |
| C Corp. | Model c1 | 1 | 0 | 0 | 0 |
| Cartridge | | | | | |
| . . . | . . . | . . . | . . . | . . . | . . . |
| D Corp. | Model d1 | 1 | 1 | 0 | 0 |
| Cartridge | | | | | |
| . . . | . . . | . . . | . . . | . . . | . . . |

To be more specific, the product 65 is an ink cartridge for use in an inkjet printer. The top level group bits are designated to stipulate manufacturer data, and the second level group bits are designated to stipulate model data.

For example, the top level group bits “00” represent a product 65 that is an ink cartridge for use in an inkjet printer of A Corp., and there are prepared four sets of second level group bits to further categorize the product 65 under these top level group bits: “00,” “01,” “10,” and “11” that represent model a1, model a2, model a3, and model a4 respectively.

Similarly, the top level group bits “01” represent a product that is an ink cartridge for use in an inkjet printer of B Corp., and there are prepared four sets of second level group bits to further categorize the product 65 under these top level group bits: “00,” “01,” “10,” and “11” that represent model a1, model a2, model a3, and model a4 respectively.

The top level group bits “10” and “11” represent products that are ink cartridges for use in an inkjet printer of C Corp. and D Corp. respectively.

Cartridges come in various configurations, including (i) those containing the primary colors and black in one cartridge, (ii) those containing the primary colors in one cartridge and black in another, and (iii) those containing the primary colors in individual cartridges and black in another. For configurations (ii) and (iii), more digits are allocated to the second level group bits to distinguish between colors.

The remaining 16 digits are, in the foregoing example, an ID number of a product specified by a model number 0011.

(Unique Data of Product, Example 4)

Other contents of recorded data are now described. The data recording body 161 records in advance data to identify the product 65 in the form of binarized 20-digit number: for example, 0011 0001 0010 1101 1010. The number of digits may vary.

The 20-digit number is now described in terms of meaning.

The first four digits are data to specify the type of product 65 and in this case can represent up to 16 distinct types by the use of numbers from 0000 through 1111. For example, the first two digits represent product's top level groups and the next two digits represent groups of a next level. A possible combination of digits and groups of both levels is shown in Table 8.

TABLE 8

| | | First 4 Bits | | | |
|---|---|---|---|---|---|
| | | | | Sec- | |
| Product Group | | Top Level | | ond Level | |
| Top Level | Second Level | Group Bits | | Group Bits | |
| CD-ROM | Music | 0 | 0 | 0 | 0 |
| CD-ROM | Games | 0 | 0 | 0 | 1 |
| CD-ROM | General | 0 | 0 | 1 | 0 |
| CD-ROM | Business | 0 | 0 | 1 | 1 |
| DVD | Movies | 0 | 1 | 0 | 0 |
| DVD | Car Navigation | 0 | 1 | 0 | 1 |
| DVD | Database | 0 | 1 | 1 | 0 |
| . . . | . . . | . . . | . . . | . . . | . . . |
| VHS | Movies | 1 | 0 | 0 | 0 |
| . . . | . . . | . . . | . . . | . . . | . . . |
| Unrecorded | New VHS Tape | 1 | 1 | 0 | 0 |
| . . . | . . . | . . . | . . . | . . . | . . . |

To be more specific, the top level group bits “00” represent a product that is a CD-ROM, and there are prepared four sets of second level group bits to further categorize the product under these top level group bits: “00,” “01,” “10,” and “11” that represent music, game applications, general applications, and business applications respectively.

Similarly, the top level group bits “01” represent a product that is a DVD-ROM, and there are prepared four sets of second level group bits to further categorize the product under these top level group bits: “00,” “01,” “10,” and “11” that represent movies, car navigation software, and encyclopedia and other database, and so on respectively.

The top level group bits “10” and “11” represent products that are a video tape and a new tape of VHS format respectively.

The top level groups are not limited to the foregoing example, but may include MD and other magneto-optical disks, removable hard drive disks, floppy disks, super disks and other magnetic disks, rewritable DVDs, rewritable CDs, and PDs (Phase Change Optical Disks) and other optical disks. Third level groups may be used to further categorize the second level groups.

The remaining 16 digits are, in the foregoing example, an ID number of a product identified by a model number 0011. Each piece of the product is assigned its unique number selected from 65536 numbers of 0000 0000 0000 0000 through 1111 1111 1111 1111.

(Second Terminal 40, Example 1)

FIG. 20(a) to FIG. 20(c) shows an example of a second terminal 40 provided to the contract signer 1 when a magnetic card is used as the data recording body 161. The second terminal 40 is provided with a slit section 42a into which the magnetic card is inserted. As the magnetic card is moved deliberately along the slit section 42a as shown in FIG. 42(b), its data is read out by a fixed head section (not shown) provided in the slit section 42a of read-out device.

The data read out is transmitted externally from communications means composed primarily of a transmitter/receiver section 41, a communications connector 22, a communications cable 200, and a network connector 210 and fed via the network 20 to the communications section 121 of the terminal 12.

Alternatively, the data recording body 161 may be fixed instead of the read-out device with the head section disposed so as to be movable for data read-out.

(Second Terminal 40, Example 2)

Other configurations of the second terminal 40 will be now described in reference to FIG. 21(a) and FIG. 21(b).

FIG. 21(a) to FIG. 21(c) show an example of a memory card used as the data recording body 161. The second terminal 40 is provided with a connector section 212 which connects to the memory card. Data is read out electrically through the connection of the connector section 212 to the memory card.

The readout data is externally transmitted by communications means composed of a transmitter/receiver section 41, a communications connector 22, a communications cable 200, a network connector 210, etc.

There are provided a submission button 243 to instruct transmission and an eject button to eject the memory card.

A display section 242 may be provided to display, for example, an error message.

The display section 242, thus provided, can notify the user whether the data readout and transmission has been completed without an error. The user can therefore carry out the process, while feeling a sense of security.

(Second Terminal 40, Example 3)

Another example of the second terminal 40 will be now described in reference to FIG. 25(a) to FIG. 25(c).

FIG. 25(a) to FIG. 25(c) show examples where the data recording body 161 is an optical disk. The head in the read-out device reads out data from the optical disk, while the optical disk is rotating. Basically, the second terminal 40 here is an optical disk drive device and can be constructed as in either FIG. 25(a) or FIG. 25(c), depending on how to insert the optical disk.

FIG. 25(a) and FIG. 25(b) show constructions where the optical disk as the data recording body 161 is inserted in a disk insertion slot 211. Since this constructions do not include a loading tray 213 as does the construction shown in FIG. 25(c), they have several advances including quick loading, increased reliability of the device, and low cost because of fewer components used.

The method of FIG. 25(c) requires a tray 213 to house an optical disk and has several advantages in comparison with the method of FIG. 25(a), including better protection against dust and versatility for disks of various diameters.

In the present invention, the data recording body 161 is preferably rewritable for recycling purposes. However, the second terminal 40 only needs to read data stored in the data recording body 161; no other functions are essential. The pickup in the second terminal 40 should be readout only and does not need to have any extra functions to prevent undesirable writing or erasure of data.

For example, no magnetic circuit is required if the data recording body 161 is a magneto-optical disk in which data is stored by magnetic modulation. In a case of a phase-change type of optical disk, laser with a relatively low output power is sufficient, because it only has to perform reproduction, not writing or erasure; The lower output improves reliability and leads to cost reduction. The control circuit is less complex, because it only has to execute reproduction.

Disk-type data storage bodies 161 are not limited to magneto-optical disks and may be magnetic disks, phase-change types of optical disks, etc. Further, if the data recording body does not need to be recycled, it may be a CD-ROM, CD-R, or another similar medium.

(Second Terminal 40, Example 4)

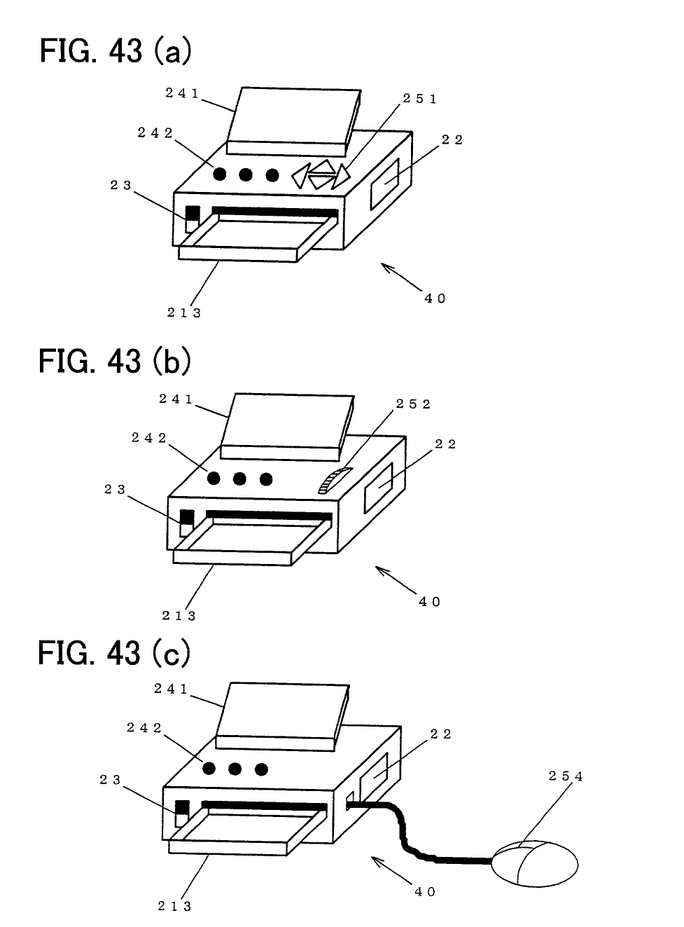

As shown in FIG. 42(c), FIG. 25(c), and FIG. 43(a) to FIG. 43(c), the second terminal 40 that is provided for a consumer includes a data recording body 161 and may additionally include a read-out section for reading data stored in the data recording body 161, an interface section for communications with the service provider 10, and display sections 24, 241 composed of, for example, a liquid crystal display.

By configuring the display sections 24, 241 from liquid crystal displays, etc. in this manner, an increased amount of data can be quickly displayed. On top of the same advantage as those of the foregoing embodiment, data can be downloaded and displayed over the Internet.

For example, the second terminal 40, if provided with a browser function, can display HTML (HyperText Markup Language) documents that are used in the WWW (World Wide Web). A possible document content is a list of products-in-circulation 6 that can be delivered to the contract signer 1. A list used in typical online shopping can be used for this purpose. For example, the contract signer 1 can specify which product(s)-in-circulation he/she wishes to be delivered by somehow selecting the product(s) from the list.

Such a second terminal 40 is also beneficial to the service provider 10, who can provide those HTML documents that are written for users accessing from personal computers to contract signers 1 without modifying the documents and does not have to prepare files separately. The browser function may be a unique variation of a typical browser used on a personal computer (PC) with some existent features removed or tweaked and new, unique features added; the elimination of useless features reduce software workload and leads to more compact hardware, and the addition of unique features increase convenience.

The second terminal 40 is intended to be an data terminal that the user can use without deep knowledge about an operating system. The second terminal 40 starts up quickly, requires no special knowledge or training to use, comes with limited functions, but in a small size, consumes little power, and provides much more advantages to the user, in comparison with typical personal computers.

A push button 251 as shown in FIG. 43(a) and/or a dial button 252 as shown in FIG. 43(b) may be provided as a selection section to scroll and switch pages (both forward and backward) and send a command (click) in browsing. Alternatively, a pointing device of an electrostatic capacitance type may be provided in advance. A further alternative is to provide a connector for a mouse and other input devices 254 as shown in FIG. 43(c).

Further, a keyboard or a connector for an external keyboard may be provided in advance to allow entering URLs (Uniform Resource Locators) and other data to connect to the Internet.

The foregoing input means serves as a selection section to select desired products-in-circulation from a list of products-in-circulation that are available for delivery.

A display of management data of a contract signer 1 can be produced too. Specifically, data, for example, monthly accounts, of the contract signer 1 is stored as a database in the second terminal 40; the contract signer 1 can obtain and display current monthly accounts by accessing the file. The contract signer 1 can thereby confirm current data in real time and does not have to have invoices or bills printed on paper, which promotes elimination of paper from office.

A product list for a next delivery may be sent via a network too. Compared to distributing catalogues, this is beneficial to the service provider 10 in that the service provider 10 can cut down on production cost and time because of elimination of paper edition of such a list and distribute latest data quickly and to the contract signer 1 in that the contract signer 1 can make a request quickly and does not have to keep the paper edition.

(Second Terminal 40, Example 5)

The present embodiment differs from the previous embodiment in that the second terminal 40 has an e-mail function, as well as, or in place of, the browser function. The data recording body 161 here is configured identically to example 2 or 4 of the data recording body 161 and have advantages as immediately below when the data formed in the data recording body 161 is such that it can be directly recognized by humans.

If, for example, only the read-out section 42 in the second terminal 40 has gone out of order, data on the contract signer 1, such as the ID number and products purchased, can be transmitted to the service provider 10 by manual operation.

(Second Terminal 40, Example 6)

The second terminal 40 of the present embodiment differs from the one of the previous embodiment in that the former is provided with a large volume hard disk and a TV tuner function. The large volume hard disk may be either a built-in type or an externally connected type. The provision enables the second terminal 40 to receive and record television broadcasting and act as a set-top box or home server.

Audio output can be provided by an audio board and/or built-in speakers. Alternatively, audio and/or speaker jacks are prepared to establish connection to an external amplifier and speakers.

If cable television is available, a single cable can be used both to receive TV broadcasting and to connect to the Internet.

(Second Terminal 40, Example 7)

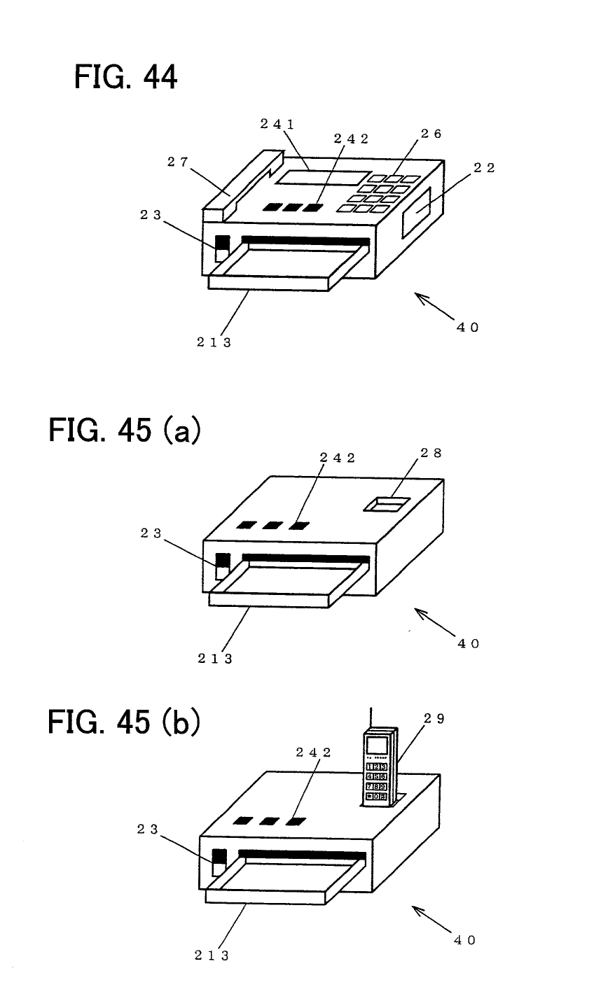

The second terminal 40 shown in FIG. 44 has a telephone function in addition to the basic configuration of FIG. 20 and comes complete with necessary telephony functions and a keyboard 26 to allow telephone number entry.

Similarly to example 5, when the data formed in the data recording body 161 is such that it can be directly recognized by humans, and for example, only the read-out section in the second terminal 40 has gone out of order, data on the contract signer 1, such as the ID number and products purchased, can be transmitted to the service provider 10 by manual operation.

It is possible to configure the second terminal 40 so that the same operation can be carried out through two or more auxiliary telephones in the same manner as through typical conventional, non-mobile phones.

(Second Terminal 40, Example 8)

The second terminal 40 shown in FIG. 45(a) and FIG. 45(b) has an interface section 28 for connection to a mobile phone (or so-called personal handy phone) 29 in addition to the basic configuration of FIG. 20. Necessary telephony functions are provided in the mobile phone 29 and can be omitted in the second terminal 40. So, the second terminal 40 basically only has to read data from the data recording body 161 and does not need display sections 241, 242.

More details are now given.

(Step 1) As the data recording body 161 is installed in the terminal 40, the controller section 43 (see FIG. 20) causes a head section, drive section, etc. to read out data from the data recording body 161, and the read-out section stands by.

(Step 2) As the second terminal 40 gets connected to a mobile phone 29 and receives from the mobile phone 29 a request signal to read out data, the controller section 43 reads out data from the data recording body 161 and causes transmission of the read-out data, as well as unique data of the terminal 40, to the mobile phone 29 to occur. The display section 242 may be used to show whether connection has been successfully made to the mobile phone 29 and to display current status or an error message for (electrically) failed connection.

(Step 3) The mobile phone 29 stores in memory the data transmitted from the second terminal 40.

(Step 4) The mobile phone 29 makes a connection to the terminal 12 over a network.

(Step 5) The mobile phone 29 transmits the data stored in the built-in memory to the terminal 12.

In step 1, if the second terminal 40 has separate built-in memory means, the data readout can be stored in the memory. When this is the case, the controller section 43 causes retransmission of the stored data to the mobile phone 29 upon the establishment of a connection between the second terminal 40 and the mobile phone 29. Further, the display section 242 can produce a display showing whether the memory means has the data stored therein.

Step 3 and step 4 may be executed in reverse order.

The data transmitted together with the data read out from the data recording body 161 is not limited to the unique data of the second terminal 40 and may be user data (contract signer ID) allocated to the contract signer 1 by the service provider 10. In this case, the second terminal 40 needs to include nonvolatile memory to store the user data, on top of the basic configuration.

The above configurations have an advantage that if it is only the telephony functions that have become outdated and obsolete because of technological development, the contract signer 1 can continue using the second terminal 40 as such by only replacing the mobile phone. Conversely, if the second terminal 40 becomes outdated first, the contract signer 1 only needs to replace the second terminal 40 and can continue using the mobile phone 29 as such.

Further, if telephony functions are arranged separately, the contract signer 1 can make the best use out of the mobility of the mobile phone 29.

(Registration of Product-in-Circulation Subject to the Service)

The following will describe how the system operates.

First, the service provider 10 creates a product-in-circulation data table [2] subject to the service as shown in FIG. 6(c) and stores the table in the memory section 124.

A feature of the product-in-circulation data table [2] is that the unique data on a product-in-circulation 6 is paired with the number of times the product-in-circulation 6 is collected. In FIG. 6(c), accounting status cells are provided also to show whether the product-in-circulation 6 is subjected to accounting.

The number of collections is now described in more detail. The service system according to the present invention allows the product-in-circulation 6 delivered to, but not bought by, the contract signer 1 to be collected after a certain period of time. This enables the service provider 10 to manage the number of times the delivered product-in-circulation 6 is collected for use in calculating the charge.

The accounting status cells show whether or not the product-in-circulation 6 is valid as a product subject to the service. Specifically, those pieces of the product-in-circulation 6 marked “COMPLETED???” are used by the contract signer 1 and therefore are invalid as a product subject to the service, and they can be excluded as described above. Those marked “N/A???” are yet to be used by the contract signer 1 and therefore valid as a product subject to the service.

Physical expiry of application software, etc. stored on optical disks and other storage media is said to be 10 years which is dictated by deterioration of the properties of aluminum used as a reflector. In the foregoing sense, the expiry date is calculated by counting the period starting at the date of manufacture. However, in view of the commercial value of the software, the lifetime is shorter: for example, the lifetime is about one year in the case of New Year card printing software.

As would be clear from the above, “expiry” refers not only to lifetime in terms of physical and/or chemical properties, but also to lifetime in terms of commercial value.

(Registration of Contract Signer Data)

A contract signer table shown in FIG. 7 is created similarly to the one in the first embodiment and stored in the memory section 124.

(Registration of Data on Delivered Products-in-Circulation)

The second terminal 40, provided to the contract signer 1, is connected and set up to communicate externally. As communications become ready, the model number, unique ID number, and other data of the second terminal 40 are sent to the terminal 12 of the service provider 10. Because of this step, the terminal 12 can automatically detect the model of the second terminal 40 of the contract signer 1 and single out that contract signer 1 using a model data table and an associated contract signer data table.

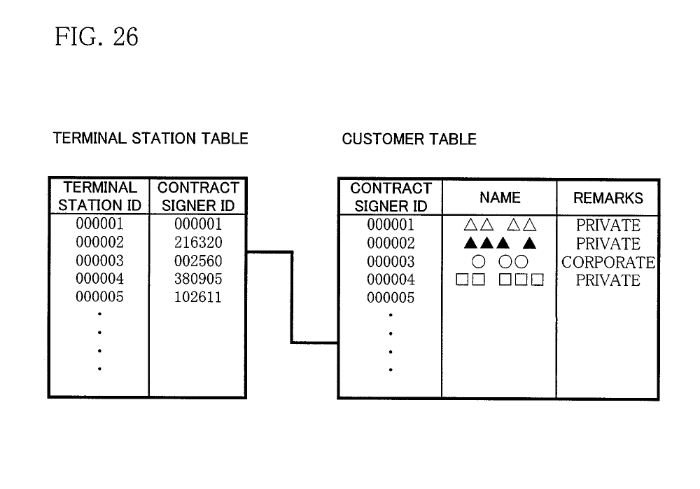

Alternatively, contract signer IDs are provided separately to all contract signers, and the contract signer 1 transmits its ID to the terminal 12 together with other data so that the terminal can identify the contract signer 1. FIG. 26 shows an example of the terminal table and the customer table managed in the terminal 12.

The terminal table, as shown in the left-hand side of the figure, is a table establishing one-to-one or one-to-many relations between terminal IDs (unique data of machines) and contract signer IDs (unique data of contract signers). The customer table, as shown in the right-hand side of the figure, is a table establishing one-to-one relations between contract signer IDs and general data of contract signers, such as names. The two tables can be combined based on contract signer IDs, a common key. For example, by searching the customer table with the contract signer ID as the key word, it can be found out that the name of the contract signer 1 who is identified by the terminal ID “000001” is “Mr. S. Smith.”

As shown in FIG. 27, a management table is prepared for each contract signer 1 in the terminal 12 of the service provider 10. At this stage, as shown in FIG. 27, no data has been entered in the terminal 12 of the service provider 10.

Subsequently, the service provider 10 collects data on all the products delivered in advance to the contract signer 1 and stores the data in the terminal 12 of the service provider 10 immediately or later.

The data collecting method was already described and detailed description is omitted here.

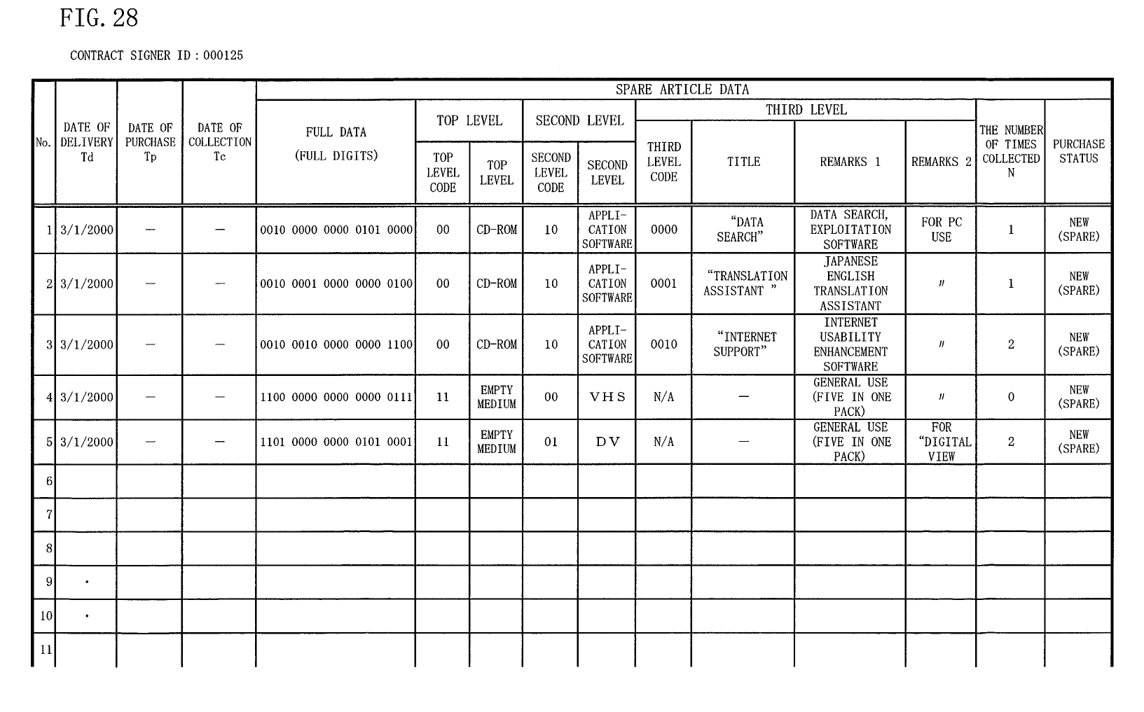

The terminal 12 of the service provider 10 enters to the management table the data of products 65 delivered to the contract signer 1 in reference to the incoming data as shown in FIG. 28. In FIG. 28, product types and other data are displayed in codes, and also supplementarily in actual product names, etc., for a better user interface. At this stage, the purchase status cells all show “N/A (SPARE).”

This concludes an initial setup and registration.

(Purchase Detection)

Now, the following will describe operations when a product is purchased.

The contract signer 1 breaks the packing of the product 65 that he/she has decided to buy and installs the data recording body 161 into the second terminal 40. The data recording body 161 cannot be detached from the product 65 without breaking the packing. The present embodiment has a feature that the data recording body 161, storing unique data to specify the product 65, is packed separately from the product 65, but in the same packing or wrapping material. Put differently, the data recording body 161 is placed inside the same the packing or wrapping material as the product 65 to confirm the breaking of the packing, as well as to specify the product 65.

The packing or wrapping material is a different thing from the packing or wrapping material for the product 65, and breaking the former packing or wrapping material does not cost the product 65 its commercial value. Alternatively, the data recording body 161 may be placed inside the same packing or wrapping material as the product 65, in which case the product 65 is regarded as used and having no more commercial value to anyone except the contract signer 1 who has broken the packing once the packing or wrapping material is broken.

The second terminal 40, which is already connected and set up to be ready for external communications, reads product the unique data, of the product 65, formed in the installed data recording body 161 and executes normal procedures required for transmission, before transmitting the unique data of the product to the terminal 12 of the service provider 10.

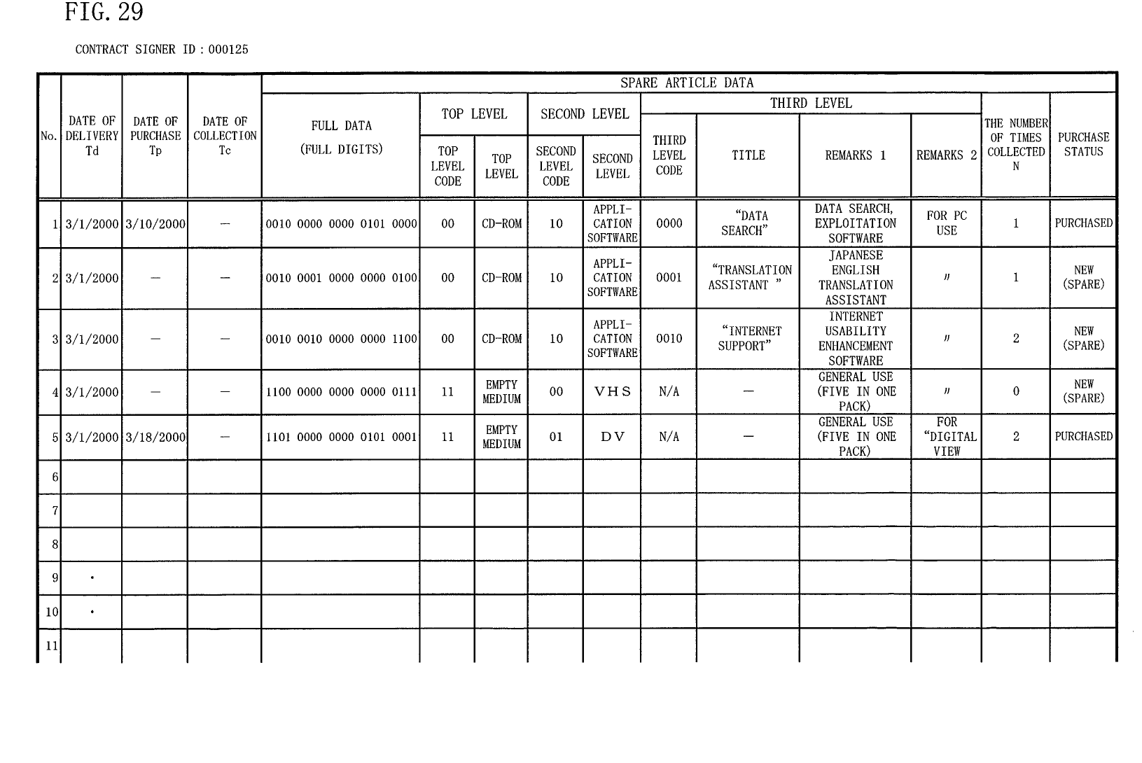

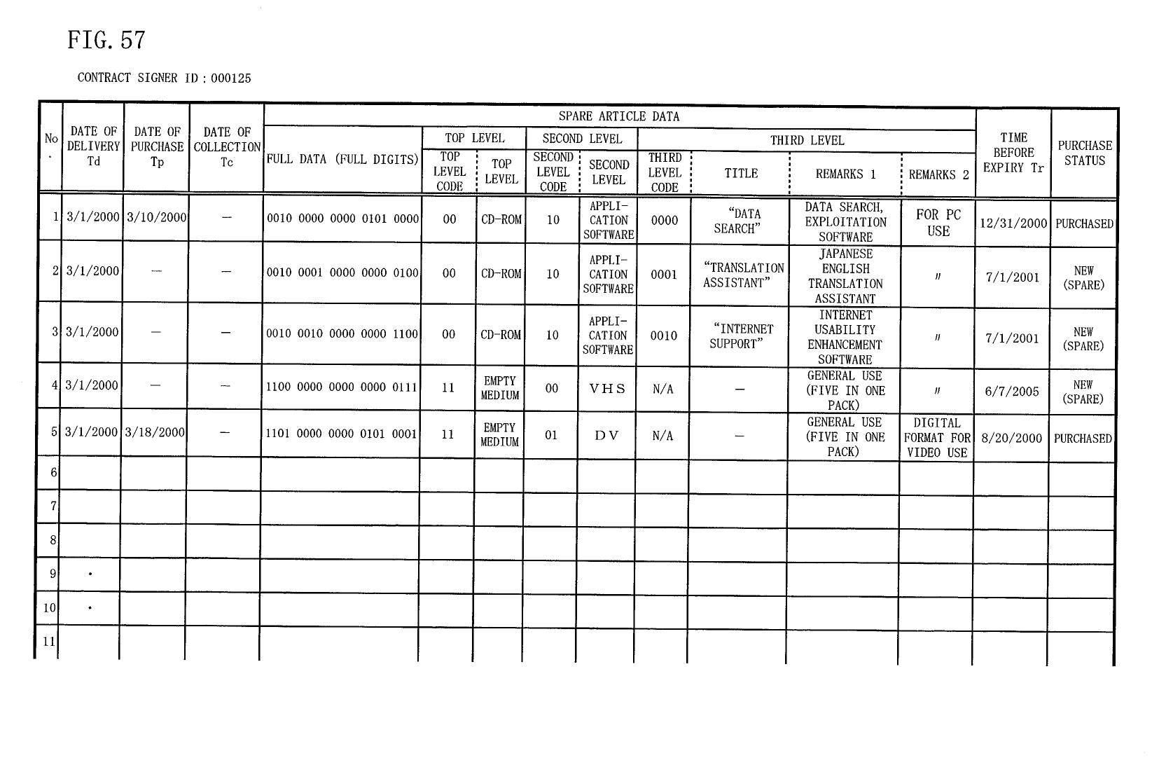

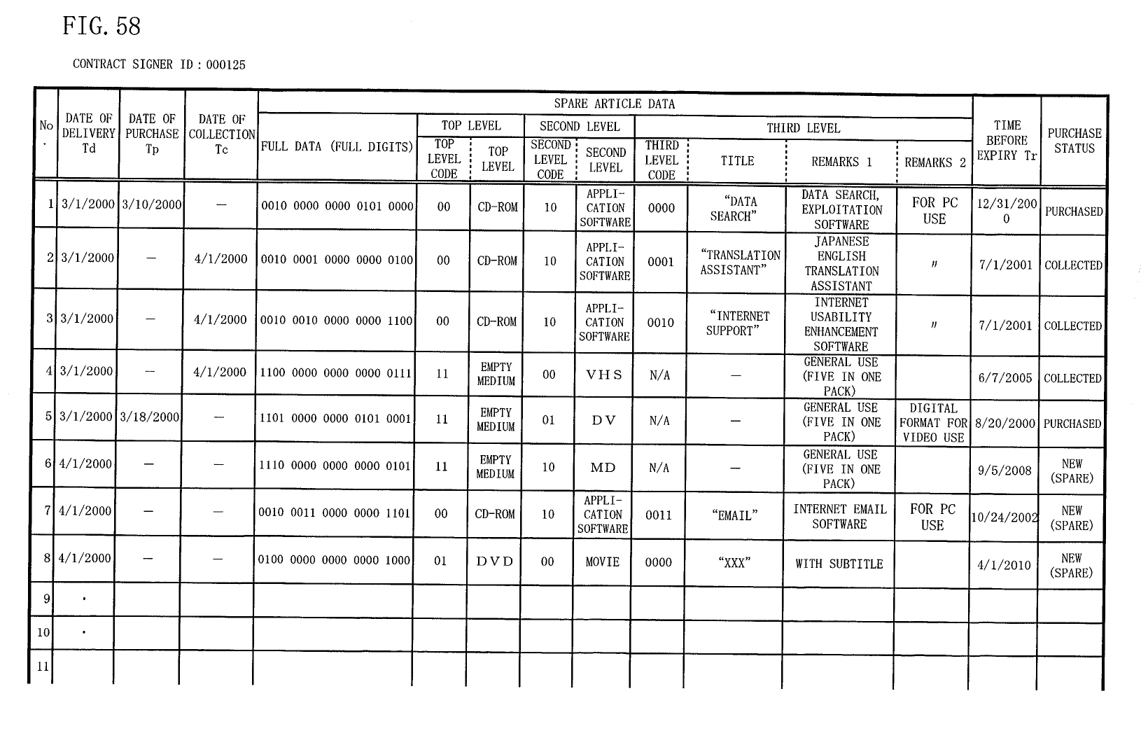

In the terminal 12 of the service provider 10, the arithmetic processing section 122 identifies the contract signer 1 and the product 65 based on the incoming data, and as shown in FIG. 29 or FIG. 3, and FIG. 57 and FIG. 58 detects the opening (i.e., purchase) of the product 65 by the contract signer 1 to update the data appearing in the corresponding purchase status cells in the management table from “NEW (SPARE)” to “PURCHASED.”

The contract signer 1, who has a contract with the service provider 10, purchases what he/she needs from the delivered products 65. The purchase is confirmed by opening the product 65 the contract signer 1 has decided to purchase, reading the data of the data recording body 161, which is available only after breaking the packing, with the second terminal 40, and registering the data in the terminal 12 of the service provider 10 over a network, i.e., storing in the management table.

(Accounting)

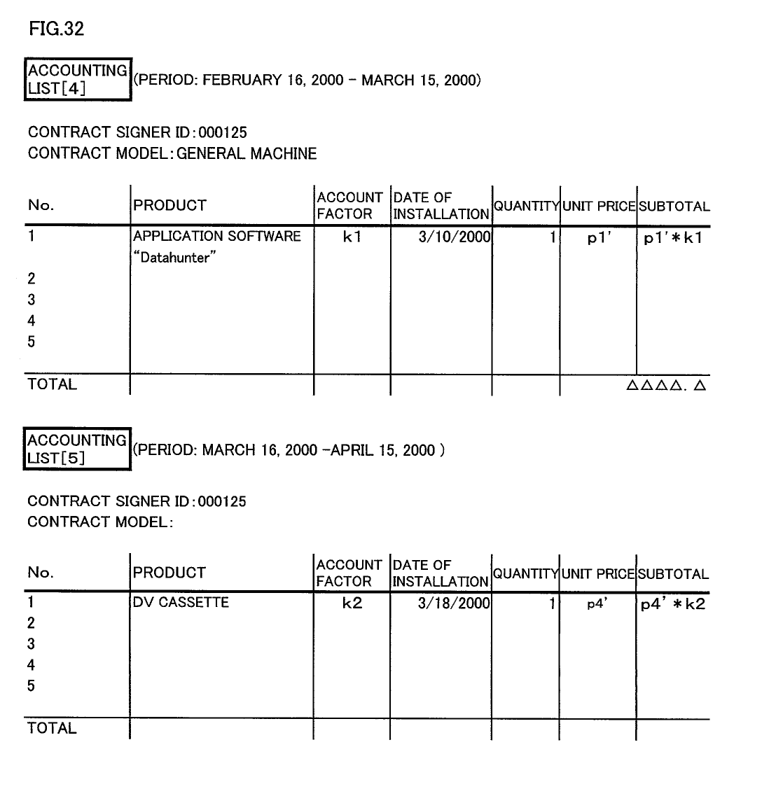

The following describes an accounting method. FIG. 32 shows lists of consumables to be subjected to accounting. Each period of accounting is, for example, one month. The lists of consumables are created, for example, based on the management table by clipping data on those products which were used during a one-month period before the closing date of accounting (15th day of the month in the present embodiment). Here, the products which are clipped are those which are indicated by “PURCHASED” in the cells under “PURCHASE STATUS” in the management table and which have dates of installation within the one-month period before the closing date of accounting.

In this manner, the products 65 subject to accounting are identified. Procedures to calculate the charge was already described in the first embodiment.

FIG. 32 is a list for the past three months.

Basic account table [2] shown in FIG. 16(b) may used in place of basic account table [1] shown in FIG. 16(a) for use in calculating charges in the first embodiment. Basic account table [2] stipulates a basic charge p′ for each product 65.

As would be clear from the foregoing, the present invention has a feature that the contract signer 1 is charged only for those products 65 that are actually purchased for use, not for those that are not yet used; on top of that, the charge differs depending on how many times the product 65 has been collected or on the remaining lifetime of the product 65 as counted from the date of delivery or the date of commencement of use of the product 65.

Thus, the contract signer 1 can use the products 65 immediately when they are necessary, reduce advance payment and unnecessary inventory and use the product 65, no matter when the contract signer needs it, without running out of consumables or going through bothersome management. Further, discounts on repeatedly collected products 65 or those with only a short lifetime left ease apprehension of the contract signer 1 regarding the use of those products and encourage the contract signer 1 for more purchase.

(Sales System: Collection of Unused Products and Delivery of New Products)

The following will describe a system to collect unused products and deliver new products.

The service provider 10 collects unpurchased products 65 among those delivered in the previous month and delivers new products of this month once per month, on a fixed date and time, in accordance with the period of accounting.

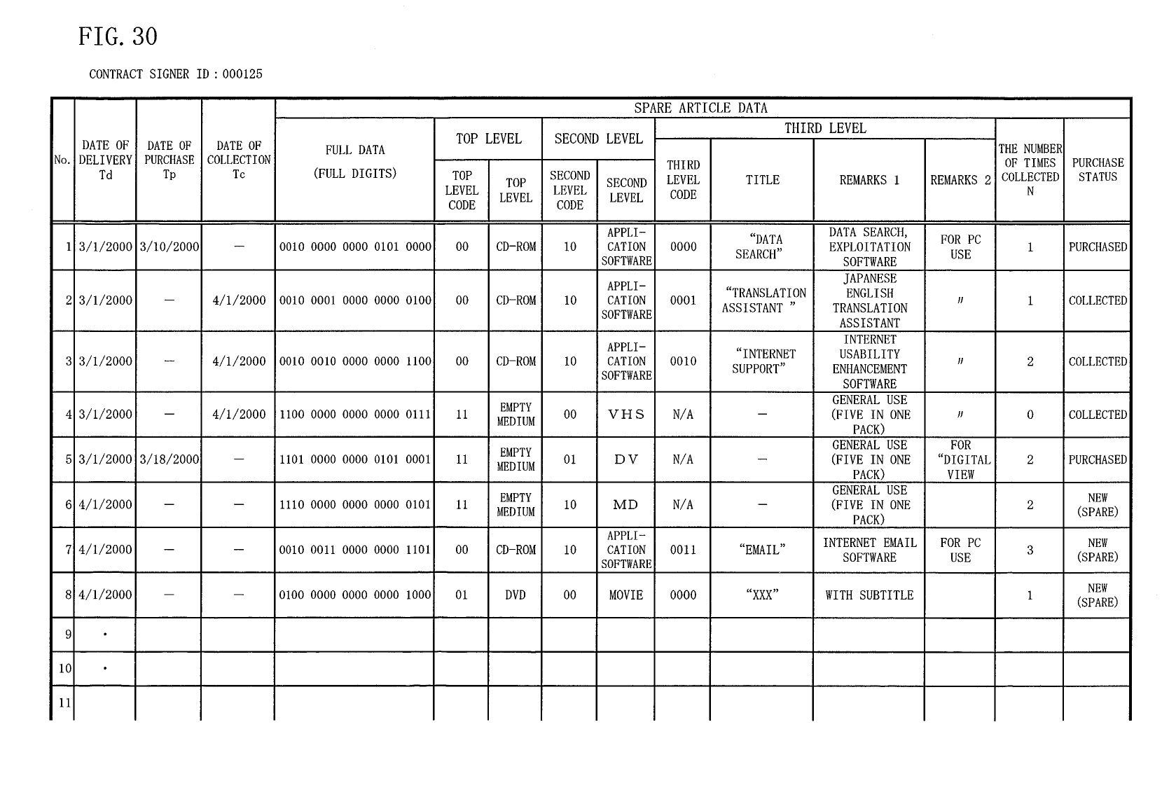

FIG. 30 and FIG. 58 show cases in which every 1st day of the month is designated a collection and delivery day. Among the products 65 delivered in the previous month, i.e., March 1, those that were not purchased by the contract signer 1 are specified. The specification is performed by the arithmetic processing section 122 searching the management tables of FIG. 30 and FIG. 58 for those products 65 that meet both condition 1 that the data stored in the purchase status cell be “NEW (SPARE)” and condition 2 that the date of delivery fall in a collection period.

However, if every 1st day of the month is designated a collection day, condition 2 is unnecessary. Alternatively, the service provider 10 can specify products 65 to be collected in the on-screen management tables of FIG. 30 and FIG. 58 displayed by the output section 125 using a pointing device, etc.

By the foregoing process to specify the products 65 to be collected, Nos. 2, 3, 4 are specified, for example. Either the arithmetic processing section 122 or the service provider 10 instructs the dispatch section of products 65 to collect the product 65, Nos. 2, 3, 4. Thus, the product 65, Nos. 2, 3, 4 are collected on April 1. As collect data is entered in the terminal 12 of the service provider 10, as shown in the figures, the dates of collection appears in date-of-collection cells, and the purchase status changes to “COLLECTED.”

Together with the collection of unpurchased products, new products, No. 6, 7, 8 for April are delivered to the contract signer 1. Setup and registration upon delivery are done as in the foregoing, and description is omitted here. As data upon new delivery is entered to the terminal 12 of the service provider 10, as shown in the figures, the dates of delivery appears in date-of-delivery cells, and the purchase status changes to “N/A (SPARE).”

The service provider 10 may select new products by making a prediction or suggestion based on the purchase history of the contract signer 1 and also in view of additional data, such as family members. As already described in the foregoing, the contract signer 1 may select product 65 to his/her likings from a pre-distributed list of all the products that can be delivered and inform the service provider 10. The product list may be stored in the magneto-optical disk shown in example 1 of the data recording body 161, distributed as a catalogue, or posted so that it is accessible over the Internet. By these methods, the service provider 10 can provide products 65 that suit the needs of the contract signer 1.

If unpurchased products from the previous month are collected on the same day as the delivery of new products for this month, the collection and delivery jobs are done simultaneously and therefore preferable.

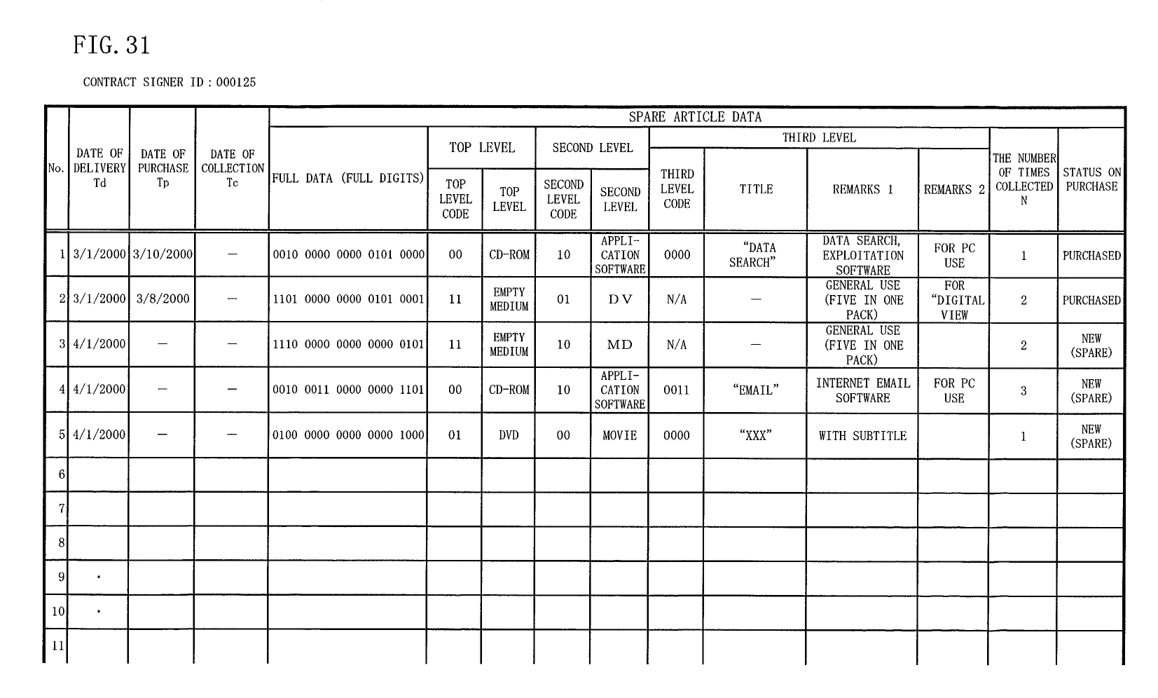

FIG. 30 and FIG. 58 show examples in which data on collected products 65 is retained. In contrast, FIG. 31 shows an example in which either data on products 65 whose collection date and time is entered and collection is checked and confirmed is either displayed or erased from the management table.

(Collection of Unused Products: Example 1)

The sales system of the present invention involves two kinds of services: delivery of new products 65 and collection of unpurchased products 65.

In view of current logistics systems, these services are offered through express mail and parcel services. Further, visiting a bunch of contract signers 1 and doing both delivering and collecting products 65 at the same time improves efficiency.

In such a case, if the products collected from and newly delivered to a contract signer 1 and those collected from and newly delivered to another contract signer 1 are mixed chaotically, the delivery and collection is a time-consuming process. Further, if products 65 differ from one contract signer 1 to the other, the number of products that the service provider 10 must handle grow tremendously, and precise management of products 65 will go beyond abilities of servicemen actually doing the delivery and collection.

If only one container is used for each contract signer 1, and products for delivery and collection are mixed, they cannot be discriminated from one another quickly or doing so is time-consuming. For example, when both the delivery products and the collection products are optical disks, comparing titles and other data to the contents registered in the terminal 12 of the service provider would ensure correct delivery and collection. However, such an environment is difficult to create, and the comparison is time-consuming. Before the registration process, each product is either collected or delivered depending on the presence of the second data recording body 7. Once the registration process is over, servicemen cannot precisely distinguish between collected products and delivered products.

To solve these problems, the present invention has a feature that two dedicated containers are prepared for each contract signer 1, one for delivery and the other for collection. Thus, unexpected mixture of collected products and newly delivered products is avoided.

Based on advance requests, etc. from contract signers 1, the service provider 10 puts the products 65 in individual new delivery containers of the contract signers 1 at a product distribution base. At the place of the contract signer 1, the service person delivers the whole new delivery container to the contract signer 1.

The contract signer 1 puts in advance unpurchased products 65 in the container delivered last time (or last month if a collection is scheduled every month). Then, the contract signer 1 receives a new delivery container from the service person and gives back the container containing unpurchased products 65 to the service person on a new delivery and collection day.

To ensure accuracy, data including at least the date of delivery, and optionally the scheduled date of collection, should be formed in each container. This data enables it to distinguish between delivery containers and collection containers at the date and time of this new delivery and collection.

Alternatively, containers' colors and delivery months may be associated. For example, if a collection is scheduled every month, those containers that are delivered in even-numbered months are assigned the blue, and those containers that are delivered in odd-numbered months are assigned the gray. The coloring enables instantaneous recognition.

(Collection of Unused Products: Example 2)

The present embodiment is closely related to the previous embodiment and provides structures of delivery vehicle carrying the containers and methods of loading the containers in the delivery vehicle.

The delivery vehicle has a cargo compartment divided or separated into two parts, one for new delivery containers and the other for collection containers.

The structure further improves on the delivery of new products and collection of old products both in efficiency and accuracy.

As described above, the service management method of the present invention may include the step of giving an instruction (by the arithmetic processing section of the terminal section) to collect an unused product-in-circulation, of all products-in-circulation delivered to a service receiver after a prescribed duration.

According to the arrangement, since it is possible to exclude a situation where a delivered product-in-circulation is not used for an extended period of time and merely stocked without being purchased on the side of the service receiver. Further, it is possible to deliver the collected product-in-circulation to another service receiver. That is, a product-in-circulation which has not been used within a prescribed duration is recognized as a product-in-circulation which is not to be purchased by a service receiver who has received the product-in-circulation. Then, the product-in-circulation is provided to another service receiver, so that it is possible to increase chances to purchase or sell the product-in-circulation.

Note that, collection date may be based on delivery date, for example, it may be one month from the delivery date. Alternatively, it may be set to be an end of each month.

In a case where a product-in-circulation can be recycled, the product-in-circulation may be collected on the foregoing collection date even though the product-in-circulation has been used.

Note that, collection date may be set so that a period-before-expiring of the product-in-circulation is shorter than the predetermined period-before-expiring, in accordance with the expiring date data corresponding to unique data of each product-in-circulation. In this case, the arithmetic processing section of the terminal managed by the service provider is programmed so that it accesses the management data regularly so as to monitor the unused-state and the period-before-expiring of each product-in-circulation.

Further, the service management apparatus of the present invention may be arranged as follows. The service management apparatus includes: an account factor memory section for registering an account factor table related to period-before-expiring data of a product-in-circulation; and a basic account memory section for registering a basic account table of the product-in-circulation related to unique data of the product-in-circulation, wherein the arithmetic processing section calculates a period-before-expiring of the product-in-circulation by using the expiring date data of the product-in-circulation detected being used, and refers to the account factor table by using the period-before-expiring so as to obtain account factor, and refers to the basic account table by using the unique data of the product-in-circulation detected being used so as to obtain a basic account, and calculates an account of the product-in-circulation by multiplying the obtained account factor and the obtained basic account.

According to the arrangement, a period-before-expiring which remains at a time when a product-in-circulation is delivered, or a period-before-expiring which remains at a time when use of the product is detected is calculated, in accordance with the expiring date data, and an account is calculated according to the foregoing calculation. Thus, even when the same products-in-circulation are provided and their consumption periods are the same, it is possible to vary an account in accordance with a period-before-expiring calculated at a time when a product-in-circulation is delivered to or used by a service receiver.

Note that, the service receiver can arbitrarily select whether calculation of the period-before-expiring is based on a time when the product-in-circulation is delivered or based on a time when the service receiver begins to use the product-in-circulation. By calculating in accordance with the latter, it is possible to provide more delicate service according to how the service receiver uses the product-in-circulation. Besides, it is possible to solve, more effectively, such a problem that a product-in-circulation whose period-before-expiring is short is hard to be purchased.

Thus, as described above, it is possible to provide the service management apparatus which realizes extremely rational accounting method, whereby an account, corresponding to the performance of a product-in-circulation, which varies according to a period-before-expiring is charged to a service receiver after the service receiver actually uses the product-in-circulation.

Further, if the arithmetic processing section calculates a price of a product-in-circulation used by the service receiver within a prescribed duration, it is possible to perform a regular accounting process automatically besides the foregoing effect.

Further, the service management method of the present invention may be realized by a service management program executed by a computer.

According to the arrangement, it is possible to provide the service management method of the present invention to the service receiver by loading the service management program to the service management apparatus. Further, it is possible to execute the service management method by using a typical computer.

Further, it is needless to say that a computer-readable recording medium which records the service management program for making a computer execute the service management method of the present invention belongs to the scope of the present invention.

A product-in-circulation used in the service management method of the present invention is as follows.

The product-in-circulation is managed by the service management method of the present invention, so that it is possible for the service provider to obtain such an advantage that the status on use can be grasped precisely. And it is possible for the service receiver to obtain such an advantage that only the products used actually are charged and spares are not charged.

If the arrangement is characterized in that unique data of the product-in-circulation is formed in advance, the service provider can confirm “which product-in-circulation has been delivered in advance, and which service receiver has received the delivery in advance” upon delivering a product-in-circulation.

Upon detecting electrically data on how the service receiver uses the product-in-circulation, it is possible to determine whether it is a case where the same product-in-circulation is used or a case where a newly replaced product-in-circulation is used. If the detected data of the product-in-circulation is new, notice of the foregoing case can be regarded as purchase of the product-in-circulation.

Note that, unique data formed with respect to a product-in-circulation may be made code data which does not make sense per se, and the code data of the product-in-circulation may be translated into an article name by referring to a product table prepared on the side of the service provider.

In this case, the unique data of the product-in-circulation of the present invention is not risky data for both the service provider and service receiver even if the unique data leaks out to the third party and is decoded, so that it is not required to perform a high level process such as encipherment and decoding. Therefore, compared with a case where data is read out while paying attention to security, it is possible to make a hard wear and a soft wear smaller. Further, it is possible to shorten the processing time since it is not required to decode, so that data can be read out at high speed.

If the service provider registers product-in-circulation data and service receiver data with them associated with each other, it is possible to specify a contract signer only by obtaining unique data of a product-in-circulation. That is, compared with the case where not only unique data of a product-in-circulation but also service receiver data with respect to a user of the product-in-circulation is obtained, it is possible to reduce the amount of data that is to be transmitted. In a case where a network is used, it is possible to alleviate communications load.

When the arrangement is used in the service management method of the present invention, even though the third party manufactures and sells a duplicate of the product-in-circulation and its unique data, the duplicate product is not serviced as long as the service provider does not deal in the product. Thus, it is possible to exclude pirated versions.

Further, when a first data recording body in which unique data of the product-in-circulation is formed is attached to a product-in-circulation, it is not required to form the unique data directly with respect to the product-in-circulation. Thus, it is not required to change a manufacturing process of the product-in-circulation entirely. The first data recording body in which the unique data is formed is created additionally, and the first data recording body is attached to the product-in-circulation. By adding such a simple step, it is possible to treat the product-in-circulation as a serviced object of the present invention.

Further, when plural products are packed in a single package and the first data recording body in which unique data of the product-in-circulation is formed is attached to the packed product-in-circulation, it is possible to obtain the following advantage. Not only a single product-in-circulation but also a new product, created by combining plural products-in-circulation or combining the single product-in-circulation with other kinds of products-in-circulation, can be treated as a serviced object. A description thereof is given by taking an automobile as an example. When four or sometimes two tires (front and rear) are regarded as a minimum unit, or 5 or 3 tires are regarded as a minimum unit in a case where a temporary tire is the same as a regular tire, plural tires can be treated as a single serviced object of the present invention. Further, a new set of products may be created by combining different products-in-circulation such as shampoo and rinse.

Further, makers of products-in-circulation sometimes cannot create effective combination of products-in-circulation, or cannot sell combined products immediately. Even in this case, it is possible to obtain such an advantage that a service provider can react to market trend sensitively so as to combine products-in-circulation and to sell the combined products immediately.

When a product is packed with a packing member, and the first data recording body in which unique data is formed is allocated in the packing member, and a portion which corresponds to an allocating position of the first data recording body in the packing material is transparent, it is possible to obtain the following advantage. Since the allocating position of the first data recording body in the packing member corresponds to the transparent portion of the packing member, it is possible to recognize the content of the packed product, that is, it is possible to recognize data such as kinds and types of the product visually or optically without opening the product. Thus, it is possible to confirm the product easily. Note that, if the first data recording body is allocated so that a data surface of the first data recording body is positioned within a range of the transparent portion, data formed in the first recording body can be detected visually or optically. Thus, it is possible to omit a second data recording body (described later) for obtaining data of the delivered product. In other wards, arrangement of the packing member particularly concerns a fact that the data formed in the first data recording body is not secret.

Further, when a protecting member to pack or wrap the product-in-circulation is used, and the second data recording body in which the same data as the unique data of the product-in-circulation is formed is provided on or in the protecting member, a service person can obtain data of the product-in-circulation from the second data recording body attached to a surface of the product-in-circulation such as the packing member upon delivery of the product-in-circulation. Thus, it is not required to open the packing member etc. and take out the product-in-circulation so as to obtain unique data formed in the product-in-circulation. As a result, value as a product is not lost since it is not required to open the product.

Further, it is possible to obtain data formed in the second data recording body by reading the data with a scanner. For example, if unique data is formed in bar code, it is possible to read the data easily and quickly. Thus, it is possible to perform delivery check and similar operation upon delivery more quickly.

In a case where the second data recording body is attached to a surface of a product-in-circulation, it is easier to read data. Thus, it is possible to quicken the foregoing operations.

In a case where the second data recording body is attached to the inside of a product-in-circulation, it is necessary to be careful not to lose value as a product by opening the product. But, compared with a process of attaching the second data recording body to the surface of the product-in-circulation, the second data recording body does not receive damages. Thus, it is possible to avoid a situation where data cannot be read out since the second data recording body is lost or damaged.

Note that, if the second data recording body can be detached from a product-in-circulation, it is possible to determine whether the product-in-circulation has delivered or not by confirming whether the second data recording body is attached or not. Further, since it is possible to bring the second data recording body back to the service station, it is possible to avoid a situation where advance registration cannot be performed in a case where a scanner is out of order. It is possible to bring the second data recording body back to the service station so as to read out the data and perform the advance registration.

Further, when the second data recording body can be detached from a product-in-circulation, it is possible to determine easily whether the product-in-circulation has been delivered or not by confirming whether the second data recording body has been attached or not. It is possible to bring the second data recording body back to the service station, and it is possible for the service provider to bring it back o the service station so as to register the delivered product-in-circulation after the delivery. Thus, compared with a case where unique data of a delivered product-in-circulation is registered upon delivery, it is possible to confirm a delivered product with more reliability. Further, more reliability can be obtained by combining both the processes.

If the second data recording body is attached to a product-in-circulation with adhesive etc. by which attachment can be performed repeatedly, it is possible to attach the second data recording body to the product-in-circulation again without spoiling appearance of the product-in-circulation even in a case where the second data recording body has been detached upon delivery. Such a situation occurs in the following case. Although a product-in-circulation has been delivered to a service receiver, the service receiver takes an advantage of the service of the present invention to the maximum, so that the service receiver does not purchase the product-in-circulation. In this case, the unused product-in-circulation is collected and is delivered to another service receiver.

When an IC chip is included, and unique data of the product-in-circulation is stored in the IC chip, it is possible to use the IC chip whose attachment has been considered for the sake of excluding pirated versions, and cost up is not required in terms of a hard wear, and unique data of a product-in-circulation required in the present invention can be stored.

Further, a product-in-circulation may be a cartridge which stores toner. An electrophotographic image forming apparatus is designed so that replacement of degradables such as the toner cartridge is possible. A market for the degradables is larger than a market for the image forming apparatus itself as an after market, so that manufacturing and sales of pirated versions increase. If the service management method of the present invention is used in such a situation, it is possible to provide genuine products-in-circulation while excluding the pirated versions. That is, since a service provider guarantees and manages all the processes of manufacturing, circulation, and sales with respect to the product-in-circulation, there is no room where the pirated versions exist. Further, since the service provider registers a product-in-circulation upon delivery of the product-in-circulation, it is possible to treat only the product-in-circulation, admitted by the service provider, as a serviced object.

Further, if the present invention is characterized in that a product-in-circulation is a cartridge which stores ink, an effect as in the foregoing is brought about with respect to an ink cartridge of an inkjet printer.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A service management method which makes a computer execute the steps of:
registering unique data to specify each product-in-circulation delivered to a service receiver and expiring date data of the product-in-circulation in a terminal;
detecting use of the product-in-circulation used by a service receiver via a network;
recognizing the use as a purchase action;
calculating an account of a product-in-circulation recognized as the purchase action, out of products-in-circulation delivered to the service receiver, in accordance with the expiring date data of the product-in-circulation.

2. The service management method as set forth in claim 1, further comprising the step of outputting an instruction to collect an unused product-in-circulation of all products-in-circulation delivered to the service receiver, after a prescribed duration.

3. A service management method which makes a computer execute the steps of:
accessing management data which records, as required, (a) unique data to specify each product-in-circulation delivered to a service receiver, (b) expiring date data of the product-in-circulation, and (c) status on use of the product-in-circulation used by the service receiver, so as to specify a product-in-circulation recognized to be purchased by the service receiver, and so as to read out the expiring date data of the product-in-circulation that has been specified;
calculating a period-before-expiring of the product-in-circulation that has been specified, in accordance with the expiring date data that has been read out; and
calculating an account of the specified product-in-circulation, the account being varied according to the calculated period-before-expiring.

4. The service management method as set forth in claim 3, further comprising the step of outputting an instruction to collect an unused product-in-circulation, of all products-in-circulation delivered to the service receiver, after a prescribed duration.

5. A service management method, in which a computer causes a product-in-circulation for use in operating a machine to be provided, making a computer execute the steps of:
causing a terminal managed by a service provider to register unique data of a product-in-circulation delivered to a service receiver and expiring date data of the product-in-circulation in the terminal;
causing a machine provided on a side of the service receiver to read out the unique data of the product-in-circulation installed in the machine;
transmitting data which contains at least the unique data, that has been read out, to the service provider;
causing the terminal managed by the service receiver to detect the data via a network;
recognizing installation of the product-in-circulation in the machine as a purchase action, in accordance with the unique data that has been detected; and
calculating an account of a product-in-circulation recognized as the purchase action, of all products-in-circulation, in accordance with the expiring date data of the product-in-circulation.

6. The service management method as set forth in claim 5, further comprising the step of outputting an instruction to collect an unused product-in-circulation, of all products-in-circulation delivered to the service receiver, after a prescribed duration.

7. A service management apparatus comprising: a product-in-circulation data memory section for registering data to specify a product-in-circulation delivered to a service receiver and expiring date data of the product-in-circulation in pairs; an input section for inputting status on use of the product-in-circulation; and an arithmetic processing section for calculating an account of a product-in-circulation that has been used, of all products-in-circulation, in accordance with the expiring date data of the product-in-circulation.

8. A service management apparatus comprising: a product-in-circulation data memory section for registering unique data to specify each product-in-circulation delivered to a service receiver and expiring date data of the product-in-circulation in pairs; a communications section for detecting use of the product-in-circulation via a network; and an arithmetic processing section for calculating an account of a product-in-circulation detected being used, of all products-in-circulation delivered to the service receiver, in accordance with the expiring date data of the product-in-circulation.

9. The service management apparatus as set forth in claim 8, further comprising:
an account factor memory section for registering an account factor table related to period-before-expiring data of the product-in-circulation; and
a basic account memory section for registering a basic account table of the product-in-circulation related to the unique data of the product-in-circulation, wherein
the arithmetic processing section (a) calculates a period-before-expiring of the product-in-circulation that has been detected being used in accordance with the expiring date data of the product-in-circulation, and (b) obtains an account factor by reference to the account factor table in terms of the period-before-expiring, and (c) obtains a basic account by reference to the basic account table in terms of the unique data of the product-in-circulation that has been detected being used, and (d) calculates an account of the product-in-circulation by multiplying the account factor and the basic account that have been obtained.

10. A service management network system comprising: a first group and a second group, wherein:
the first group is a machine on which a product-in-circulation, having unique data, which is consumed or degraded, is installed so as to be detachable, and the machine includes: (a) a read-out section for detecting unique data of the product-in-circulation from the product-in-circulation; (b) a transmitter section for externally transmitting the unique data that has been read out via a network; and (c) a controller section for controlling the read-out section and the transmitter section, and
the second group is a service management apparatus including: (a) a communications section for performing communications with the first group; (b) a product-in-circulation data memory section for registering the unique data of the product-in-circulation and expiring date data of the product-in-circulation generated in the first group; and (c) an arithmetic processing section for confirming status on use of the product-in-circulation so as to calculate an account of a used product-in-circulation, of all products-in-circulation delivered to a service receiver, in accordance with the expiring date data of the product-in-circulation.

11. A service management network system comprising: a first group and a second group, wherein:
the first group is a machine including: (a) a read-out section for detecting unique data of a product-in-circulation from the product-in-circulation having the unique data; (b) a transmitter/receiver section for externally transmitting the unique data that has been read out via a network; and (c) a controller section for controlling the read-out section and the transmitter/receiver section, and
the second group is a service management apparatus including: (a) a communications section for performing communications with the first group; (b) a product-in-circulation data memory section for registering the unique data of the product-in-circulation and expiring date data of the product-in-circulation generated in the first group; and (c) an arithmetic processing section for confirming status on use of the product-in-circulation so as to calculate an account of a used product-in-circulation, of all products-in-circulation delivered to a service receiver, in accordance with the expiring date data of the product-in-circulation.

12. A service management program making a computer execute a service management method which includes the steps of:
registering unique data to specify each product-in-circulation delivered to a service receiver and expiring date data of the product-in-circulation in a terminal;
detecting use of the product-in-circulation used by a service receiver via a network;
recognizing the use as a purchase action;
calculating an account of a product-in-circulation recognized as the purchase action, of all products-in-circulation, in accordance with the expiring date data of the product-in-circulation.

13. A service management program making a computer execute a service management method which includes the steps of:
accessing management data which records, as required, (a) unique data to specify each product-in-circulation delivered to a service receiver, (b) expiring date data of the product-in-circulation, and (c) status on use of the product-in-circulation used by the service receiver, so as to specify a product-in-circulation recognized to be purchased by the service receiver, and so as to read out the expiring date data of the product-in-circulation that has been specified;
calculating a period-before-expiring of the product-in-circulation that has been specified, in accordance with the expiring date data that has been read out; and
calculating an account of the specified product-in-circulation, the account being varied according to the calculated period-before-expiring.

14. A service management program, whereby a product-in-circulation for use in operating a machine is provided, making a computer execute a service management method which includes the steps of:
causing a terminal managed by a service provider to register unique data of a product-in-circulation delivered to a service receiver and expiring date data of the product-in-circulation in the terminal;
causing a machine provided on a side of the service receiver to read out the unique data of the product-in-circulation installed in the machine;
transmitting data which contains at least the unique data, that has been read out, to the service provider;
causing the terminal managed by the service receiver to detect the data via a network;
recognizing installation of the product-in-circulation in the machine as a purchase action in accordance with the unique data that has been detected; and
calculating an account of a product-in-circulation recognized as the purchase action, of all products-in-circulation, in accordance with the expiring date data of the product-in-circulation.

15. A computer program product recording a service management program which makes a computer execute a service management method which has the steps of:
registering unique data to specify each product-in-circulation delivered to a service receiver and expiring date data of the product-in-circulation in a terminal;
detecting use of the product-in-circulation used by a service receiver via a network;
recognizing the use as a purchase action;
calculating an account of a product-in-circulation recognized as the purchase action, of all products-in-circulation, in accordance with the expiring date data of the product-in-circulation.

16. A computer program product recording a service management program which makes a computer execute a service management method which has the steps of:
accessing management data which records, as required, (a) unique data to specify each product-in-circulation delivered to a service receiver, (b) expiring date data of the product-in-circulation, and (c) status on use of the product-in-circulation used by the service receiver, so as to specify a product-in-circulation recognized to be purchased by the service receiver, and so as to read out the expiring date data of the product-in-circulation that has been specified;
calculating a period-before-expiring of the product-in-circulation that has been specified, in accordance with the expiring date data that has been read out; and
calculating an account of the specified product-in-circulation, the account being varied according to the calculated period-before-expiring.

17. A computer program product recording a service management program which makes a computer execute a service management method which has the steps of:
causing a terminal managed by a service provider to register unique data of a product-in-circulation delivered to a service receiver and expiring date data of the product-in-circulation in the terminal;
causing a machine provided on a side of the service receiver to read out the unique data of the product-in-circulation installed in the machine;
transmitting data which contains at least the unique data, that has been read out, to the service provider;
causing the terminal managed by the service receiver to detect the data via a network;
recognizing installation of the product-in-circulation in the machine as a purchase action in accordance with the unique data that has been detected; and
calculating an account of a product-in-circulation recognized as the purchase action, of all products-in-circulation, in accordance with the expiring date data of the product-in-circulation.

18. A service management method making a computer program execute the steps of:
registering unique data of a product-in-circulation delivered to a service receiver and number of times collected data of the product-in-circulation in a memory section that is capable of being accessed by a computer;
detecting use of the product-in-circulation used by the service receiver via a network;
recognizing the use that has been detected as a purchase action; and
calculating an account of a product-in-circulation recognized as the purchase action, of all products-in-circulation, by considering the number of times collected data of the product-in-circulation.

19. The service management method as set forth in claim 18, further comprising the step of specifying an unused product-in-circulation that is to be collected from the service receiver after a prescribed duration, of all products-in-circulation delivered to the service receiver.

20. A service management method, in which a computer causes a product-in-circulation for use in operating a machine to be provided, making the computer execute the steps of:
causing a terminal managed by a service provider to register unique date of the product-in-circulation delivered to a service receiver and number of times collected data of the product-in-circulation in memory means which is capable of being accessed by the computer; causing a machine provided on a side of the service receiver to read out the unique data of the product-in-circulation installed in the machine; transmitting data, that includes the unique data of the product-in-circulation, to a terminal managed by the service provider; causing the terminal managed by the service provider to detect the data via a network; recognizing installation of the product-in-circulation in the machine as a purchase action in accordance with the unique data of the product-in-circulation; and calculating an account of a product-in-circulation recognized as the purchase action, of all products-in-circulation, by considering the number of times collected data of the product-in-circulation.

21. The service management method as set forth in claim 20, further comprising the step of specifying an unused product-in-circulation that is to be collected from the service receiver after a prescribed duration, of all products-in-circulation delivered to the service receiver.

22. A service management apparatus comprising: a product-in-circulation data recording section for registering unique data of a product-in-circulation delivered to a service receiver and number of times collected data of the product-in-circulation in pairs; an input section for inputting status on use of the product-in-circulation; and an arithmetic processing section for calculating an account of a product-in-circulation detected being used in accordance with the status on use, of all products-in-circulation, by considering the number of times collected data of the product-in-circulation.

23. A service management apparatus comprising: a product-in-circulation data recording section for registering unique data of a product-in-circulation delivered to a service receiver and number of times collected data of the product-in-circulation in pairs; a communications section for detecting use of the product-in-circulation via a network; and an arithmetic processing section for calculating an account of a product-in-circulation detected being used by means of the communications section, of all products-in-circulation delivered to the service receiver, by considering the number of times collected data of the product-in-circulation.

24. A service management network system comprising a first group and a second group, wherein:
the first group is a machine in which a product-in-circulation, having unique data, which is consumed or degraded, is installed as to be detachable, and the machine includes: (a) a read-out section for detecting the unique data of the product-in-circulation from the product-in-circulation; (b) a transmitter section for externally transmitting the unique data that has been read out via a network; and (c) a controller section for controlling the read-out section and the transmitter section, and
the second group is a service management apparatus including: (a) a product-in-circulation data recording section for registering the unique data of the product-in-circulation delivered to a service receiver and number of times collected data of the product-in-circulation; (b) a communications section for performing communications with the first group so as to obtain data which contains the unique data; and (c) an arithmetic processing section for calculating an account of a product-in-circulation detected being used in accordance with the data, of all products-in-circulation delivered to the first group, by considering the number of times collected data of the product-in-circulation.

25. A service management network system comprising a first group and a second group, wherein:
the first group is a machine including: (a) a read-out section for detecting unique data of a product-in-circulation from the product-in-circulation having the unique data; (b) a transmitter section for externally transmitting data which contains the unique data via a network; and (c) a controller section for controlling the read-out section and the transmitter section, and
the second group is a service management apparatus including: (a) a product-in-circulation data recording section for registering the unique data of the product-in-circulation and number of times collected data of the product-in-circulation; (b) a communications section for performing communications with the first group so as to obtain the data which contains the unique data; and (c) an arithmetic processing section for calculating an account of a product-in-circulation detected being used in accordance with the data, of all products-in-circulation delivered to the first group, by considering the number of times collected data of the product-in-circulation.

26. A service management program making a computer execute a service management method which includes the steps of: registering unique data of a product-in-circulation delivered to a service receiver and number of times collected data of the product-in-circulation in a memory section that is capable of being accessed by the computer; detecting use of the product-in-circulation used by the service receiver via a network; recognizing the use that has been detected as a purchase action; and calculating an account of a product-in-circulation recognized as the purchase action, of all products-in-circulation, by considering the number of times collected data of the product-in-circulation.

27. A service management program, whereby a product-in-circulation for use in operating a machine is provided, making a computer execute a service management method which includes the steps of: causing a terminal managed by a service provider to register unique data of the product-in-circulation delivered to a service receiver and number of times collected data of the product-in-circulation in memory means that is capable of being accessed by the computer; causing a machine provided on a side of the service receiver to read out the unique data of the product-in-circulation installed in the machine; transmitting data, that includes the unique data of the product-in-circulation, to a terminal managed by the service provider; causing the terminal managed by the service provider to detect the data via a network; recognizing installation of the product-in-circulation in the machine as a purchase action based on the unique data of the product-in-circulation; and calculating an account of a product-in-circulation recognized as the purchase action, by considering the number of times collected data of the product-in-circulation.

28. A computer program product recording a service management program which makes a computer execute a service management method which includes the steps of: registering unique data of the product-in-circulation delivered to a service receiver and number of times collected data of the product-in-circulation in memory means that is capable of being accessed by the computer; detecting use of the product-in-circulation used by the service receiver, via a network; recognizing the use of the product-in-circulation as a purchase action; and calculating an account of a product-in-circulation recognized as the purchase action by considering the number of times collected data of the product-in-circulation.

29. A computer program recording a service management program for providing a product-in-circulation for use in operating a machine, the service management program making a computer execute a service management method which includes the steps of: causing a terminal managed by a service provider to register unique data of the product-in-circulation delivered to a service receiver and number of times collected data of the product-in-circulation in memory means that is capable of being accessed by the computer; causing a machine provided on a side of the service receiver to read out the unique data of the product-in-circulation installed in the machine; transmitting data, that includes the unique data of the product-in-circulation, to a terminal managed by the service provider; causing the terminal managed by the service provider to detect the data via a network; recognizing installation of the product-in-circulation in the machine as a purchase action in accordance with the unique data of the product-in-circulation; and calculating an account of a product-in-circulation recognized as the purchase action by considering the number of times collected data of the product- in-circulation.
